(19) United States
(12) Patent Application Publication
(10) Pub. No.: US 2024/0233233 A1
(43) Pub. Date: Jul. 11, 2024

(54) TECHNIQUES FOR ANIMATING AN AVATAR BASED ON SENSOR DATA FROM AN ARTIFICIAL-REALITY HEADSET COLLECTED WHILE PREPARING A SPEECH-BASED COMMUNICATION, AND SYSTEMS AND METHODS USING THESE TECHNIQUES

(71) Applicant: Meta Platforms Technologies, LLC, Menlo Park, CA (US)

(72) Inventors: Benjamin Neal Bethurum, Shoreline, WA (US); Joseph Gardner, Burlingame, CA (US); Zachary William Halvorson, Seattle, WA (US); Benjamin Parker Tankersley, Mountain View, CA (US)

(21) Appl. No.: 18/509,134

(22) Filed: Nov. 14, 2023

Related U.S. Application Data
(60) Provisional application No. 63/479,340, filed on Jan. 10, 2023.

(51) Int. Cl. G06T 13/40; G02B 27/01; G06F 3/01

(52) U.S. Cl. CPC G06T 13/40; G02B 27/017; G06F 3/012

(57) ABSTRACT

A method includes animating head movements of an avatar representing the wearer of augmented-reality glasses, based on first data indicating movements a wearer's head during a period in which the wearer of the augmented-reality glasses is recording an audio message using spoken words, where the first data was obtained by an inertial-measurement unit (IMU) of the augmented-reality glasses. The method includes animating mouth movements of the avatar representing the user, based on second data indicating the spoken words of the user during the period of time, where the second data was obtained by a microphone of the augmented-reality glasses. And the method includes providing an animated version of the avatar having the head movements and the mouth movements to a device other than the augmented-reality glasses for presentation in conjunction with playback of an electronic communication at the device other than the augmented-reality glasses.

### RELATED APPLICATIONS

This application claims priority to U.S. Prov. App. No. 63/479,340, filed on Jan. 10, 2023, and entitled “Techniques for Determining Whether To Animate an Avatar Based on Sensor Data From an Artificial-Reality Headset Collected While Preparing a Speech-Based Communication, and Systems and Methods Using These Techniques,” which is incorporated herein by reference.

### TECHNICAL FIELD

This disclosure relates generally to techniques for determining how to animate an avatar using sensor data from an artificial-reality headset, including but not limited to techniques (e.g., operations caused by instructions stored in non-transitory computer-readable storage media stored at electronic devices) for determining whether to animate an avatar based on sensor data from an artificial-reality headset collected while preparing a speech-based communication, as well as techniques for receiving speech-based communications associated with animated avatars.

This also relates generally to techniques for presenting animated avatars that are associated with electronic communications within portions of artificial-reality (AR) headsets (e.g., augmented-reality glasses) including but not limited to techniques for presenting animated avatars corresponding to users of AR headsets that are performing physical activities while the animated avatars are being displayed.

### BACKGROUND

Electronic devices have increased users' abilities to communicate with each other, including electronic communications such as electronic messages (e.g., audio messages, reactions to messages), and sharing of compositional content (e.g., a video that includes an image overlay during a portion of the video). Electronic messages, for example, can be configured to include textual content, audio content, video content, links to additional content, and the like.

Despite these advances in electronic communication, there are still numerous drawbacks and/or shortcomings of electronic communications technology. For example, users are not always able to efficiently and intuitively communicate expressions, and/or non-verbal interactions, for example, in conjunction with text-based electronic communications (e.g., text messages) as well as speech-based communications (e.g., spoken audio messages). Such drawbacks and/or shortcomings can be particularly pronounced with emerging types of electronic devices, such as smart glasses, which can have smaller-capacity power sources that can further limit the amount of information that can be conveyed along with electronic communications.

Further, it can be difficult for users to provide representations of themselves in conjunction with sharing electronic communications, particularly if they are using a camera of the electronic device to record something else. For example, an influencer (e.g., a user of an electronic device that has a considerable following on a particular social media platform) may wish to record content from a front-facing camera of an electronic device (e.g., video content showing the user playing piano). At the same time, the user may wish to present to their followers a visual representation that includes some characterized elements of their expressions (e.g., animated mouth movements corresponding to their spoken words, head movements corresponding to their actual head movements). Such features can provide receivers of such electronic messages with a more immersive, engaging, and/or entertaining experience.

### SUMMARY

As such, it would be desirable to address one or more of the above-identified issues, drawbacks, or areas for further exploration.

The systems (e.g., non-transitory computer-readable storage media, wearable devices, wearable devices used to control head-wearable devices, etc.) and methods described herein address at least one of the above-mentioned issues, drawbacks, or areas for exploration by allowing a user to share (e.g., from a sending electronic device, which can be a head-wearable device) an electronic message to another user (e.g., using a receiving electronic device) and an avatar corresponding to the user, and that avatar can be animated to move in accordance with sensor data present at that sending electronic device while the electronic message was being recorded (e.g., this animating can occur on a real-time basis if the electronic message is a live video call between the sending and receiving users, or it can occur on an asynchronous basis once the electronic message is opened by the receiving user). The avatar can be presented (e.g., at the receiving device once the message is received and played, and/or at the sending device as the message is being recorded) with animated head movements that are based on data from an inertial measurement unit of a head-wearable device that the user is wearing (e.g., while they are preparing an electronic message to be sent to the other user).

As a prophetic example, consider a user, Ashley, who is wearing an AR headset (specifically, augmented-reality glasses that can include waveguides to overlay digit contact on top of a view of the physical world that is directly visible through the augmented-reality glasses). Ashley wants to send an audio message to her friend, Brad, that includes a head movement corresponding to a funny dance she saw a mascot doing at an amusement park. Ashley initiates composition of an electronic communication that includes her spoken words, and an animated avatar that includes animated head movements corresponding to Ashley's actual head movements, which are detected by an inertial measurement (IMU) on her augmented-reality glasses, is displayed on Ashley's AR headset as she composes the electronic communication. Thus, Ashley can see a preview of how her animated avatar will appear once she sends her electronic communication to Brad.

Brad receives a notification of the electronic communication from Ashley, and the electronic communication includes first data from the IMU for the head movements, and second data from a microphone of the AR headset corresponding to spoken words included in Ashley's electronic communication (as described below, in certain embodiments, the first and second data need not be directly conveyed to Brad's AR headset (or other portable electronic device (e.g., a smartphone or laptop), but instead the animated avatar that includes the appropriate head movements and lip movements can be sent as a playable object that was animated based on the first and second data). Brad is able to quickly and efficiently access the electronic communication, including an animated avatar corresponding to Ashley that is animated based on the first data from the IMU and the second data from the microphone, which animated avatar can be played back along with the content of the electronic communication (e.g., the animated avatar moves as the words spoken by Ashley are audibly presented at Brad's device). In embodiments in which the first and second data are directly conveyed, Brad's electronic device is able to process the first data and the second data faster and more efficiently than the same electronic device would be able to process video data. Similarly, the first data and the second data are also received more quickly and efficiently than video data would be obtained via a wireless communication, and thus are smooth and crisp even when a wireless connection between the electronic devices is relatively weak.

The first data and the second data can be encrypted, such that Brad may only access the electronic communication, and/or cause the animated avatar corresponding to Ashley to be displayed, based on a determination that Brad is connected with Ashley (e.g., as a contact, a friend, a verified follower, etc.) via a sharing application (e.g., a messaging application, a social media application, etc.). That is, the first data and/or the second data can be encrypted to not only control who may access the first data and the second data, but also to control how the data can be accessed (e.g., to be presented as an animated avatar).

At Brad's augmented-reality glasses, non-transitory computer-readable storage media include instructions, which can cause a processor, while it is executing the instructions to cause operations related to the presentation of the electronic communication from Ashley, including the animated avatar, to also cause the animated avatar to be adjusted based on one or more aspects of Ashley's current or most recently shared status. For example, the animated avatar can include a hat corresponding to a particular location (e.g., San Francisco) that Ashley recently shared a status about (e.g., at a sharing application). The sharing application can be a different application than the sharing application that she is using to share the electronic communication with Brad. But the animated avatar is modified based on the status about the particular location, since the other sharing application is linked with the sharing application (e.g., via one or more operations of the non-transitory computer-readable storage media located at Brad's augmented-reality headset), and since Brad is connected with Ashley via the other sharing application.

Brad displays the animated avatar corresponding to Ashley's electronic communication, in real time at his augmented-reality glasses, while Ashley is composing the electronic communication. Brad is performing a physical activity on an electronic workout machine that includes a display with instructions for performing the physical activity (e.g., a guided spinning class). The animated avatar corresponding to Ashley's electronic communication is presented at a portion of a lens of Brad's augmented-reality glasses that is configured and arranged (e.g., positioned) so as to not obstruct the display of the electronic workout machine. The display of the electronic workout machine is detected in conjunction with an artificial-intelligence model for detecting objects of interests that is stored in one or more programs in memory of the augmented-reality glasses. Further, the animated avatar corresponding to Ashley is presented in conjunction with subtitles, based on a determination that Brad is already using speakers of his augmented-reality glasses to listen to audio from the guided spin-bike training class. But when Brad performs an in-air hand gesture that is detected by sensors of a wrist-wearable device that Brad is also wearing, an interactive electronic communication between Brad and Ashley is initiated, and each user can see an animated avatar corresponding to the other user at portions of their respective AR headsets, and the audio of Brad's guided spinning class is muted based on initiating the interactive electronic communication.

Meanwhile, Brad has been sharing a different electronic communication to his followers on a different sharing application, where the different electronic communication includes front-facing video content from Brad's augmented-reality glasses (e.g., showing his progress on the electronic workout machine) while presenting an animated avatar corresponding to Brad in conjunction with the video content. Carla, who is viewing Brad's shared electronic communication via a wrist-wearable device, notices that Brad's animated avatar becomes unavailable via the shared electronic communication, which is based on his initiating the interactive electronic communication with Ashley. That is, Carla is still able to view the video content, but a user interface element displayed at her wrist-wearable device for viewing the animated avatar corresponding to Brad becomes blurred and non-selectable.

Carla begins composing an audio message to Brad asking whether he is still working out. Since Carla is not wearing an AR headset that includes an IMU, her wrist-wearable device indicates to Carla that she is unable to prepare an electronic communication that includes an animated avatar that has animated head movements corresponding to her actual head movements. Carla selects a user interface element that allows her to share the electronic communication that includes an animated avatar with default animations for the animated head movements.

Brad receives a real-time notification that Carla is sharing an electronic communication with Brad that includes an animated avatar, while Brad is still engaged in an interactive electronic communication with Ashley. Brad invites Carla to join the interactive electronic communication, and all three users are able to see each other's respective animated avatar. That is, Ashley and Brad are viewing the three animated avatars in a virtual room as it is being presented at their augmented-reality glasses, and Carla is viewing a similar virtual scene presented at her wrist-wearable device.

Daniel is a mutual contact of Ashley, Brad, and Carla, and Daniel is wearing a virtual-reality (VR) headset that is presenting a substantially immersive AR environment that obscures a substantial portion of Daniel's field of view. Based on his mutual connection with Ashley, Brad, and Carla via a particular sharing application (e.g., a business communications application), Daniel receives a visual indication that they are all engaged in an interactive electronic communication and sends a notification to the virtual room asking if he can join the interactive electronic communication. Upon his request to join being accepted, a virtual room is presented at Daniel's VR headset that includes the animated avatars corresponding to Ashley, Brad, and Carla. A modified version of Carla's avatar is presented at Daniel's VR headset, since Carla has enabled user-configurable settings for modifying VR representations of her animated avatar.

Within the virtual room presented at Daniel's VR headset, Ashley, Brad, Carla, and Daniel are sitting at a virtual conference room, and a screen in front of them is presenting video content showing Ashley performing a calculation on a pen and paper in front of her. Daniel remarks: “brilliant work Ashley, I'm glad we were all able to meet in this way to get these numbers finalized before the end of the year,” and performs a head movement that is detected by the IMU sensors of his VR headset. Ashley, Brad, and Carla view an animated avatar corresponding to Daniel that includes animated head movements based on the data from the IMU sensors of his VR headset, and animated mouth movements corresponding to his spoken words detected by a microphone of the VR headset.

Having thus described this prophetic example for illustrative purposes, example methods will now be described (as will be appreciated, these example methods can be used to enable the prophetic example discussed earlier).

In accordance with some embodiments, a method is provided for animating aspects of an animated avatar corresponding to an electronic communication. The method includes preparing a speech-based communication (e.g., a speech-based communication can be any communication that includes speech from a user, including both real-time and asynchronous communications, including, but not limited to, audio messages, video messages, voice calls, video calls, etc.) at an electronic device associated with a user. The method further includes, in accordance with determining that the electronic device is an artificial-reality (AR) headset, animating head movements of an animated avatar associated with the user. The animating of the head movements of the animated avatar is based on data from an inertial measurement unit (IMU) of the AR headset that was received while preparing the speech-based communication.

In accordance with some embodiments, a method is provided for presenting an animated avatar that is associated with an electronic communication. The method includes receiving, at a receiving electronic device of a receiving user and from a sending electronic device of a sending user, a first speech-based communication. The method includes, in response to a request to view the first speech-based communication when the sending electronic device is an AR headset that includes an inertial measurement unit, presenting the first speech-based communication along with an avatar associated with the sending user, such that the avatar, when presented along with the first speech-based communication, is animated to have head movements based on data from the inertial measurement unit (IMU) of the AR headset. The head movements correspond to head movements of the sending user while the first speech-based communication was prepared. The method includes receiving, at the receiving electronic device of the receiving user and from a different sending electronic device of the sending user, a second speech-based communication. And the method includes, in response to a request to view the second speech-based communication when the different sending electronic device is not an AR headset, presenting the second speech-based communication, such that the presenting of the second speech-based communication is not based on data from any IMU.

In accordance with some embodiments, a method is provided for presenting an avatar at a portion of a display of AR glasses. The method includes, while a user is (i) wearing an artificial-reality (AR) headset and (ii) composing an electronic communication, presenting, at the AR headset, an animated avatar associated with the user. The animated avatar includes one or both of (i) animated head movements based on signals detected by an inertial measurement unit (IMU) of the AR headset as the electronic communication is composed, and (ii) animated mouth movements based on signals detected by a microphone as the electronic communication is composed.

In accordance with some embodiments, a method is provided for presenting an avatar in an electronic communication based on data from sensors of augmented-reality glasses. The method includes animating of an avatar representing a wearer of augmented-reality glasses, based on receiving first data indicating movements of a head of the wearer of the augmented-reality glasses during a period of time in which the wearer of the augmented-reality glasses is recording an audio message using spoken words. The first data was obtained by an inertial measurement unit (IMU) of the augmented-reality glasses while the wearer was wearing the augmented-reality glasses. The method further includes animating mouth movements of the avatar representing the wearer, based on receiving second data indicating the spoken words of the wearer during the period of time. The second data was obtained by a microphone of the augmented-reality glasses while the wearer was wearing the augmented-reality glasses. The method further includes providing an animated version of the avatar having the head movements and the mouth movements to a device other than the augmented-reality glasses for presentation in conjunction with playback of an electronic communication at the device other than the augmented-reality glasses.

In some embodiments, an AR system (e.g., an AR headset, which can be augmented-reality glasses and/or a virtual-reality headset) includes one or more processors, a display, and one or more programs (e.g., computer-readable non-transitory storage media) stored in memory. The one or more programs are configured for execution by the one or more processors. The one or more programs include instructions for performing any of the methods described herein (e.g., including the methods 800, 900, 1000, and 1100, which are described below).

In some embodiments, a non-transitory computer-readable storage medium stores one or more programs configured for execution by a computing device (e.g., a wrist-wearable device or a head-wearable device or another connected intermediary device, such as a smartphone or desktop or laptop computer (or even a dedicated intermediary device for coordinating operations between an AR headset and a wrist wearable device, which dedicated intermediary device can, in some embodiments, not include a display) that can be configured to coordinate operations at the wrist-wearable device at the wrist-wearable device and the head-wearable device), having one or more processors, memory, and a display (in some embodiments, the display can be optional, such as for certain example connected devices that can coordinate for operations to be performed at the wrist-wearable device and/or the head-wearable device, and thus have processing and power resources, but need not have their own displays). The one or more programs include instructions for performing (or causing performance of) any of the methods described herein (e.g., including methods 800, 900, 1000, and 1100 that are described in detail below).

Thus methods, systems, and computer-readable storage media are disclosed for generating or otherwise obtaining, delivering, and presenting animated avatars, including electronic messages that include animated avatars. Note that the various embodiments described above can be combined with any other embodiments described herein. As is illustrated by the prophetic example described above, the specific embodiments described in the previous paragraphs can occur alone or in combination with other specific embodiments, and all such embodiments are intended to be non-limiting in that other embodiments can include additional and/or alternative features.

It should be noted that the language used in the specification has been principally selected for readability and instructional purposes and has not necessarily been selected to delineate or circumscribe the subject matter described herein.

### BRIEF DESCRIPTION OF THE DRAWINGS

A more particular description may be had by reference to the features of various embodiments, some of which are illustrated in the appended drawings. The appended drawings illustrate pertinent example features of the present disclosure. The description may admit to other effective features as the person of skill in this art will appreciate upon reading this disclosure.

FIGS. 1A-1H show an example sequence in which an avatar is animated based on sensor data from a first user's AR headset as the first user creates an electronic communication (FIGS. 1A-1D), followed by a second user accessing the electronic communication created by the first user (FIGS. 1E-1H), in accordance with some embodiments.

FIGS. 2A-2C show an example sequence in which a user composes an audio message using a device that is not an AR headset, along with an option to utilize an avatar with default animations, in accordance with some embodiments.

FIGS. 3A-3D show an example sequence in which an ongoing electronic communication (e.g., a live-streamed video) that includes an animated avatar is being presented at a display of a wrist-wearable device, in accordance with some embodiments.

FIGS. 4A-4E show an example sequence of a user performing a physical activity while an animated avatar is presented at a lens portion of the user's AR headset and a viewing location of the animated avatar within the lens portion is adjusted to avoid interfering with the user's performance of the physical activity, in accordance with some embodiments.

FIGS. 5A, 5B, 5C-1, 5C-2, 5D-1, and 5D-2 illustrate example artificial-reality systems, in accordance with some embodiments.

FIGS. 6A and 6B illustrate an example wrist-wearable device 600, in accordance with some embodiments.

FIGS. 7A, 7B-1, 7B-2, and 7C illustrate example head-wearable devices, in accordance with some embodiments.

FIGS. 8A and 8B illustrate an example handheld intermediary processing device, in accordance with some embodiments.

FIGS. 9A to 9C illustrate an example smart textile-based garment, in accordance with some embodiments.

FIG. 10 illustrates a flow diagram of an example method of determining whether to animate head movements of an avatar based on sensor data from an artificial-reality headset, in accordance with some embodiments.

FIG. 11 illustrates a flow diagram of an example method of presenting electronic communications with or without animated avatars depending on whether a respective electronic communication was prepared using an AR headset, in accordance with some embodiments.

FIG. 12 illustrates a flow diagram of an example method of presenting an animated avatar to a user of an AR headset as the user is composing an electronic communication, in accordance with some embodiments.

FIG. 13 illustrates a flow diagram of an example method of animating an avatar's head movements of mouth movements based on respective data from two different types of sensors of an artificial-reality headset, in accordance with some embodiments.

In accordance with common practice, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

It should be appreciated that an artificial-reality (AR) headset as described herein includes (i) augmented-reality glasses (e.g., smart glasses), and/or (ii) virtual-reality goggles (e.g., a VR headset capable of VR-only mode as well as passthrough mixed-reality modes in which a user's physical environment is visible through a camera feed). That is, augmented-reality glasses include a first subset of AR headsets, including head-wearable devices that present user-interface elements in some portions of respective lenses of the augmented-reality glasses while also providing an unobstructed view of at least a portion of physical reality (e.g., the unobstructed view is not seen through a camera feed but is instead directly viewable through the lenses of the augmented-reality glasses). In some embodiments, a pair of augmented-reality glasses can be configured to have a VR mode, in which the lenses of the augmented-reality glasses are used to present full-view user interfaces.

In some embodiments, augmented-reality glasses cause a user interface to be displayed in a portion, less than all, of a field of view of the user through one or more lenses of the augmented-reality glasses. In some embodiments, one or more user-interface elements (e.g., three-dimensional virtual objects) may be distributed within an otherwise unobstructed view of the user's environment. In some embodiments, augmented-reality glasses include a lens portion that is configured to be a two-dimensional display (e.g., a screen) for presenting two-dimensional or three-dimensional objects. In some embodiments, the portion of the augmented-reality glasses that is being used to display two-dimensional or three-dimensional user interface elements can change based on aspects of the physical environment that are in the user's field of view. For example, if a user is engaged in a particular physical activity (e.g., playing golf) and the user moves their head such that a particular physical object related to the physical activity (e.g., a golf ball) is in a different portion of the user's field of view, then a different lens portion of the user's augmented-reality glasses can be used to display an animated avatar or other user interface element.

As described herein, an electronic communication includes, but is not limited to, speech-based communications (which are communications that include any form of vocalization from a user, including audio messages, video calls, video messages, livestreaming, and the like) and non-speech-based communications, such as textual messages. Electronic communications can also be synchronous (a communication that is viewed substantially at the same time that it is created, such as a video call or livestream) and can also be asynchronous (i.e., a message that is accessible whenever a receiving user views it).

While several embodiments described herein discuss head movements of animated avatars based on data from IMU sensors, a skilled artisan will appreciate that other sensors can be used to detect other types of data, which can be used in conjunction with animating head movements of animated avatars. For example, imaging data from one or more imaging sensors (e.g., cameras) of a respective head-wearable device can be used to determine that a head movement occurred and/or other body action occurred to cause an animated head movement of a respective animated avatar. In some embodiments, sensors that are not located at a head-wearable device can be used to detect a movement that corresponds to a head movement of an animated avatar. In some embodiments, different movements of users besides head movements can be used to animate head movements. In some embodiments, sensor fusion can be used to combine data from different sensors to determine aspects of movements that correspond to animated movements of a respective animated avatar.

Operations and corresponding interactions described herein may be embodied in executable instructions (e.g., a software program), which are stored on non-transitory computer-readable storage media, the executable instructions configured to be executed by processors of a plurality of distinct electronic devices, and the executable instructions can cause performance of heuristic determinations for how such operations are performed that are based on a determination of which electronic devices a respective user is wearing and/or in proximity to during the respective electronic communications.

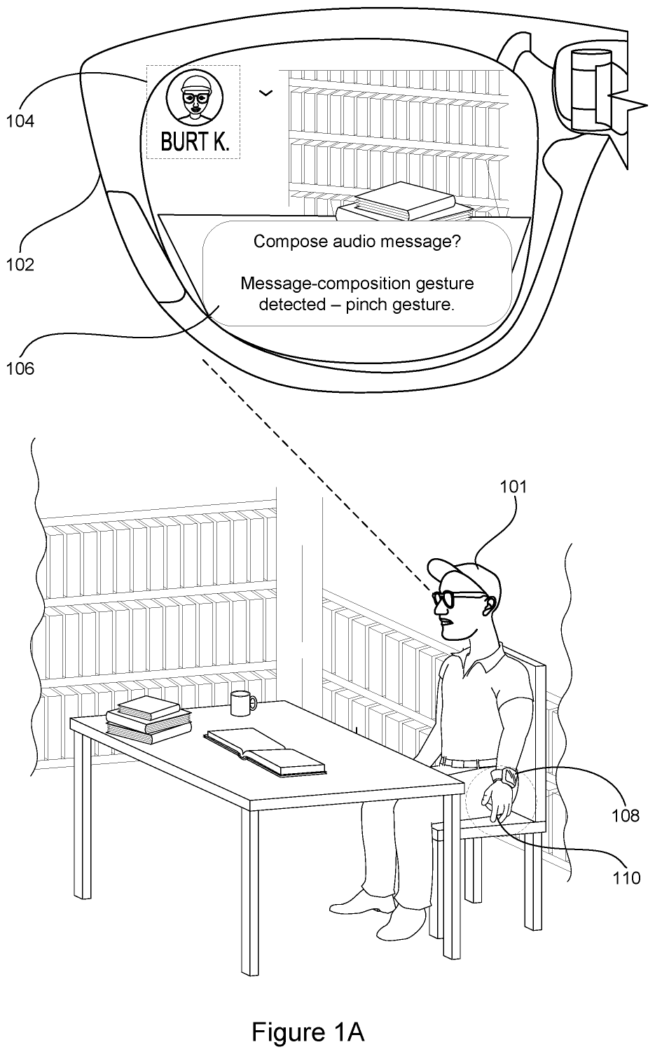

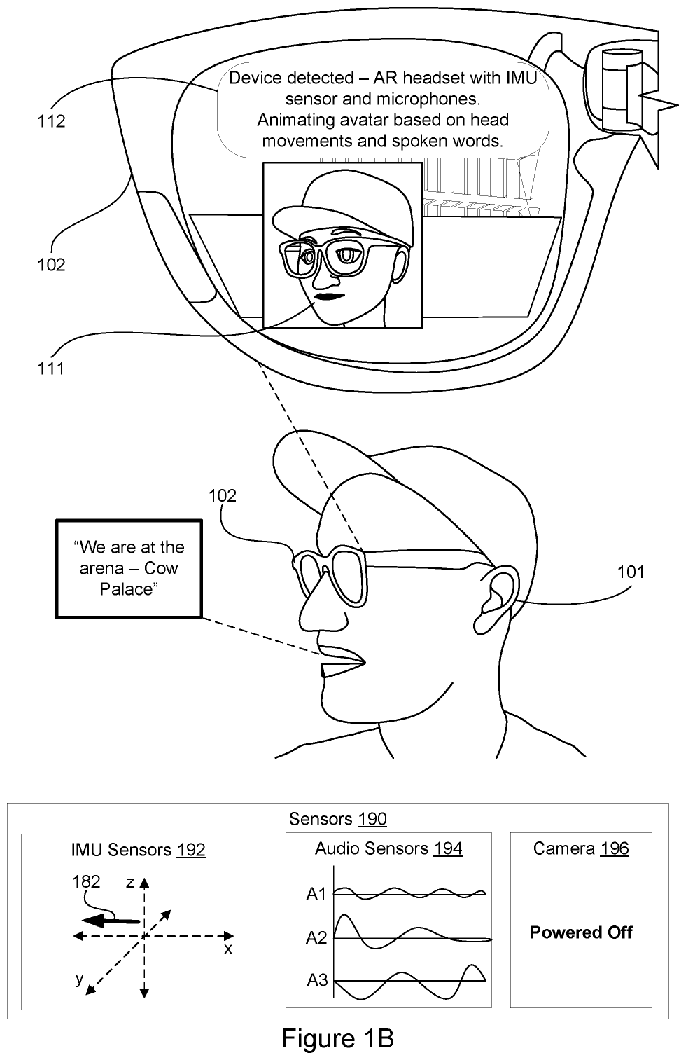

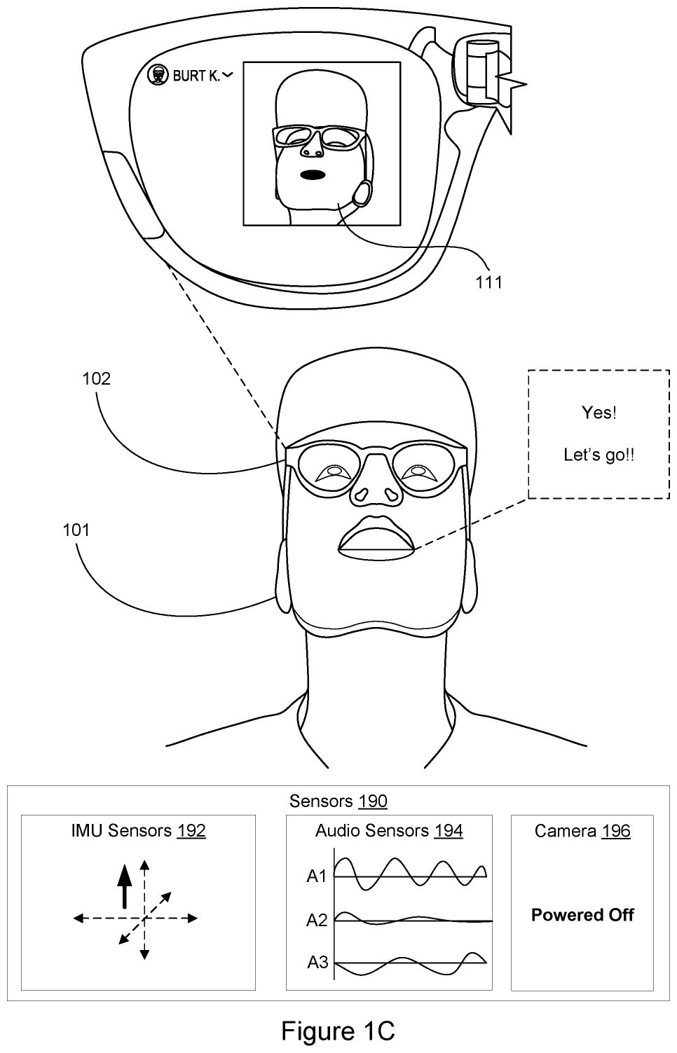

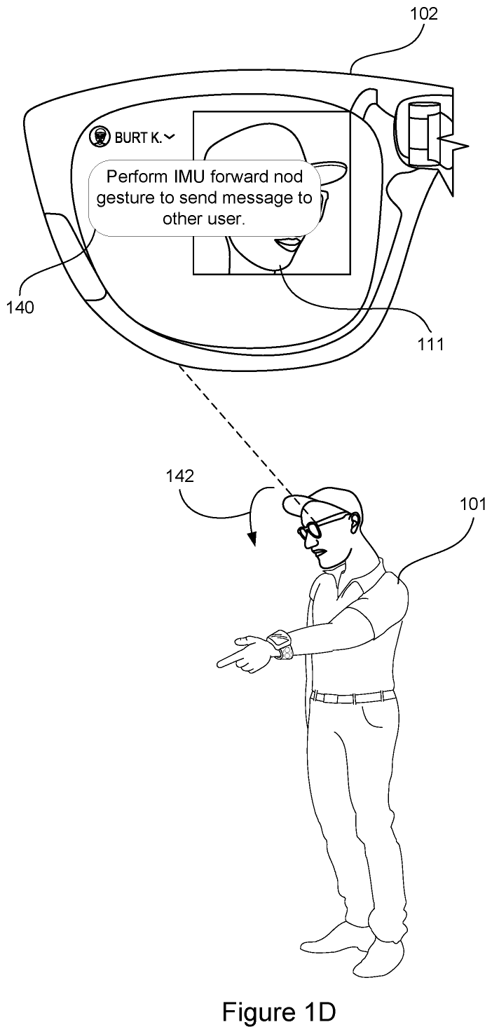

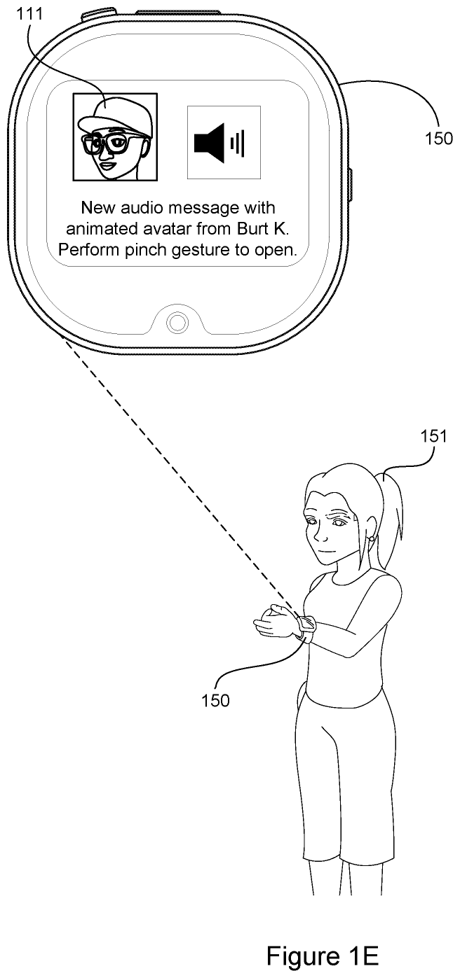

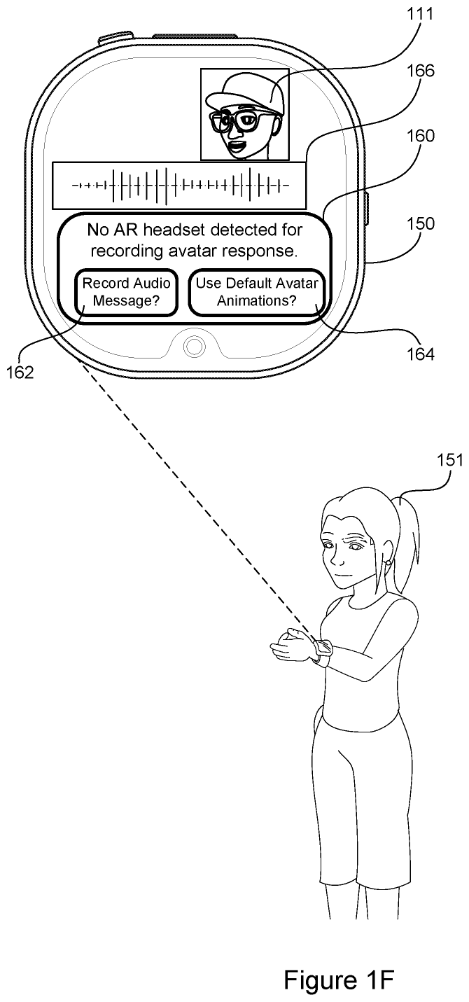

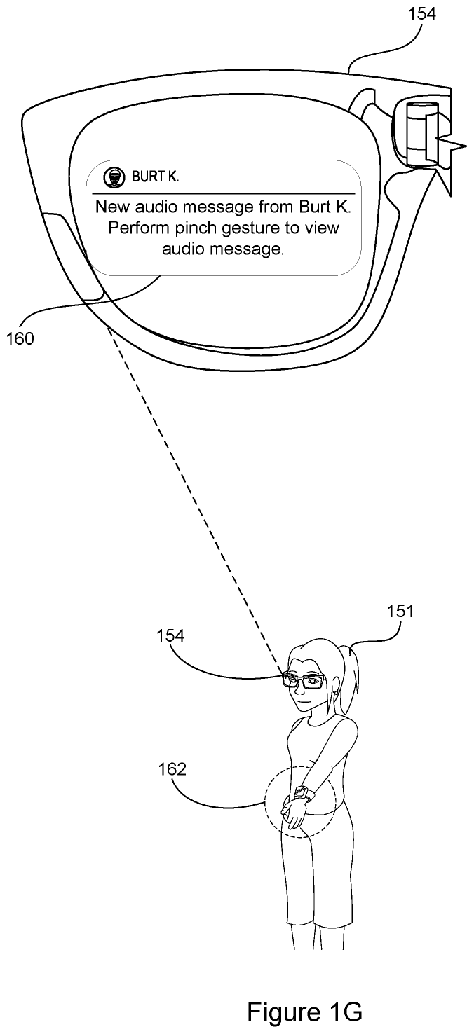

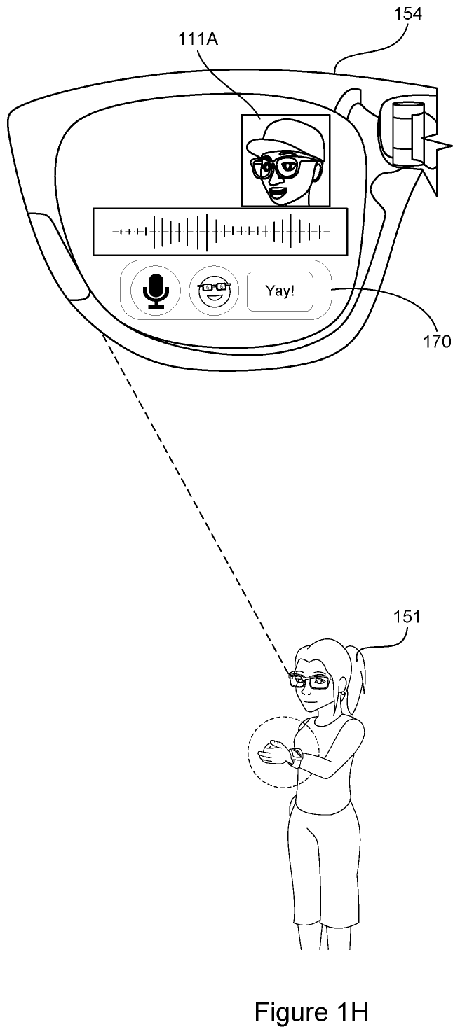

FIGS. 1A-1H show an example sequence in which an avatar is animated based on sensor data from a first user's AR headset as the first user creates an electronic communication (FIGS. 1A-1D), followed by a second user accessing the electronic communication created by the first user (FIGS. 1E-1H), in accordance with some embodiments.

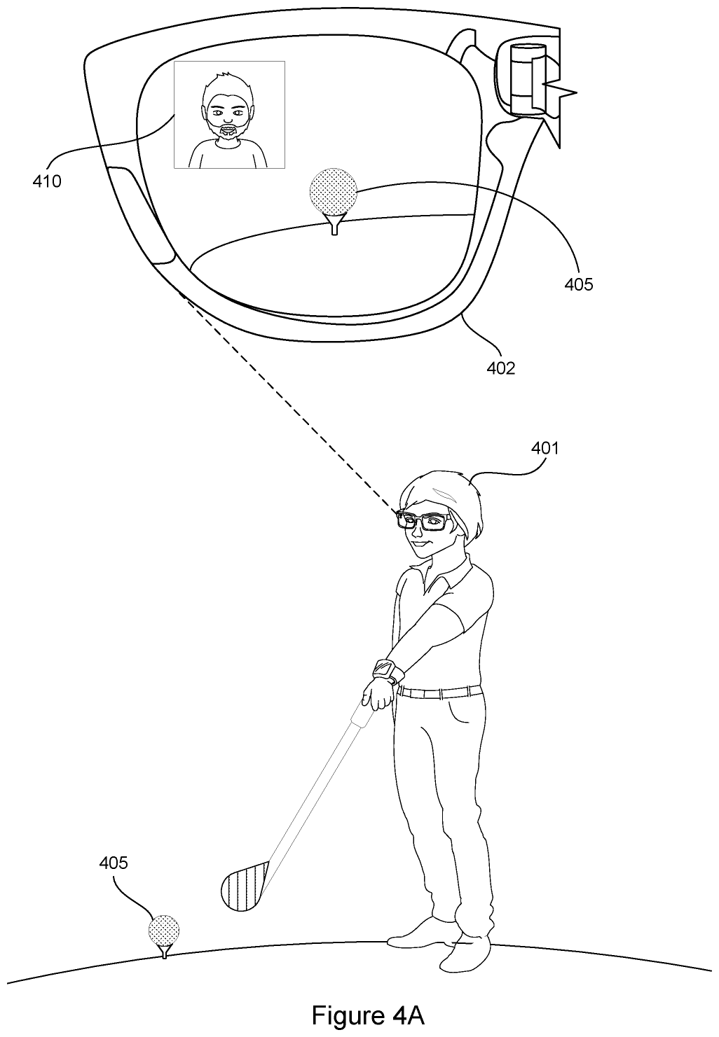

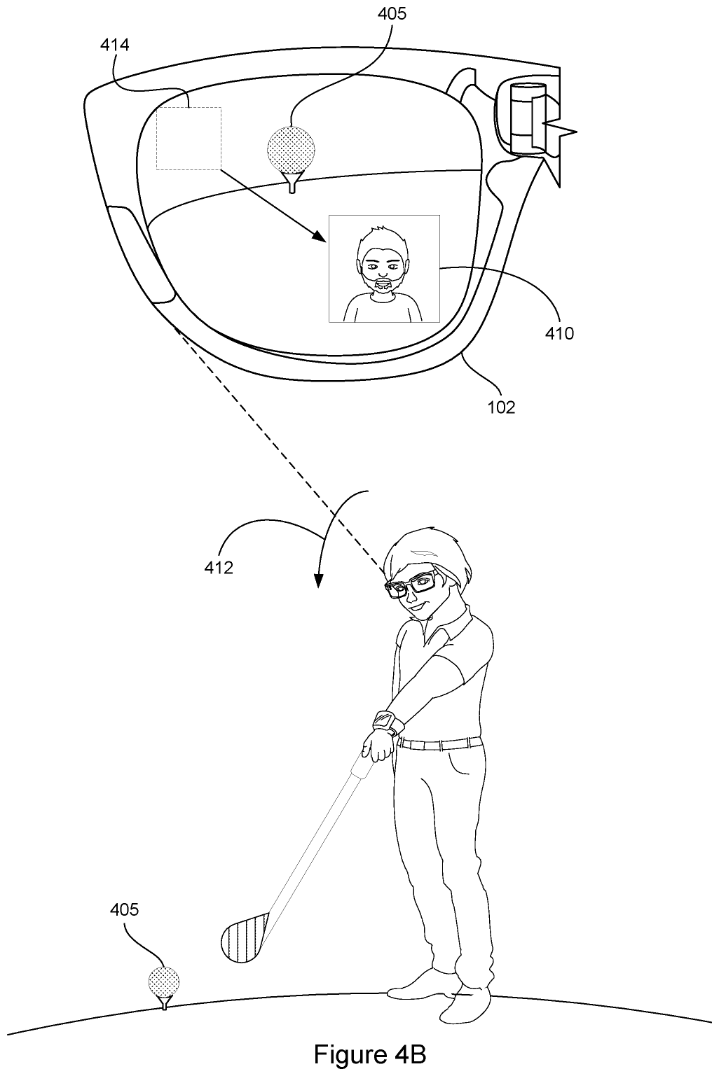

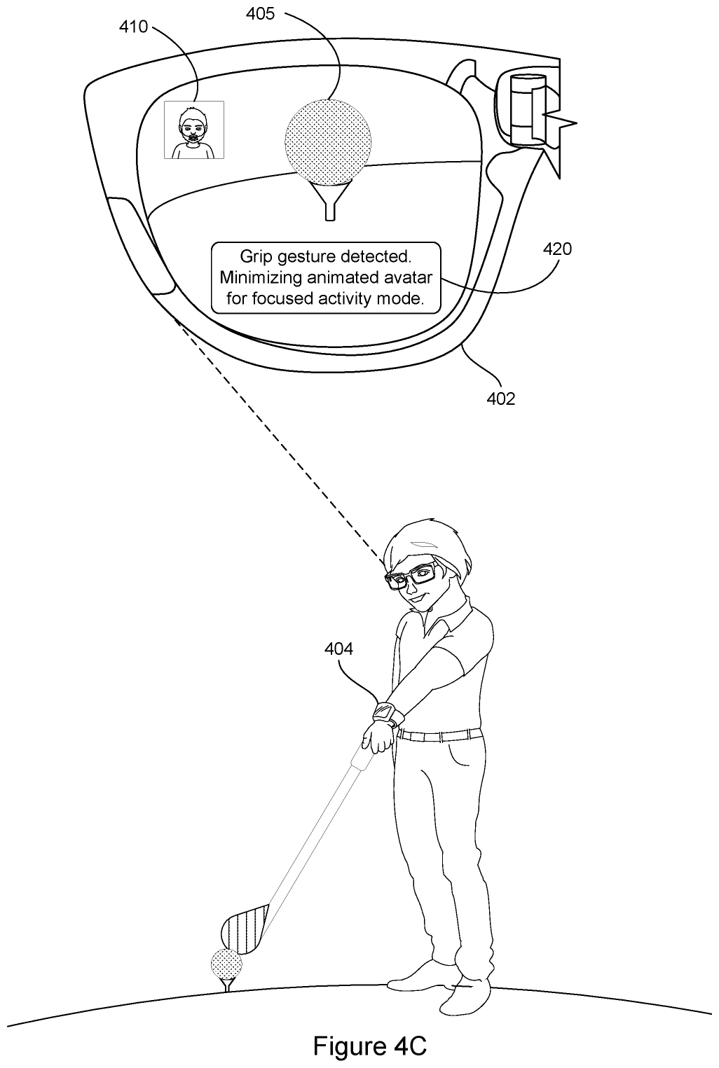

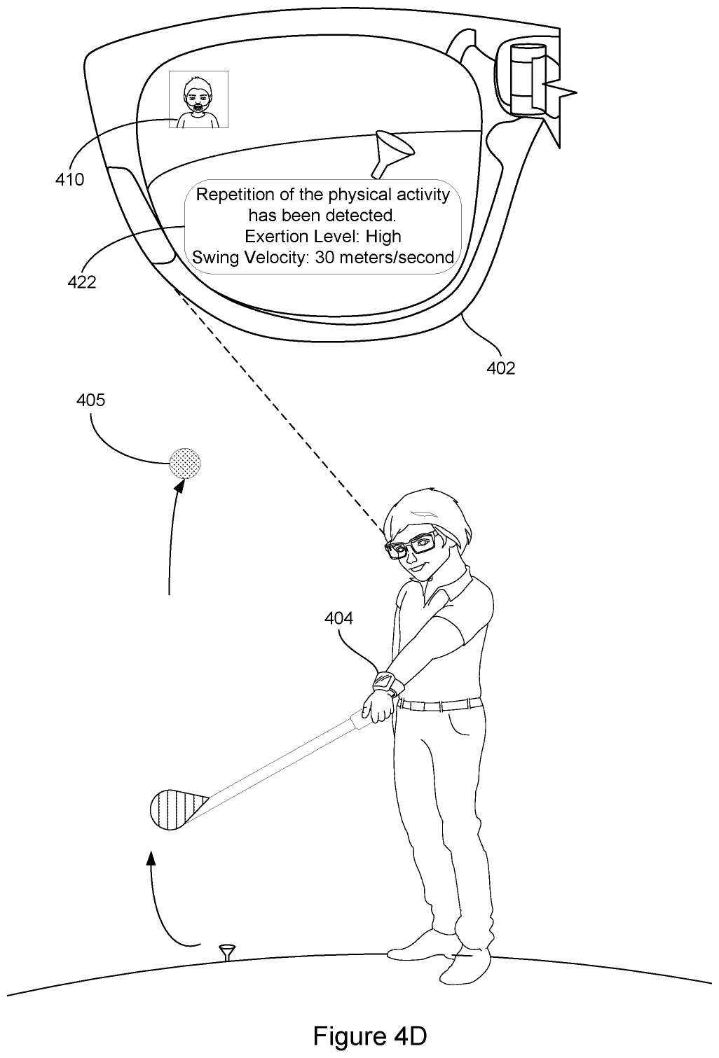

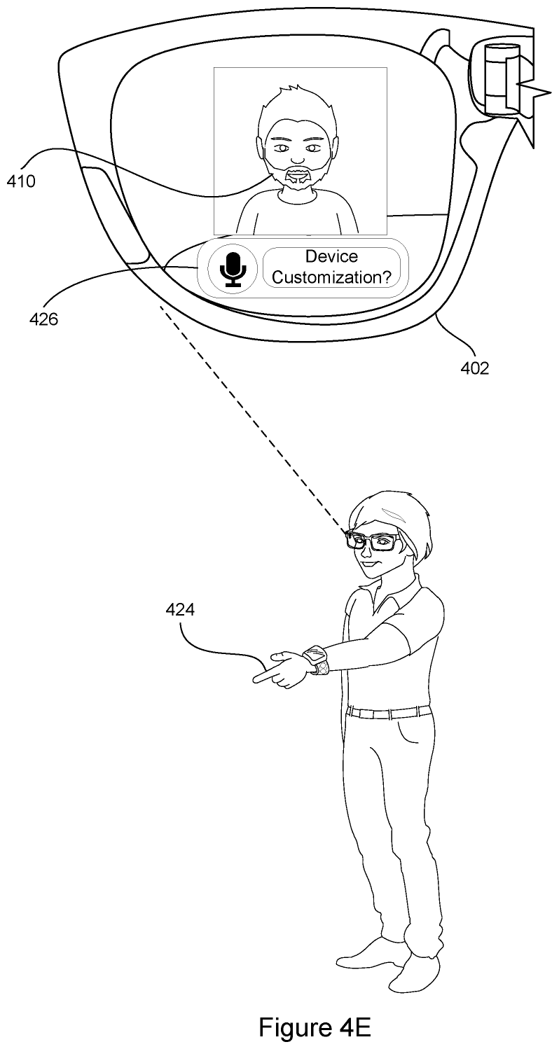

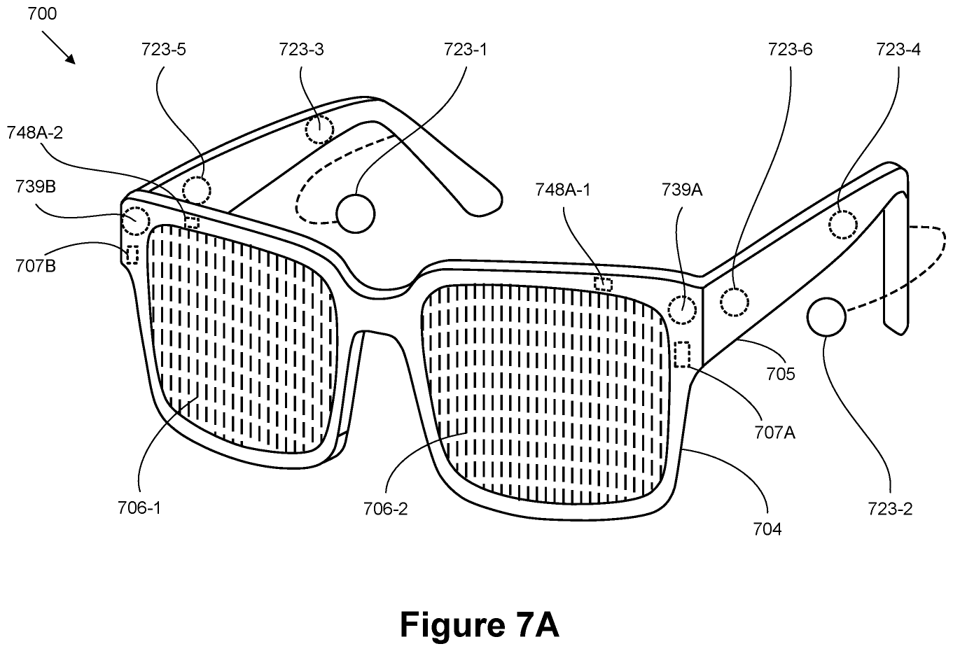

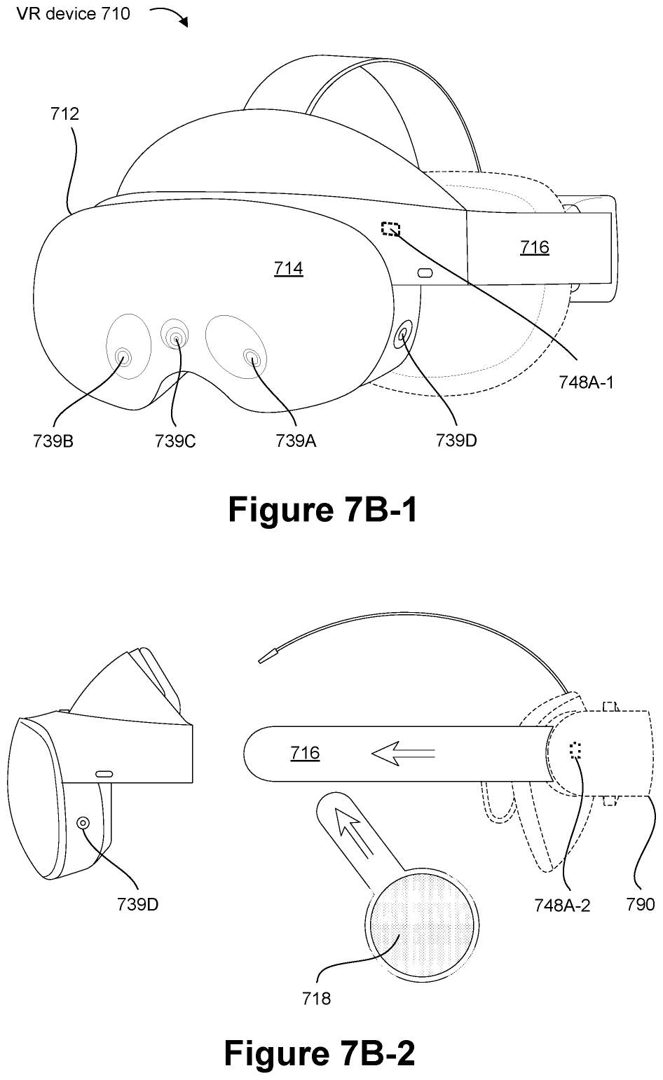

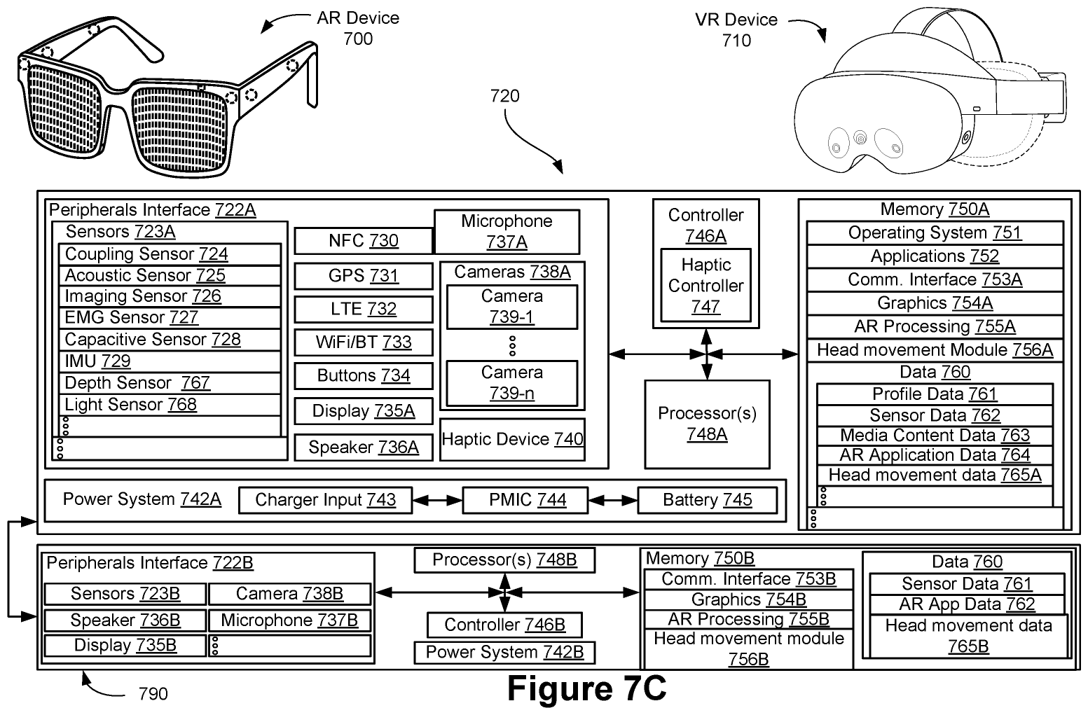

Turning first to FIG. 1A, a user 101 is wearing an AR headset 102, and a wrist-wearable device 108. The AR headset 102 shown in FIGS. 1A-1H is an example of a pair of augmented-reality glasses (e.g., which may include components of the AR device 700 or the VR device 710 shown and described with reference to FIGS. 7A to 7C). In some embodiments, one or more of the operations described with respect to FIGS. 1A-1H could also be performed while the user 101 is wearing an AR headset that is of a VR headset type or is operating in a virtual-reality mode. During the sequence shown by FIGS. 1A-1H, the AR headset 102 is functioning as augmented-reality glasses. That is, user interface elements are being shown as presented within portions of a lens of the AR headset (e.g., a left lens, which could interchangeably be a right lens or both lenses, in accordance with some embodiments), while allowing the user 101 to view an unobstructed physical environment through other portions of the lens of the augmented-reality glasses. In some embodiments, as will be shown in more detail with respect to FIGS. 4A-4E, a portion of the lens that is responsible for presenting user interface elements can change based on whether an aspect of an activity that the user 101 is performing is taking place within the respective portion of the lens of the AR headset (e.g., in other words, animated avatars can be moved to different viewing locations within one or both lenses of the AR headset to avoid obstructing the user's view of an object that is determined to be of interest to the user).

FIG. 1A shows the user 101 performing a pinch gesture (e.g., in this example, an in-air pinch gesture in which the user's middle finger makes contact with the user's thumb) while the user is wearing the AR headset 102. A thumbnail image 104 of an avatar corresponding to the user 101 is presented in an upper left corner of the AR headset 102. In some embodiments, the thumbnail image is configured to be passively animated while the user 101 is wearing the AR headset 102, based on a first type of sensor data (e.g., sensor data from an IMU) from the AR headset 102. The AR headset 102 is presenting a user interface element 106 indicating that the user can perform a gesture to compose an audio message at the AR headset 102 (e.g., “Compose audio message? Message-composition gesture detected—pinch gesture”). In the illustrated example of FIG. 1A, the user 101 is initiating an operation for composing an electronic communication using the AR headset 102, by performing a pinch gesture 110 that is detected by one or more biopotential sensors (in this example, neuromuscular-signal sensors) of a wrist-wearable device 108 that the user 101 is also wearing. In some embodiments, the initiating of the operation for composing the electronic message is based on the user 101 providing an audible command (e.g., a vocalization, such as spoken words, which audible command can be detected by one or more microphones of the AR headset 102). In some embodiments, no explicit user input is required for initiating presenting of the user's animated avatar for purposes of composing an electronic communication.

Turning next to FIG. 1B, the user 101 is now beginning to compose an electronic message via the AR headset 102, and an animated avatar 111 that corresponds to the user 101 is presented in conjunction with the user 101 beginning to compose the electronic message. In some embodiments, the animated avatar 111 is presented based on a determination that the AR headset 102 includes at least one sensor of a first type (e.g., an IMU such as the IMU sensors 192) and/or at least one sensor of a second type (e.g., at least one microphone such as the audio sensors 194). By allowing for this sensor-availability-based determination, certain software packages (which can be stored on a computer-readable storage medium) can be configured to offer the avatar-animation features or forgo doing so. The AR headset is displaying a user interface element 112 that is indicating to the user 101 that the AR headset 102 is animating the animated avatar 111 in conjunction with the user 101 composing the electronic communication (stating: “Device detected—AR headset with IMU sensor and microphones. Animating avatar based on head movements and spoken words.”).

That is, the AR headset 102 is presenting a real-time playback of an aspect (e.g., the visually animated avatar) of the electronic message that the user is composing. In some embodiments, no imaging sensors of the AR headset 102 are activated based on the user 101 beginning to prepare the electronic message to be sent to another user (e.g., the second user 151). In some embodiments, power is reduced to one or more cameras of the AR headset based on determining that the IMU sensors 192 and the audio sensors 194 will be used for composing the electronic message.

In certain embodiments, users can also use an animated avatar for portions of the electronic communication but can also switch to utilizing a live camera feed of their face for other portions of the electronic communication. That is, while a user is preparing an electronic communication, either for playback or for real-time sharing, the user may provide a user input to toggle between presenting an animated avatar to another user and providing a live camera feed to the other user. In such embodiments, determination logic based on presence or absence of an avatar-animation-utilization criteria can be utilized, such that when one or more of the avatar-animation criteria are determined to be present (e.g., no camera is facing toward the user's face in conjunction with composing the electronic communication), then the avatar continues to be animated for that portion of the electronic communication. In these same embodiments, when the avatar-animation criteria are determined to no longer be present (e.g., a camera is facing toward the user's face in conjunction with composing the electronic communication, for instance, because the user 101 has lifted up the wrist-wearable device 108 and pointed its camera toward their face), then the avatar is ceased to be animated for that other portion of the electronic communication and instead video data of the user's face can be utilized for that other portion of the electronic communication. Thus, assessment of avatar-animation-utilization criteria can be utilized to provide further flexibility to users in determining how to utilize animated avatars in portions of their electronic communications.

While the user 101 is preparing a speech-based communication (e.g., the audio message in the example of FIG. 1B), a detection operation is performed (e.g., by the messaging system, or an operating system associated with one or more of the user's wearable electronic devices) indicating that an electronic device being used in conjunction with composing the audio message is an AR headset, and that the AR headset includes one or more required sensors for producing an animated version of an avatar (e.g., one or more IMUs). Based on an indication (e.g., via the detection operation) that the user is wearing the AR headset 102, producing the speech-based communication includes animating head movements of an avatar 111 that is associated with the user 101. As shown in the block diagram below the user 101 in FIG. 1B, sensors 190 of the AR headset 102 detect aspects of the performance of the speech-based communication, including audio data captured by the audio sensors 194 (e.g., a microphone array) related to vocalizations (e.g., spoken words) of the user 101, and IMU data captured by the IMU sensors 192 of the AR headset 102. In some embodiments, head movements of the avatar 111 are animated based on head-movement data (e.g., a first set of data) obtained by one or more IMU sensors 192 and one or more audio sensors 194. In some embodiments, data from the audio sensors 194 can be used in conjunction with data from the IMU sensors 192 to determine an animated head movement for the avatar 111 to perform. The avatar 111 can also be a live preview of the avatar in its animated state, such that as the sensor data is collected from the sensors of the AR headset 102, the avatar 111 is updated to reflect animated head movements and mouth movements based on the sensor data.

The user 101 is continuing to compose the audio message in FIG. 1C, and, in so doing, they are tilting their head backward and upward, which is reflected in the visual depiction of the animated avatar 111 that is being displayed in a portion of a lens of the AR headset 102. The IMU sensors 192 detect the upward movement of the head of the user 101, and audio sensors located at different positions of the AR headset 102 are configured to collect audio data related to the vocalizations (e.g., spoken words) of the user. In some embodiments, the audio data collected by the audio sensors 194 can be used in conjunction with the IMU sensors 192 to determine head movements of the user 101. For example, the AR headset can include a first temple for resting on a first ear of the user, and a second temple for resting on a second ear of the user, and separate arrays of microphones can be located proximate to each temple. As one example, based on audio data from microphones of the first temple recording a higher volume of the vocalizations of the user (e.g., higher amplitude audio signals), the AR headset can determine that the user is turning (e.g., moving their head) toward the first temple.

FIG. 1D shows the user performing a nodding gesture 142, and thereby causing an electronic message that includes spoken-word audio, in addition to the animated avatar 111, to be sent to another user of a different electronic device (e.g., the second user 151 of the wrist-wearable electronic device 150, shown in FIG. 1E). In some embodiments, head movements of the user 101 that are detected by the IMU sensors 192 of the AR headset 102 can be interpreted to cause starting, stopping, or sending an electronic message that the user 101 is composing via the AR headset 102. In some embodiments, the AR headset can automatically, without further intervention by the user 101, determine that the user 101 has finished composing an electronic communication based on a period of time (e.g., 5-10 ms) during which no vocalizations are detected by the one or more audio sensors 194 after the user 101 completes recording of the electronic communication. For example, the AR headset can determine that the user 101 has finished composing the electronic communication based on the user 101 ceasing to pronounce spoken words. In some embodiments, a particular set of spoken words of the user 101 and/or an inflection in the user's voice during pronunciation of one or more words can be used to determine that the user has finished composing the electronic communication.

FIG. 1E shows a second user 151 receiving the electronic message that was composed by the user 101 at the AR headset 102. The second user 151 is wearing a wrist-wearable device 150 that includes a touch-sensitive display, which is displaying a notification about receiving the electronic communication from the user 101. That is, the second user 151 is receiving a speech-based communication from a sending electronic device (e.g., the AR headset 102). In some embodiments, the wrist-wearable device 150 is caused to determine (e.g., via an instruction set stored on a non-transitory computer-readable storage medium stored in memory of the wrist-wearable device 150) what type of electronic device the user 101 used to compose the electronic message, in order to determine whether to display an animated avatar in conjunction with presenting the electronic communication. That is, in some embodiments, the wrist-wearable device receives one or more packets of data, and the instruction set stored on the non-transitory computer-readable storage medium that is stored in memory at the wrist-wearable device is caused to determine whether an avatar is to be presented alongside the speech-based communication that was received (e.g., whether respective data provided with the speech-based communication includes first data corresponding to animated head movements of the user 101, and second data corresponding to animated mouth movements of the user 101, which can occur if the receiving device is to prepare the animated avatar, whether a video file that includes an animated avatar was provided along with the speech-based communication, and/or whether a flag indicating presence of an animated avatar was provided with the speech-based communication). Based on the data included in conjunction with the electronic communication, the wrist-wearable device 150 can determine options for presenting the electronic communication to the second user 151.

FIG. 1F shows the second user 151 requesting to open the electronic message from the user 101 (e.g., in this example, the second user 151 utilizes an in-air hand gesture, which is illustrated as a contact between the receiving user's index finger and their thumb, to request opening of the electronic message). In some embodiments, in response to a request to view the electronic message from the sending electronic device, when the sending electronic device is an AR headset that includes one or more IMUs (e.g., the IMU sensors 192) the first speech-based communication is presented along with an avatar (e.g., the avatar 111) associated with the sending user. The avatar 111 is presented along with the first speech-based communication (e.g., the spoken words that were recorded while the user 101 was preparing the electronic message (e.g., in FIGS. 1B and 1C)). In some embodiments, the first speech-based communication is presented audibly to the second user 151 (e.g., via a microphone of the wrist-wearable device 150). In some embodiments, a separate visual indication (e.g., a sound indicator 166) is provided in conjunction with the animated avatar to indicate the speech-based communication. In some embodiments, subtitles are presented in conjunction with presenting the animated avatar 111. A selectable user interface element 162 is provided for the user to select to compose an audio message (e.g., a vocalization, such as a speech-based communication). Another selectable user interface element 164 is provided to allow the user to use default animation to present an animated avatar in conjunction with an electronic communication. In some embodiments, default animations are obtained via a machine-learning module for processing electronic communication data.

In some embodiments, the second user 151 can receive another electronic message from a different sending user than the user 101, or from the user 101 but not while the user 101 is wearing the AR headset 102, or while the user 101 is wearing the AR headset 102 but it is for some other reason not configured to animate head movements of the animated avatar 111 based on movement-related data from the IMU sensors 192. When the different sending electronic device is not an AR headset, the second speech-based communication is presented without using data from the IMU. In some embodiments, based on the electronic message not being presented as an animated avatar, presenting the second speech-based communication includes presenting a textual message (e.g., an SMS message) that corresponds to the vocalizations associated with the speech-based communication from the sending electronic device.

As compared to FIGS. 1E-1F, FIGS. 1G-1H illustrate the second user 151 utilizing an AR headset 154 to open the electronic communication (e.g., speech-based communication) composed by the sending user depicted in FIGS. 1A-1D. As such, FIG. 1G shows the second user 151 wearing an AR headset 154, and the AR headset 154 is presenting an electronic message indicating that the electronic message from the user 101 is available to view at the AR headset 154. In some embodiments, a notification can be provided to the second user 151 while the user 101 is in the process of recording or otherwise preparing the electronic message. That is, the notification can be presented at the AR headset 154 in real time when the user 101 begins recording the speech-based communications included in the electronic message. For example, a notification user-interface element 160 is presented at a lens portion of the AR headset 154, stating: “New audio message from Burt K. Perform pinch gesture to view audio message.”

FIG. 1H shows the animated avatar 111A being displayed at the AR headset 154 based on the second user 151 performing an in-air hand gesture to access the electronic communication from the user 101. In some embodiments, a user interface element (e.g., one of the user interface elements 170) can be presented to a user to allow the user to respond to an electronic communication that includes an animated avatar (e.g., the animated avatar 111A). In some embodiments, the second user 151 can engage in a real-time conversation with the user 101 based on a selection of a user interface element presented in conjunction with the electronic communication from the user 101. For example, the second user may select an option from the user interface elements 170 to allow the second user 151 to initiate an interactive electronic communication with the user 101, where a respective animated avatar of each user may be displayed at the AR headset 102 and the AR headset 154 while the interactive electronic communication is occurring.

In certain embodiments, the AR headsets described above do not include inward-facing cameras looking at a user's face and, thus, using non-camera-based sensors to animate an avatar is necessary to provide a visual reference for the user's face during an electronic communication (an asynchronous or synchronous one). Without this feature, other users receiving communications from the user (either in synchronous or asynchronous fashion) will lose the visual cues gained from viewing a visual representation of the user's face. Also, avoiding the need to add an inward-facing camera to an AR headset helps to ensure that the limited power supplies associated with the AR headsets can be focused on powering other necessary components and that limited processing power can be used for other components rather than diverted to assisting with processing camera data. All of these improvements provide for an improved man-machine interface and also enable sustained user interactions with AR headsets.

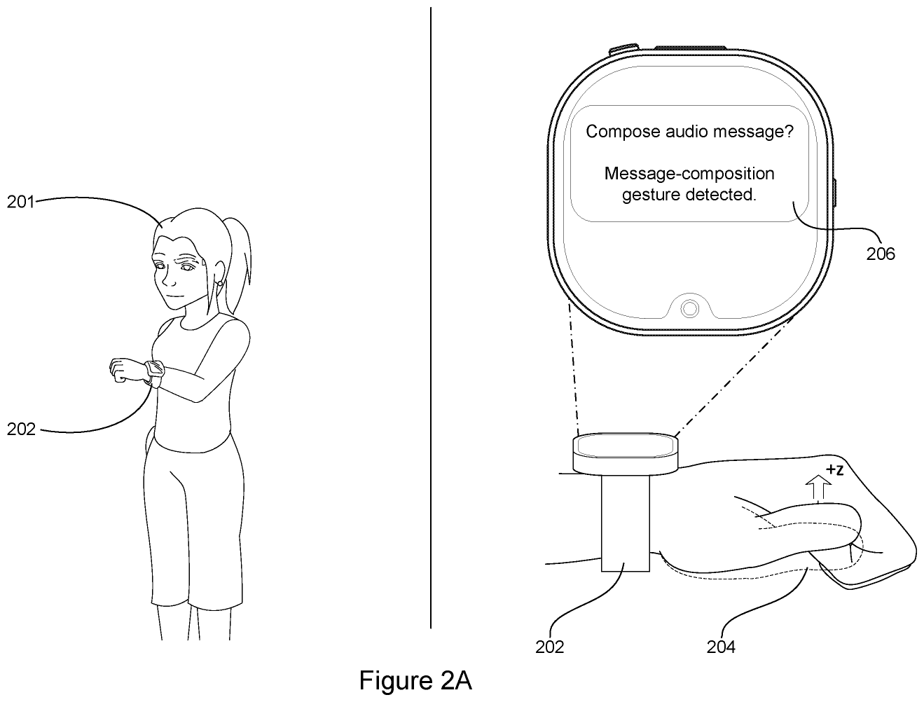

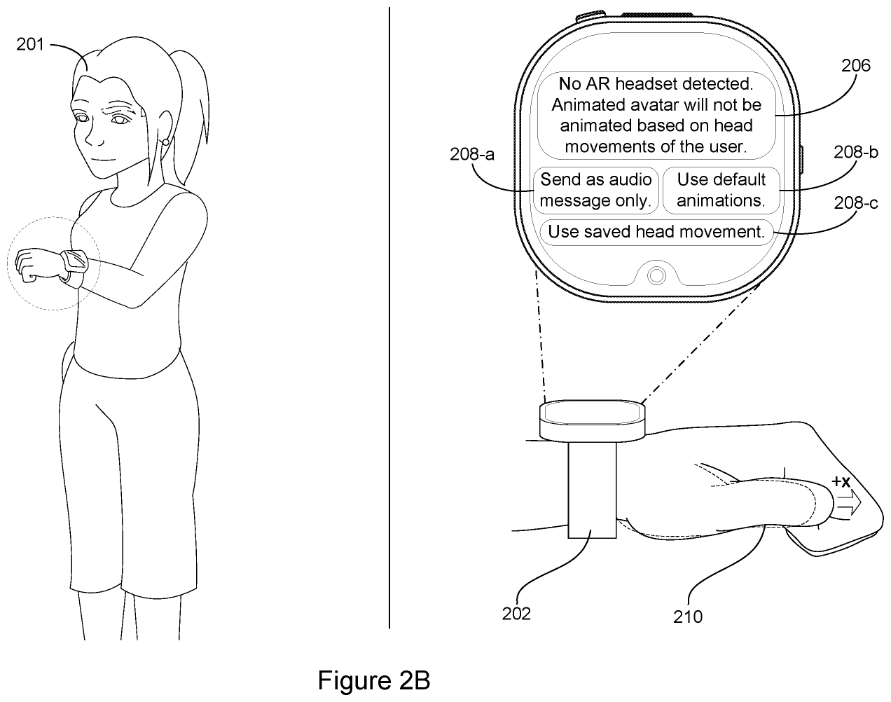

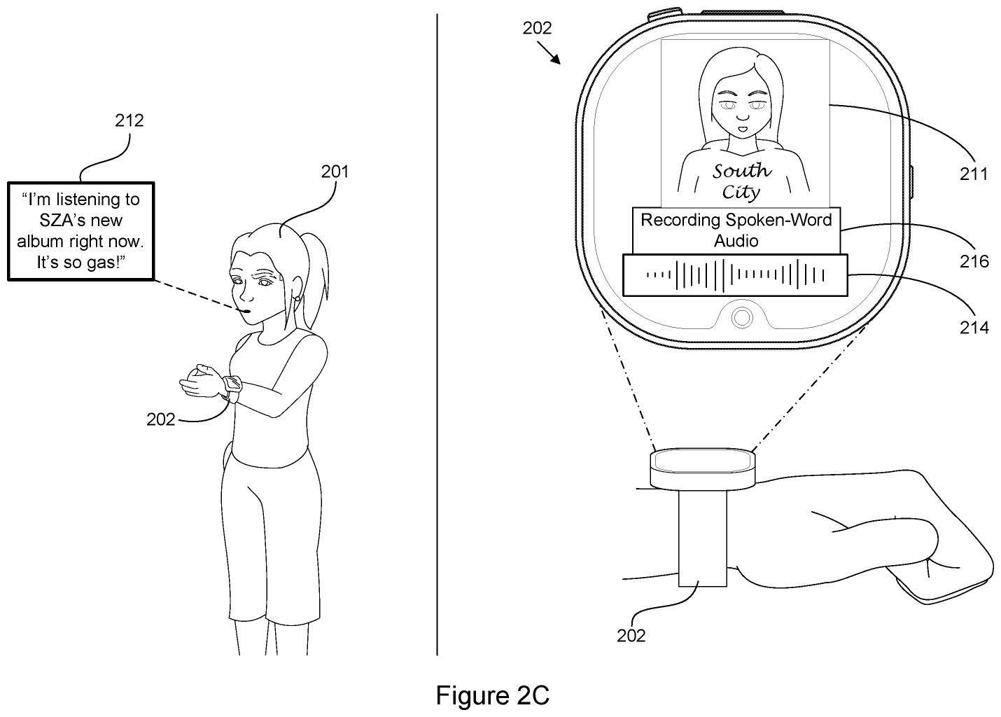

FIGS. 2A-2C show an example sequence in which a user composes an audio message using a device that is not an AR headset, along with an option to utilize an avatar with default animations, in accordance with some embodiments.

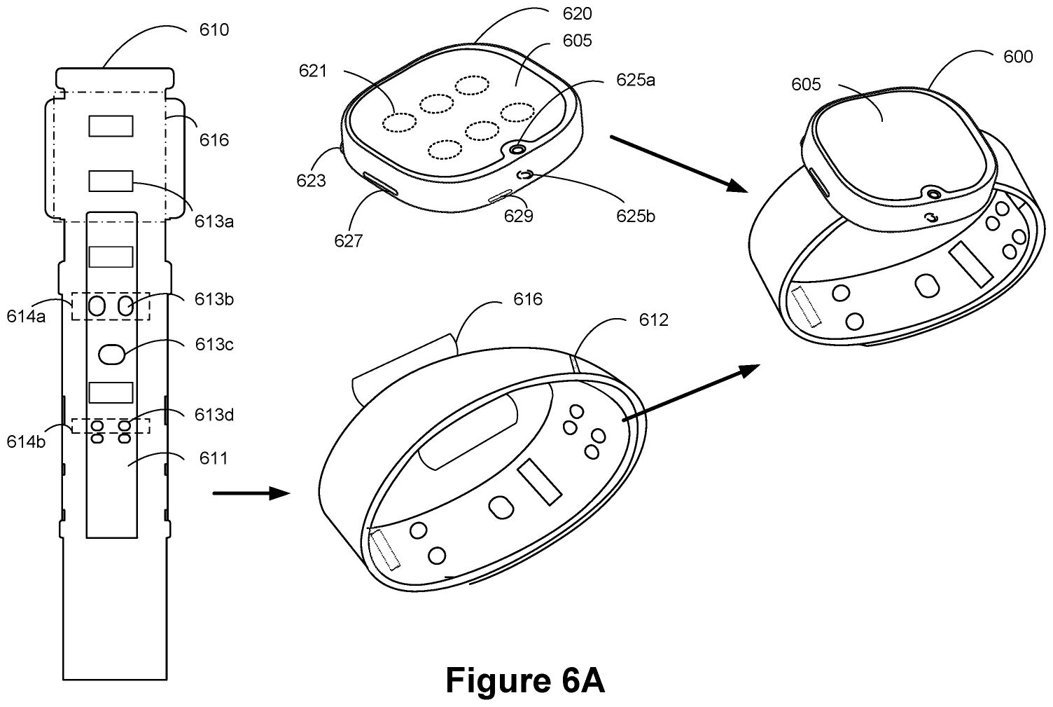

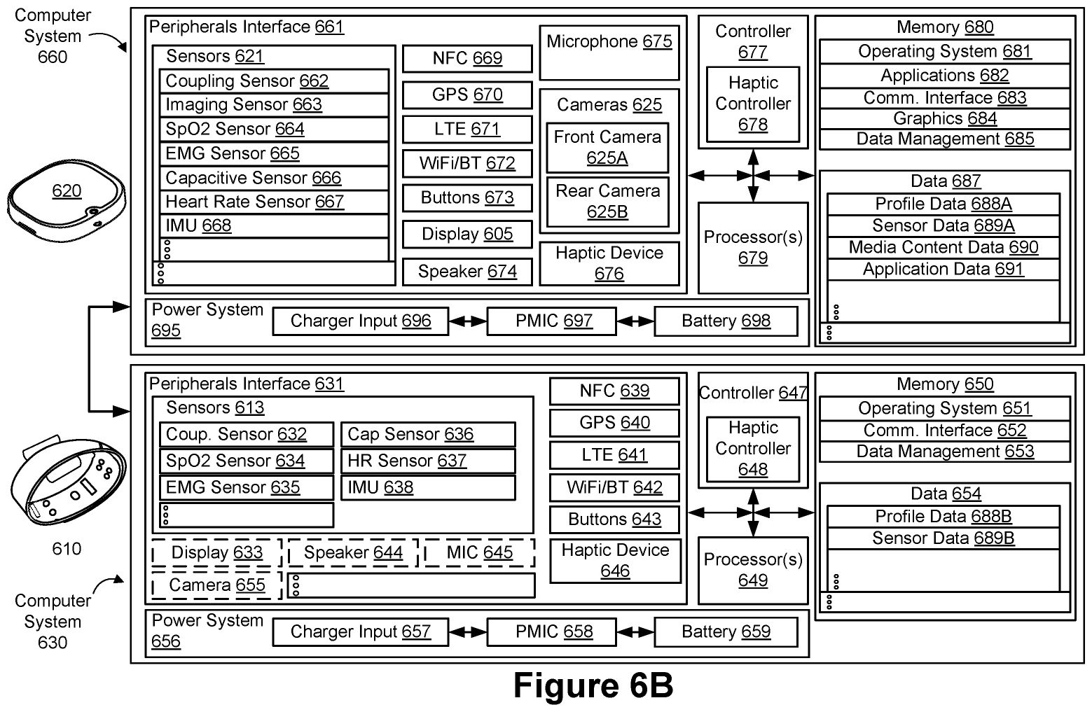

In FIG. 2A, a user 201 is wearing a wrist-wearable device, which is an example of the wrist-wearable device 600 described with respect to FIGS. 6A and 6B. The user 201 is performing an in-air hand gesture 204 that includes a thumb movement (e.g., a d-pad-like in-air hand gesture in which the thumb moves in an upward direction along the index finger on the depicted user's left hand), and a display of the wrist-wearable device is presenting a user interface element 206 that indicates that the gesture 204 is causing the wrist-wearable device 202 to initiate operations for composing an electronic message (stating: “Compose audio message? Message-composition gesture detected.”). In some embodiments, the wrist-wearable device 202 is configured to detect an audible signal from the user 201 that they are initiating operations to compose an electronic communication (e.g., spoken commands directed to the wrist-wearable device, such as directed to a virtual assistant that is executing at the wrist-wearable device).

In FIG. 2B, the display of the wrist-wearable device has been updated in response to the gesture 204 (from FIG. 2A) causing initiation of operations for composing an electronic message. The user 201, FIG. 2B, is performing a gesture 210 to select one of the updated user interface elements (206, 208-a, 208-b, and 208-c) shown on the display of the wrist-wearable device. A user interface element 206 is indicating to the user 201 that no AR headset is detected, and thus, head movements of an animated avatar will not be animated based on head movements of the user 201 while they are composing the electronic communication (stating: “No AR headset detected. Animated avatar will not be animated based on head movements of the user.”). In some embodiments, the wrist-wearable device 202 may check to determine other electronic devices that are being worn by the user 201, in conjunction with the determination that no AR headset is detected on the user 201. The wrist-wearable device 202 is also presenting selectable user interface elements for the user 201 to select how to prepare the electronic communication. A selectable user interface element 208-a allows the user 201 to send the electronic communication with only an audio-only message (stating: “Send as audio message only”) without an avatar. Another selectable user interface element 208-b allows the user 201 to send the electronic communication with default avatar animations (stating: “Use default animations.”). Yet another selectable user interface element 208-c allows the user 201 to send the electronic communication by animating an avatar using one or more saved head movements (stating: “Use saved head movements”). The gesture 210 shown in FIG. 2B results in a selection of user interface element 208-b.

FIG. 2C shows the user 201 preparing an electronic communication that includes an animated avatar 211 and audio content based on the user 201 enunciating vocalizations (e.g., spoken words 212) that are detected in data collected from audio sensors (e.g., a microphone 675 of the electronic device 600 discussed with respect to FIGS. 6A to 6B) of the wrist-wearable device 202. The animated avatar 211 does not include animated head movements that correspond to actual head movements of the user 201, based on the determination that the user 201 is not wearing an AR headset that includes an IMU sensor for tracking such head movements. Instead, a default set of animation characteristics is used to animate the avatar 211, which can be a slight swaying of the avatar's head back and forth during the message. A user interface element 214 is presented at the display of the wrist-wearable device 202, where the user interface element 214 indicates respective volumes of the electronic communication at discrete points in time. In some embodiments, the user 201 can configure which user interface elements are displayed in conjunction with the animated avatar in the electronic communication. A user interface element 216 indicates that the user 201 is recording spoken-word audio as part of the electronic communication.

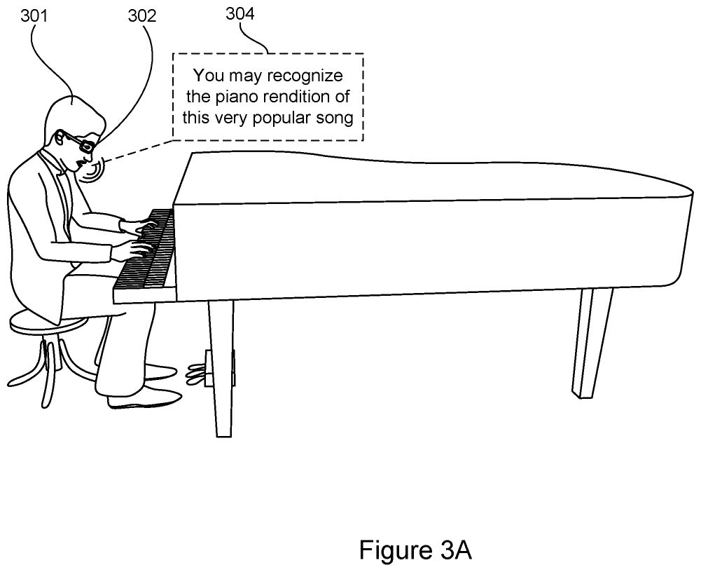

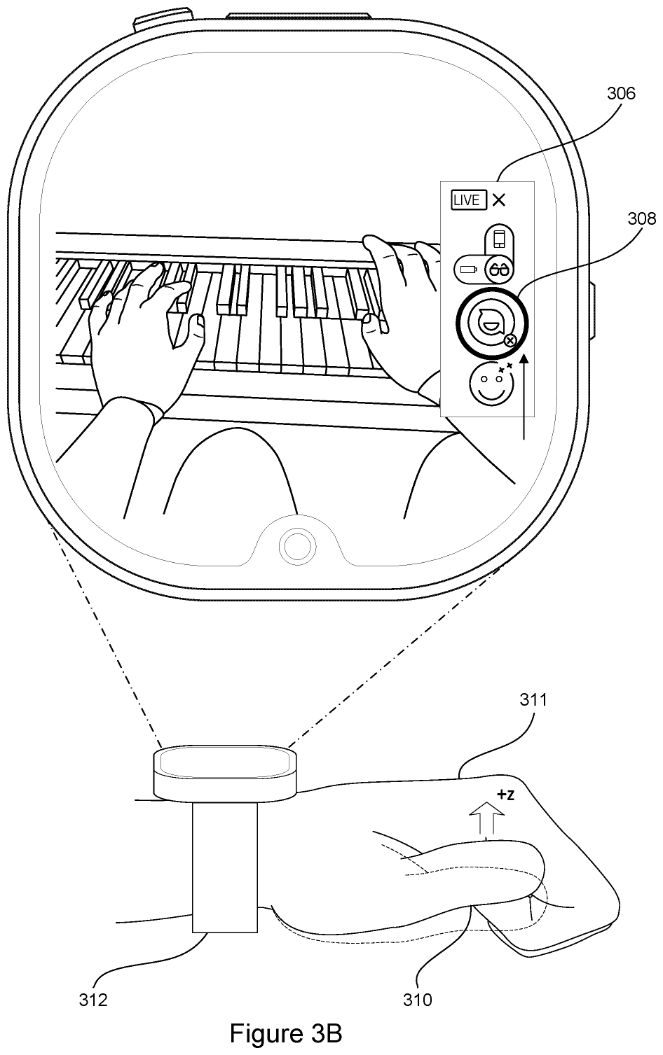

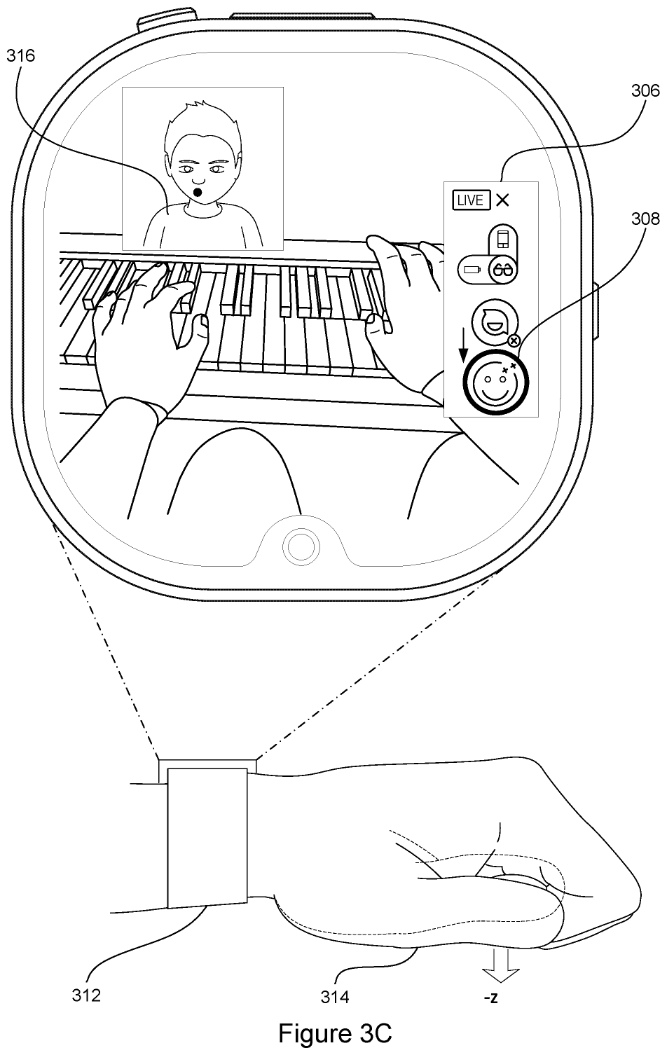

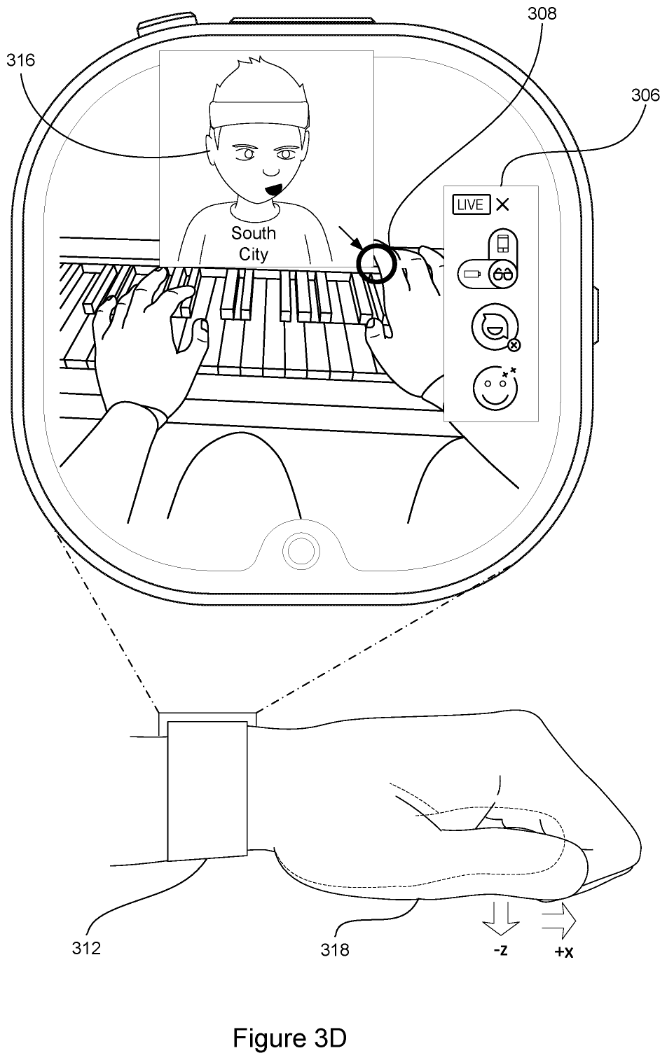

FIGS. 3A-3D show an example sequence in which an ongoing electronic communication (e.g., a live-streamed video) that includes an animated avatar is being presented at a display of a wrist-wearable device, in accordance with some embodiments.

FIG. 3A illustrates a user 301 of augmented-reality glasses 302 (e.g., an AR headset). The user 301 is recording themselves playing a piano while also capturing head movements and vocalizations (e.g., spoken words) via sensors on the AR headset. The user 301 is causing the electronic communication to be shared to a plurality of users whom the user 301 is connected with via a particular sharing application, such that that the user 301 can be understood to be providing livestreamed video contact to the plurality of users.

FIG. 3B illustrates a user 311 that is wearing a wrist-wearable device 312, and the wrist-wearable device 312 is displaying a livestream that is being recorded by the user 301 (e.g., this is a synchronous electronic communication in which the user 311 is viewing the livestream substantially at the same time that the user 301 is creating the livestream), as described with respect to FIG. 3A. The livestream is being prepared by the user 301, via the AR headset 302. The user 311 is performing an in-air hand gesture 310 that includes a thumb movement that is causing the focus selector 308 to move over a selectable option within the user interface element 306, where the selectable option is configured to cause an animated avatar of the user 301 to be displayed. In some embodiments, the selectable option for displaying the animated avatar of the user 301 has different visual properties based on whether the user 301 is capturing data for head movements and spoken words via an AR headset (e.g., the AR headset 302).

FIG. 3C shows the wrist-wearable device 312 displaying an animated avatar 316 that corresponds to the user 301. The animated avatar includes animated head movements that correspond to head movements of the user 301. And the animated avatar includes mouth movements that are based on vocalizations (e.g., spoken words) of the user 301. The animated avatar 316 includes physical features that are distinct from the actual physical features of the user 301, including the attire of the animated avatar. In some embodiments, users can select animated avatars to visually represent them via avatar animations that are distinct or include at least one distinct characteristic from the physical user.

FIG. 3D shows the wrist-wearable device 312 displaying a modified version of the animated avatar 316 based on the user 311 selecting the customization selectable element via the in-air hand gesture 318 shown in FIG. 3C. In some embodiments, the modified version of the animated avatar 316 includes customizations based on user-configurable settings of one or more of (i) the AR headset 302 being worn by the user 301 and (ii) the wrist-wearable device 312 being worn by the user 311. The user 301 is also performing a thumb movement in a downward diagonal direction (e.g., in the negative z direction and the positive x direction). Based on the thumb movement, a size of the animated avatar 316 may be caused to expand within the display of the wrist-wearable device 312. In some embodiments, the animated avatar 316 is configured to expand so as to not obscure an object of interest that is being shared in the electronic communication in conjunction with the animated avatar (e.g., the piano that the user 301 is playing).

In some embodiments, based on the user 311 expanding the view of the animated avatar 316 such that it would obscure the object of interest, the animated avatar is caused to move to a different portion of the lens of the AR headset 302. Examples of such re-positioning are shown and described with reference to FIGS. 4A-4E. In some embodiments, the user 301 can configure the electronic communication to restrict operations of the user 311 for re-sizing and/or re-positioning the animated avatar within the video content. For example, the user 301 can prevent the user 311 from expanding the user animated avatar such that it would obscure a particular aspect of the physical activity that the wearer is performing. For example, the user may configure the electronic communication such that the animated avatar 316 cannot be positioned to obscure a particular subset of the piano keys that the wearer will play during the electronic communication.

FIGS. 4A-4E show an example sequence of a user performing a physical activity while an animated avatar is presented at a lens portion of the user's AR headset, in accordance with some embodiments. Specifically, the sequence shows the animated avatar being displayed at various positions within a lens of the AR headset so as to avoid obstructing a portion of the user's field of view that is related to the performance of the physical activity. In some embodiments, the animated avatar is presented to the user 401 in a particular corner (e.g., a hot corner) of the AR headset 402. In some embodiments, the animated avatar 410 can be caused to grow or shrink based on whether the user 401 is actively engaged in an aspect of the physical activity (e.g., in the middle of swinging a golf club). In some embodiments, the user 401 can control (e.g., via an in-air hand gesture) where the animated avatar is presented within a field of view of the user 401. For example, the user can perform a particular pressing motion against a grip portion of the golf club to cause the animated avatar to be minimized out of the user's field of view until after they have completed performance of an aspect of the physical activity.

In FIG. 4A, the user 401 is approaching a golf ball 405 that is teed up in front of the user 401. The user 401 is wearing augmented-reality glasses 402, which are functioning as augmented-reality glasses (e.g., presenting user interface elements in one portion of a lens of the AR headset, while presenting an unobstructed view of the user's environment via another portion of the AR headset 402). An animated avatar 410 corresponding to the user 401 is presented within a first location of the lens of the augmented-reality glasses 402, which may be a default location (e.g., a hot corner) where the animated avatar is typically presented by default when the animated avatar 410 is configured to be presented. The animated avatar 410 includes physical features that are different from the physical features of the user 401, in accordance with some embodiments. In some embodiments, users can select one or more visual features of the appearances of their animated avatars (e.g., from a settings menu). In some embodiments, users can select particular visual features for the avatars based on a particular activity they are performing. For example, the user 401 may have selected a golf coach character as an avatar for presenting animations while the user is playing golf and livestreaming to followers on a particular social media application and may have selected a different character to be presented (e.g., a character that includes aspects of the user's own appearance) when the avatar is presented as part of different electronic communications where the user 401 is not livestreaming golf. In some embodiments, no user interface elements are presented in another lens of the augmented-reality glasses 402, such that the user 401 would be able to see through the other lens and view objects within the physical world and would not be seeing any electronically presented user interface on the other lens.

In some embodiments, the animated avatar 410 is presented in conjunction with recognition of a triggering event, such as the user 401 saying “Record me now.” In some embodiments, the triggering event is an automatic detection that the user 401 is performing a particular activity (e.g., swinging a golf club or playing a piano). In some embodiments, the triggering event is a selection by the user 401 to share an electronic communication via a sharing application (e.g., a messaging application and/or a social media application). In some embodiments, while the animated avatar 410 is caused to be presented within the lens of the AR headset, one or more objects of interest (e.g., the golf ball 405, a head of a golf club) are detected by the AR headset 402, and, after detecting one or more of the objects of interest within a field of view of the user 401, the animated avatar 410 is adjusted, such that the animated avatar 410 is not presented over an object of interest related to the activity.

In some embodiments, one or more notifications are presented to the user 401 in the course of identifying one or more objects of interest. For example, the augmented-reality glasses 402 can utilize an artificial-intelligence-based model to detect the object of interest and provide a notification to the user 401 asking the user 401 to confirm whether a particular object is an object of interest for a particular activity. In some embodiments, sensitivity settings can be configured at the augmented-reality glasses 402 such that the augmented-reality glasses 402 are more likely to minimize, move, or altogether stop presenting the animated avatar based on one or more objects of interest. For example, when the augmented-reality glasses 402 are configured with a particularly high sensitivity, any golf balls that are detected by the AR headset, even those corresponding to other users, may cause the animated avatar 410 to move to a different location within the lens of the AR headset.

In FIG. 4B, the user 401 is performing a head movement 412 that causes the golf ball 405 to be displayed at a different portion of the lens of the augmented-reality glasses 402. Specifically, since the user 401 has moved their head in a downward direction, as indicated by the head movement 412, the golf ball 405 is in a higher portion of the lens of the AR headset, in a location near where the animated avatar 410 was presented in FIG. 4A. Based on the movement of the golf ball 405 within the lens of the AR headset, the animated avatar 410 is moved to a different position within the lens, such that it is then presented at a bottom right corner of the lens of the augmented-reality glasses 402. In some embodiments, a placeholder object 414 is placed in the hot corner to indicate that the animated avatar 410 is in a different location than a default location defined by the hot corner.

In FIG. 4C, the user 401 has performed a particular grip gesture, which can be detected by biopotential sensors, such as one or more neuromuscular sensors (e.g., electromyography (EMG) sensors), of the wrist-wearable device 404. Based on the user performing the grip gesture, the animated avatar 410 is minimized to a smaller size and is returned to the hot corner of the lens portion where the animated avatar 410 was originally displayed. In some embodiments, the animated avatar 410 ceases to be presented based on the user 401 performing the particular grip gesture, or otherwise indicating that they are performing an aspect of a physical activity.

FIG. 4D shows the user 401 swinging the golf club and hitting the golf ball 405, such that the golf ball 405 is no longer present within an unobstructed portion of the lens of the augmented-reality glasses of the user 401. In some embodiments, data from one or more sensors of the wrist-wearable device 404 can be used to determine a visual aspect of the animated avatar 410. For example, a user interface element 422 shown in the lens of the augmented-reality glasses 402 indicates (stating: “Repetition of the physical activity has been detected. Exertion Level: High Swing Velocity: 30 meters/second”) that the user 401 has completed a repetition of the physical activity related to the object of interest (the golf ball).

FIG. 4E shows the user 401 performing an in-air hand gesture 424 that includes movement of an index finger of the user 401. Based on the user 401 performing the in-air hand gesture 424, the animated avatar 410 is displayed within a larger central portion of the lens of the augmented-reality glasses 402. In some embodiments, while the animated avatar is presented in certain configurations, such as the configuration shown in FIG. 4E, additional options are available for message composition, including for modifying the animated avatar. For example, a user interface element 426 is presented within the lens of the augmented-reality glasses 402, which includes a selectable user interface element for allowing the user to apply a device customization to the animated avatar 410. For example, the user 401 can apply a customization to the animated avatar 410 based on a device identifier of the wrist-wearable device 404 or the augmented-reality glasses 402. In some embodiments, the device identifier can cause the animated avatar to be displayed with a virtual accessory device, such as a virtual representation of the particular device associated with the device identifier (e.g., a virtual wristband corresponding to a device identifier of the wrist-wearable device 404). In some embodiments, the device identifier causes one or more elements of the animated avatar 410 to be depicted with a particular animation style (e.g., to include logos of a particular sports team). In some embodiments, the animated avatar 410 can include an animated hand movement corresponding with the in-air hand gesture 424 performed by the user 401.

Example systems used to enable the interactions described above will now be described.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 600, a head-wearable device, an HIPD 800, a smart textile-based garment 900, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

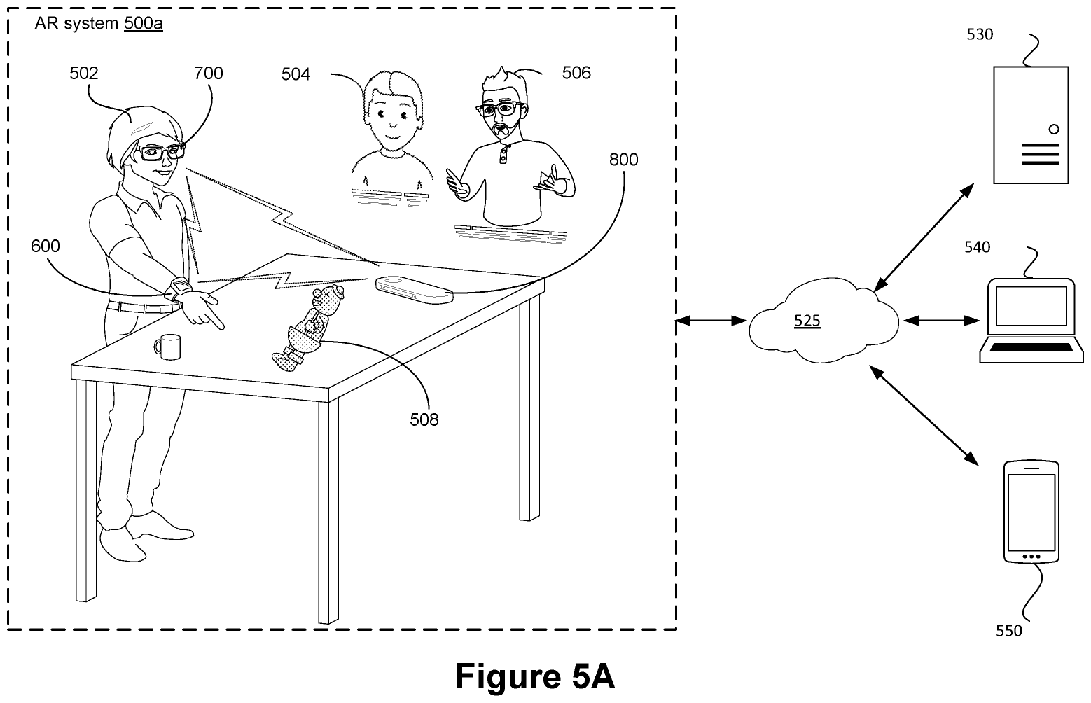

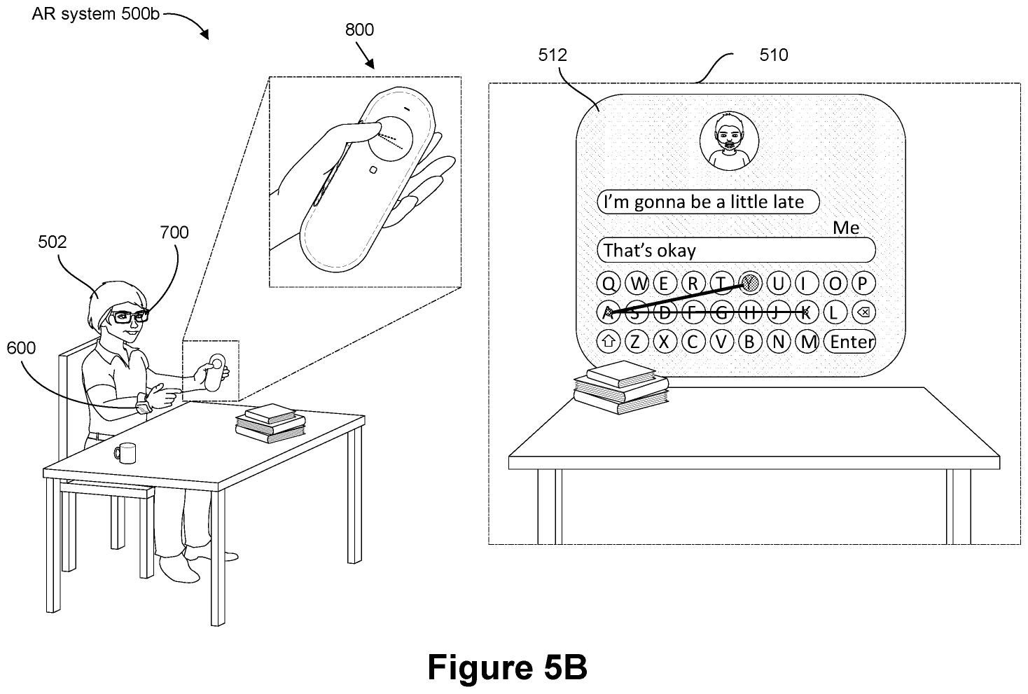

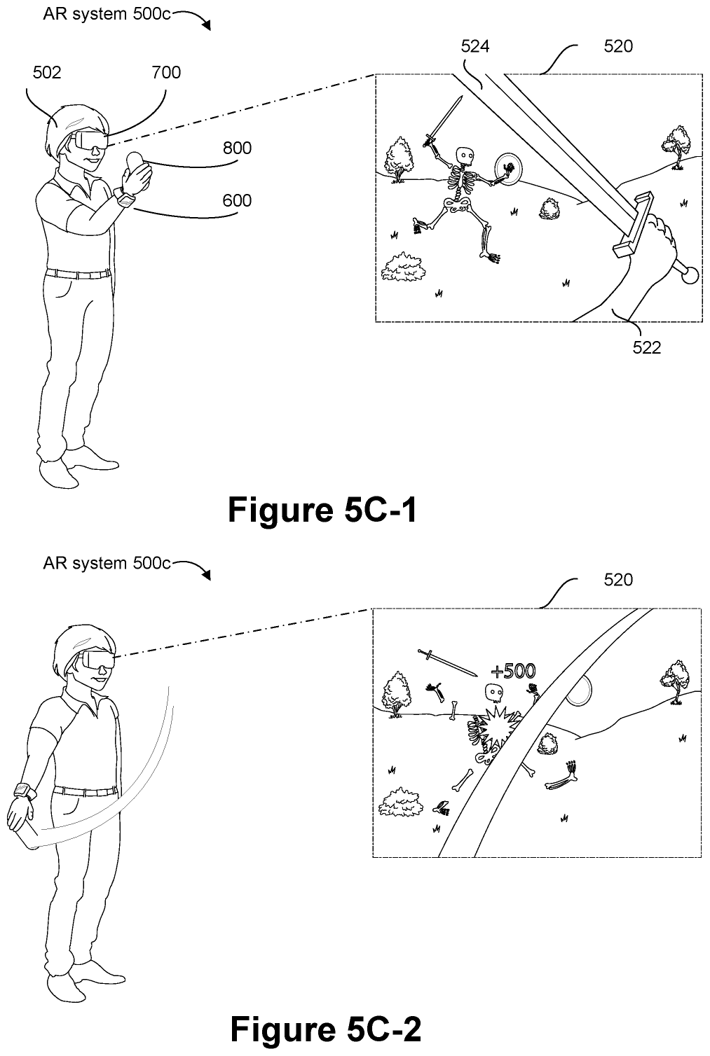

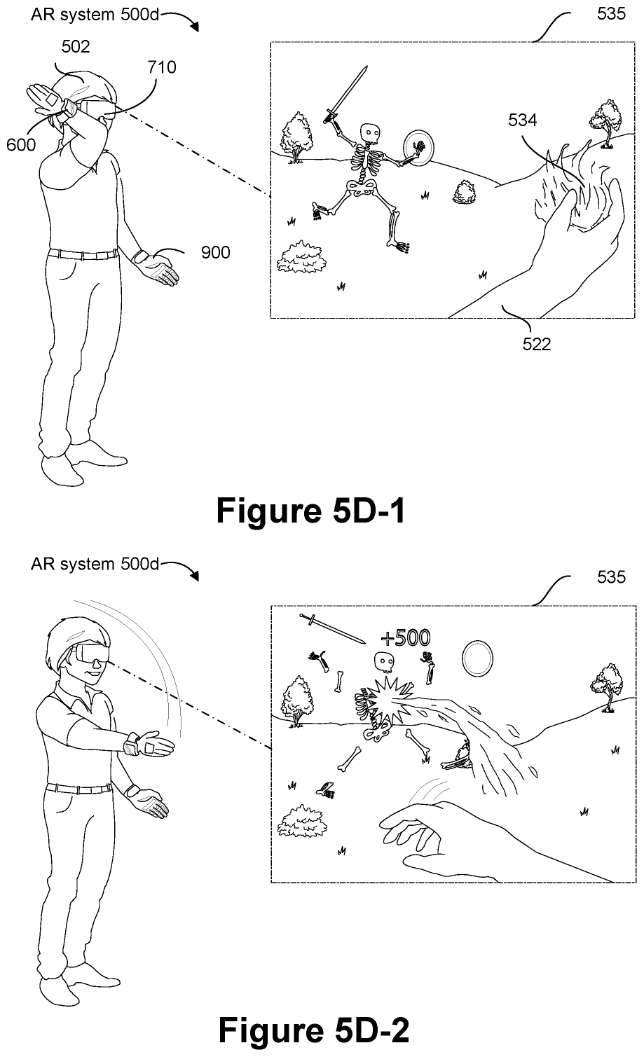

FIGS. 5A 5B, 5C-1, 5C-2, 5D-1, and 5D-2 illustrate example artificial-reality systems, in accordance with some embodiments. FIG. 5A shows a first AR system 500a and first example user interactions using a wrist-wearable device 600, a head-wearable device (e.g., AR device 700), and/or a handheld intermediary processing device (HIPD) 800. FIG. 5B shows a second AR system 500b and second example user interactions using a wrist-wearable device 600, AR device 700, and/or an HIPD 800. FIGS. 5C-1 and 5C-2 show a third AR system 500c and third example user interactions using a wrist-wearable device 600, a head-wearable device (e.g., virtual-reality (VR) device 710), and/or an HIPD 800. FIGS. 5D-1 and 5D-2 show a fourth AR system 500d and fourth example user interactions using a wrist-wearable device 600, VR device 710, and/or a smart textile-based garment 900 (e.g., wearable gloves haptic gloves). As the skilled artisan will appreciate upon reading the descriptions provided herein, the above-example AR systems (described in detail below) can perform various functions and/or operations described above with reference to FIGS. 1A to 4E.

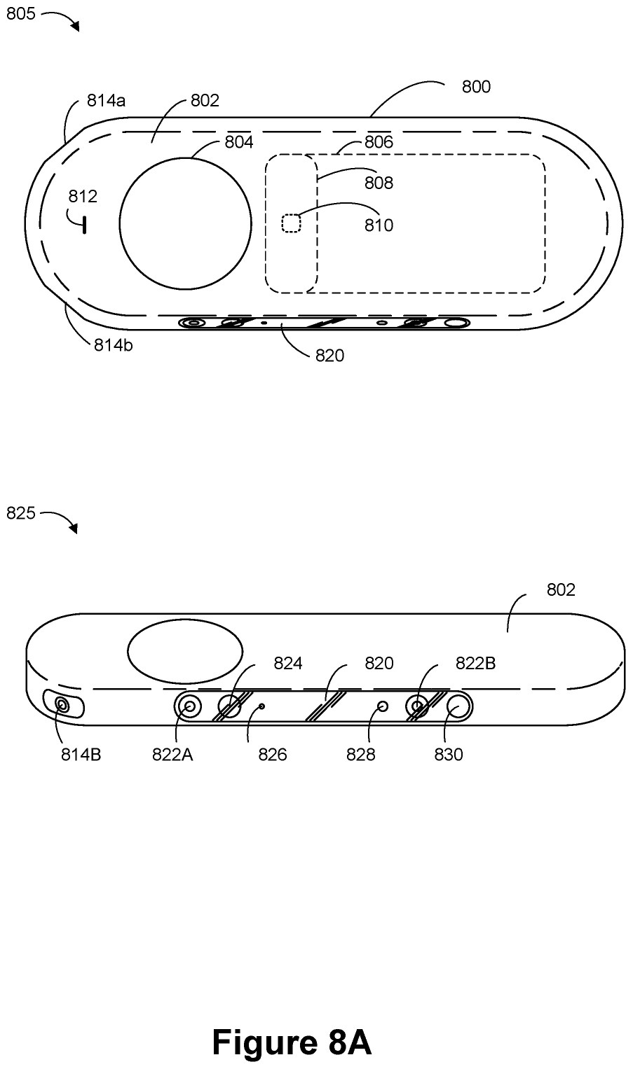

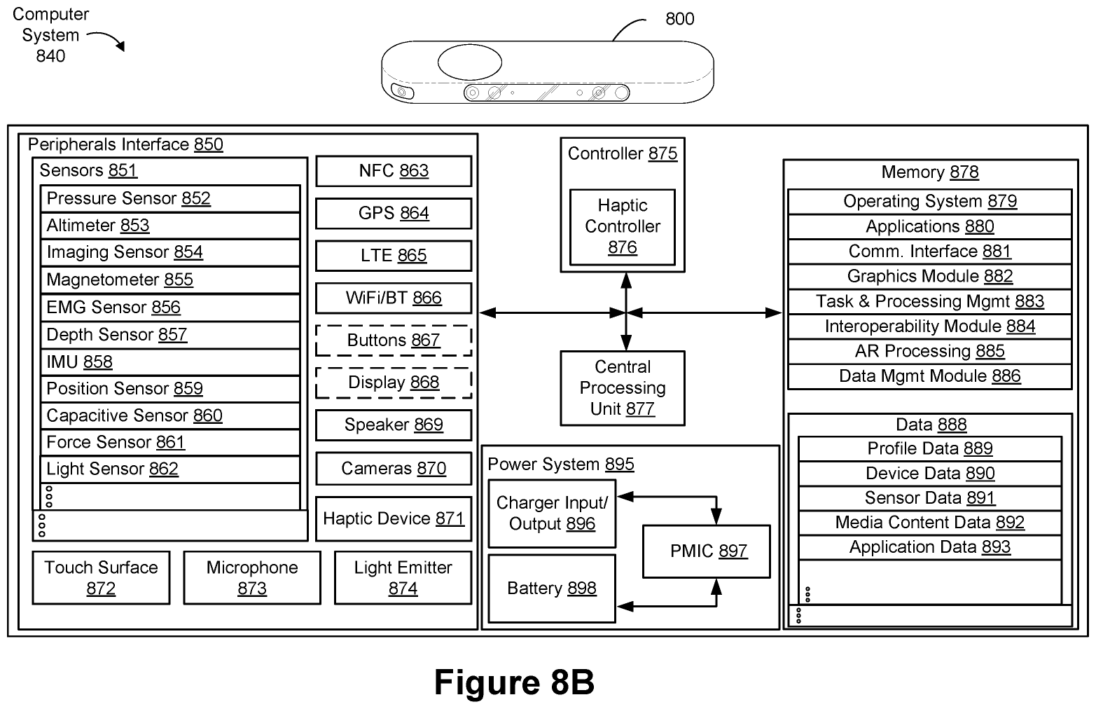

The wrist-wearable device 600 and its constituent components are described below in reference to FIGS. 6A-6B, the head-wearable devices and their constituent components are described below in reference to FIGS. 7A-7D, and the HIPD 800 and its constituent components are described below in reference to FIGS. 8A-8B. The wrist-wearable device 600, the head-wearable devices, and/or the HIPD 800 can communicatively couple via a network 525 (e.g., cellular, near field, Wi-Fi, personal area network, wireless LAN, etc.). Additionally, the wrist-wearable device 600, the head-wearable devices, and/or the HIPD 800 can also communicatively couple with one or more servers 530, computers 540 (e.g., laptops, computers, etc.), mobile devices 550 (e.g., smartphones, tablets, etc.), and/or other electronic devices via the network 525 (e.g., cellular, near field, Wi-Fi, personal area network, wireless LAN, etc.)

Turning to FIG. 5A, a user 502 is shown wearing the wrist-wearable device 600 and the AR device 700 and having the HIPD 800 on their desk. The wrist-wearable device 600, the AR device 700, and the HIPD 800 facilitate user interaction with an AR environment. In particular, as shown by the first AR system 500a, the wrist-wearable device 600, the AR device 700, and/or the HIPD 800 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 600, the AR device 700, and/or the HIPD 800.

The user 502 can use any of the wrist-wearable device 600, the AR device 700, and/or the HIPD 800 to provide user inputs. For example, the user 502 can perform one or more hand gestures that are detected by the wrist-wearable device 600 (e.g., using one or more EMG sensors and/or IMUs, described below in reference to FIGS. 6A-6B) and/or AR device 700 (e.g., using one or more image sensors or cameras, described below in reference to FIGS. 7A-7B) to provide a user input. Alternatively, or additionally, the user 502 can provide a user input via one or more touch surfaces of the wrist-wearable device 600, the AR device 700, and/or the HIPD 800, and/or voice commands captured by a microphone of the wrist-wearable device 600, the AR device 700, and/or the HIPD 800. In some embodiments, the wrist-wearable device 600, the AR device 700, and/or the HIPD 800 include a digital assistant to help the user in providing a user input (e.g., completing a sequence of operations, suggesting different operations or commands, providing reminders, confirming a command). In some embodiments, the user 502 can provide a user input via one or more facial gestures and/or facial expressions. For example, cameras of the wrist-wearable device 600, the AR device 700, and/or the HIPD 800 can track the user 502's eyes for navigating a user interface.

The wrist-wearable device 600, the AR device 700, and/or the HIPD 800 can operate alone or in conjunction to allow the user 502 to interact with the AR environment. In some embodiments, the HIPD 800 is configured to operate as a central hub or control center for the wrist-wearable device 600, the AR device 700, and/or another communicatively coupled device. For example, the user 502 can provide an input to interact with the AR environment at any of the wrist-wearable device 600, the AR device 700, and/or the HIPD 800, and the HIPD 800 can identify one or more back-end and front-end tasks to cause the performance of the requested interaction and distribute instructions to cause the performance of the one or more back-end and front-end tasks at the wrist-wearable device 600, the AR device 700, and/or the HIPD 800. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. 8A-8B, the HIPD 800 can perform the back-end tasks and provide the wrist-wearable device 600 and/or the AR device 700 operational data corresponding to the performed back-end tasks such that the wrist-wearable device 600 and/or the AR device 700 can perform the front-end tasks. In this way, the HIPD 800, which has more computational resources and greater thermal headroom than the wrist-wearable device 600 and/or the AR device 700, performs computationally intensive tasks and reduces the computer resource utilization and/or power usage of the wrist-wearable device 600 and/or the AR device 700.

In the example shown by the first AR system 500a, the HIPD 800 identifies one or more back-end tasks and front-end tasks associated with a user request to initiate an AR video call with one or more other users (represented by the avatar 504 and the digital representation of the contact 506) and distributes instructions to cause the performance of the one or more back-end tasks and front-end tasks. In particular, the HIPD 800 performs back-end tasks for processing and/or rendering image data (and other data) associated with the AR video call and provides operational data associated with the performed back-end tasks to the AR device 700 such that the AR device 700 performs front-end tasks for presenting the AR video call (e.g., presenting the avatar 504 and the digital representation of the contact 506).

In some embodiments, the HIPD 800 can operate as a focal or anchor point for causing the presentation of information. This allows the user 502 to be generally aware of where information is presented. For example, as shown in the first AR system 500a, the avatar 504 and the digital representation of the contact 506 are presented above the HIPD 800. In particular, the HIPD 800 and the AR device 700 operate in conjunction to determine a location for presenting the avatar 504 and the digital representation of the contact 506. In some embodiments, information can be presented within a predetermined distance from the HIPD 800 (e.g., within five meters). For example, as shown in the first AR system 500a, virtual object 508 is presented on the desk some distance from the HIPD 800. Similar to the above example, the HIPD 800 and the AR device 700 can operate in conjunction to determine a location for presenting the virtual object 508. Alternatively, in some embodiments, presentation of information is not bound by the HIPD 800. More specifically, the avatar 504, the digital representation of the contact 506, and the virtual object 508 do not have to be presented within a predetermined distance of the HIPD 800.

User inputs provided at the wrist-wearable device 600, the AR device 700, and/or the HIPD 800 are coordinated such that the user can use any device to initiate, continue, and/or complete an operation. For example, the user 502 can provide a user input to the AR device 700 to cause the AR device 700 to present the virtual object 508 and, while the virtual object 508 is presented by the AR device 700, the user 502 can provide one or more hand gestures via the wrist-wearable device 600 to interact and/or manipulate the virtual object 508.

FIG. 5B shows the user 502 wearing the wrist-wearable device 600 and the AR device 700 and holding the HIPD 800. In the second AR system 500b, the wrist-wearable device 600, the AR device 700, and/or the HIPD 800 are used to receive and/or provide one or more messages to a contact of the user 502. In particular, the wrist-wearable device 600, the AR device 700, and/or the HIPD 800 detect and coordinate one or more user inputs to initiate a messaging application and prepare a response to a received message via the messaging application.

In some embodiments, the user 502 initiates, via a user input, an application on the wrist-wearable device 600, the AR device 700, and/or the HIPD 800 that causes the application to initiate on at least one device. For example, in the second AR system 500b the user 502 performs a hand gesture associated with a command for initiating a messaging application (represented by messaging user interface 512); the wrist-wearable device 600 detects the hand gesture; and, based on a determination that the user 502 is wearing AR device 700, causes the AR device 700 to present a messaging user interface 512 of the messaging application. The AR device 700 can present the messaging user interface 512 to the user 502 via its display (e.g., as shown by user 502's field of view 510). In some embodiments, the application is initiated and can be run on the device (e.g., the wrist-wearable device 600, the AR device 700, and/or the HIPD 800) that detects the user input to initiate the application, and the device provides another device operational data to cause the presentation of the messaging application. For example, the wrist-wearable device 600 can detect the user input to initiate a messaging application, initiate and run the messaging application, and provide operational data to the AR device 700 and/or the HIPD 800 to cause presentation of the messaging application. Alternatively, the application can be initiated and run at a device other than the device that detected the user input. For example, the wrist-wearable device 600 can detect the hand gesture associated with initiating the messaging application and cause the HIPD 800 to run the messaging application and coordinate the presentation of the messaging application.

Further, the user 502 can provide a user input provided at the wrist-wearable device 600, the AR device 700, and/or the HIPD 800 to continue and/or complete an operation initiated at another device. For example, after initiating the messaging application via the wrist-wearable device 600 and while the AR device 700 presents the messaging user interface 512, the user 502 can provide an input at the HIPD 800 to prepare a response (e.g., shown by the swipe gesture performed on the HIPD 800). The user 502's gestures performed on the HIPD 800 can be provided and/or displayed on another device. For example, the user 502's swipe gestures performed on the HIPD 800 are displayed on a virtual keyboard of the messaging user interface 512 displayed by the AR device 700.

In some embodiments, the wrist-wearable device 600, the AR device 700, the HIPD 800, and/or other communicatively coupled devices can present one or more notifications to the user 502. The notification can be an indication of a new message, an incoming call, an application update, a status update, etc. The user 502 can select the notification via the wrist-wearable device 600, the AR device 700, or the HIPD 800 and cause presentation of an application or operation associated with the notification on at least one device. For example, the user 502 can receive a notification that a message was received at the wrist-wearable device 600, the AR device 700, the HIPD 800, and/or other communicatively coupled device and provide a user input at the wrist-wearable device 600, the AR device 700, and/or the HIPD 800 to review the notification, and the device detecting the user input can cause an application associated with the notification to be initiated and/or presented at the wrist-wearable device 600, the AR device 700, and/or the HIPD 800.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 700 can present to the user 502 game application data and the HIPD 800 can use a controller to provide inputs to the game. Similarly, the user 502 can use the wrist-wearable device 600 to initiate a camera of the AR device 700, and the user can use the wrist-wearable device 600, the AR device 700, and/or the HIPD 800 to manipulate the image capture (e.g., zoom in or out, apply filters, etc.) and capture image data.

Turning to FIGS. 5C-1 and 5C-2, the user 502 is shown wearing the wrist-wearable device 600 and a VR device 710 and holding the HIPD 800. In the third AR system 500c, the wrist-wearable device 600, the VR device 710, and/or the HIPD 800 are used to interact within an AR environment, such as a VR game or other AR application. While the VR device 710 present a representation of a VR game (e.g., first AR game environment 520) to the user 502, the wrist-wearable device 600, the VR device 710, and/or the HIPD 800 detect and coordinate one or more user inputs to allow the user 502 to interact with the VR game.

In some embodiments, the user 502 can provide a user input via the wrist-wearable device 600, the VR device 710, and/or the HIPD 800 that causes an action in a corresponding AR environment. For example, the user 502 in the third AR system 500c (shown in FIG. 5C-1) raises the HIPD 800 to prepare for a swing in the first AR game environment 520. The VR device 710, responsive to the user 502 raising the HIPD 800, causes the AR representation of the user 522 to perform a similar action (e.g., raise a virtual object, such as a virtual sword 524). In some embodiments, each device uses respective sensor data and/or image data to detect the user input and provide an accurate representation of the user 502's motion. For example, image sensors 858 (e.g., SLAM cameras or other cameras discussed below in FIGS. 8A and 8B) of the HIPD 800 can be used to detect a position of the 800 relative to the user 502's body such that the virtual object can be positioned appropriately within the first AR game environment 520; sensor data from the wrist-wearable device 600 can be used to detect a velocity at which the user 502 raises the HIPD 800 such that the AR representation of the user 522 and the virtual sword 524 are synchronized with the user 502's movements; and image sensors 726 (FIGS. 7A-7C) of the VR device 710 can be used to represent the user 502's body, boundary conditions, or real-world objects within the first AR game environment 520.

In FIG. 5C-2, the user 502 performs a downward swing while holding the HIPD 800. The user 502's downward swing is detected by the wrist-wearable device 600, the VR device 710, and/or the HIPD 800 and a corresponding action is performed in the first AR game environment 520. In some embodiments, the data captured by each device is used to improve the user's experience within the AR environment. For example, sensor data of the wrist-wearable device 600 can be used to determine a speed and/or force at which the downward swing is performed and image sensors of the HIPD 800 and/or the VR device 710 can be used to determine a location of the swing and how it should be represented in the first AR game environment 520, which, in turn, can be used as inputs for the AR environment (e.g., game mechanics, which can use detected speed, force, locations, and/or aspects of the user 502's actions to classify a user's inputs (e.g., user performs a light strike, hard strike, critical strike, glancing strike, miss) or calculate an output (e.g., amount of damage)).

While the wrist-wearable device 600, the VR device 710, and/or the HIPD 800 are described as detecting user inputs, in some embodiments, user inputs are detected at a single device (with the single device being responsible for distributing signals to the other devices for performing the user input). For example, the HIPD 800 can operate an application for generating the first AR game environment 520 and provide the VR device 710 with corresponding data for causing the presentation of the first AR game environment 520, as well as detect the 502's movements (while holding the HIPD 800) to cause the performance of corresponding actions within the first AR game environment 520. Additionally, or alternatively, in some embodiments, operational data (e.g., sensor data, image data, application data, device data, and/or other data) of one or more devices is provide to a single device (e.g., the HIPD 800) to process the operational data and cause respective devices to perform an action associated with processed operational data.

FIGS. 5D-1 and 5D-2, the user 502 is shown wearing the wrist-wearable device 600, the VR device 710, smart textile-based garments 900. In the fourth AR system 500d, the wrist-wearable device 600, the VR device 710, and/or the smart textile-based garments 900 are used to interact within an AR environment (e.g., any AR system described above in reference to FIGS. 5A-5C-2, as well as FIGS. 1A to 4E). While the VR device 710 present a representation of a VR game (e.g., second AR game environment 530) to the user 502, the wrist-wearable device 600, the VR device 710, and/or the smart textile-based garments 900 detect and coordinate one or more user inputs to allow the user 502 to interact with the AR environment.

In some embodiments, the user 502 can provide a user input via the wrist-wearable device 600, the VR device 710, and/or the smart textile-based garments 900 that causes an action in a corresponding AR environment. For example, the user 502 in the fourth AR system 500d (shown in FIG. 5D-1) raises a hand wearing the smart textile-based garments 900 to prepare for cast spell or throw an object within the second AR game environment 530. The VR device 710, responsive to the user 502 holding up their hand (wearing a smart textile-based garments 900), causes the AR representation of the user 522 to perform a similar action (e.g., hold a virtual object, such as a casting a fireball 534). In some embodiments, each device uses respective sensor data and/or image data to detect the user input and provide an accurate representation of the user 502's motion.

In FIG. 5D-2, the user 502 performs a throwing motion while wearing the smart textile-based garment 900. The user 502's throwing motion is detected by the wrist-wearable device 600, the VR device 710, and/or the smart textile-based garments 900 and a corresponding action is performed in the second AR game environment 530. As described above, the data captured by each device is used to improve the user's experience within the AR environment. Although not shown, the smart textile-based garments 900 can be used in conjunction with an AR device 710 and/or an HIPD 800.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 6A and 6B illustrate an example wrist-wearable device 600, in accordance with some embodiments. The wrist-wearable device 600 is an instance of the wrist-wearable device 108 described in reference to FIGS. 1A to 1H herein, such that the wrist-wearable devices should be understood to have the features of the wrist-wearable device 600 and vice versa. FIG. 6A illustrates components of the wrist-wearable device 600, which can be used individually or in combination, including combinations that include other electronic devices and/or electronic components.

FIG. 6A shows a wearable band 610 and a watch body 620 (or capsule) being coupled, as discussed below, to form the wrist-wearable device 600. The wrist-wearable device 600 can perform various functions and/or operations associated with navigating through user interfaces and selectively opening applications.

As will be described in more detail below, operations executed by the wrist-wearable device 600 can include (i) presenting content to a user (e.g., displaying visual content via a display 605); (ii) detecting (e.g., sensing) user input (e.g., sensing a touch on peripheral button 623 and/or at a touch screen of the display 605, a hand gesture detected by sensors (e.g., biopotential sensors)); (iii) sensing biometric data via one or more sensors 613 (e.g., neuromuscular signals, heart rate, temperature, sleep, etc.); messaging (e.g., text, speech, video, etc.); image capture via one or more imaging devices or cameras 625; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 620, independently in the wearable band 610, and/or via an electronic communication between the watch body 620 and the wearable band 610. In some embodiments, functions can be executed on the wrist-wearable device 600 while an AR environment is being presented (e.g., via one of the AR systems 500a to 500d). As the skilled artisan will appreciate upon reading the descriptions provided herein, the novel wearable devices described herein can be used with other types of AR environments.

The wearable band 610 can be configured to be worn by a user such that an inner (or inside) surface of the wearable structure 611 of the wearable band 610 is in contact with the user's skin. When worn by a user, sensors 613 contact the user's skin. The sensors 613 can sense biometric data such as a user's heart rate, saturated oxygen level, temperature, sweat level, neuromuscular signal sensors, or a combination thereof. The sensors 613 can also sense data about a user's environment, including a user's motion, altitude, location, orientation, gait, acceleration, position, or a combination thereof. In some embodiments, the sensors 613 are configured to track a position and/or motion of the wearable band 610. The one or more sensors 613 can include any of the sensors defined above and/or discussed below with respect to FIG. 6B.

The one or more sensors 613 can be distributed on an inside and/or an outside surface of the wearable band 610. In some embodiments, the one or more sensors 613 are uniformly spaced along the wearable band 610. Alternatively, in some embodiments, the one or more sensors 613 are positioned at distinct points along the wearable band 610. As shown in FIG. 6A, the one or more sensors 613 can be the same or distinct. For example, in some embodiments, the one or more sensors 613 can be shaped as a pill (e.g., sensor 613a), an oval, a circle a square, an oblong (e.g., sensor 613c) and/or any other shape that maintains contact with the user's skin (e.g., such that neuromuscular signal and/or other biometric data can be accurately measured at the user's skin). In some embodiments, the one or more sensors 613 are aligned to form pairs of sensors (e.g., for sensing neuromuscular signals based on differential sensing within each respective sensor). For example, sensor 613b is aligned with an adjacent sensor to form sensor pair 614a and sensor 613d is aligned with an adjacent sensor to form sensor pair 614b. In some embodiments, the wearable band 610 does not have a sensor pair. Alternatively, in some embodiments, the wearable band 610 has a predetermined number of sensor pairs (one pair of sensors, three pairs of sensors, four pairs of sensors, six pairs of sensors, sixteen pairs of sensors, etc.).

The wearable band 610 can include any suitable number of sensors 613. In some embodiments, the number and arrangements of sensors 613 depend on the particular application for which the wearable band 610 is used. For instance, a wearable band 610 configured as an armband, wristband, or chest-band may include a plurality of sensors 613 with different number of sensors 613 and different arrangement for each use case, such as medical use cases, compared to gaming or general day-to-day use cases.

In accordance with some embodiments, the wearable band 610 further includes an electrical ground electrode and a shielding electrode. The electrical ground and shielding electrodes, like the sensors 613, can be distributed on the inside surface of the wearable band 610 such that they contact a portion of the user's skin. For example, the electrical ground and shielding electrodes can be at an inside surface of coupling mechanism 616 or an inside surface of a wearable structure 611. The electrical ground and shielding electrodes can be formed and/or use the same components as the sensors 613. In some embodiments, the wearable band 610 includes more than one electrical ground electrode and more than one shielding electrode.

The sensors 613 can be formed as part of the wearable structure 611 of the wearable band 610. In some embodiments, the sensors 613 are flush or substantially flush with the wearable structure 611 such that they do not extend beyond the surface of the wearable structure 611. While flush with the wearable structure 611, the sensors 613 are still configured to contact the user's skin (e.g., via a skin-contacting surface). Alternatively, in some embodiments, the sensors 613 extend beyond the wearable structure 611 a predetermined distance (e.g., 0.1 mm to 2 mm) to make contact and depress into the user's skin. In some embodiments, the sensors 613 are coupled to an actuator (not shown) configured to adjust an extension height (e.g., a distance from the surface of the wearable structure 611) of the sensors 613 such that the sensors 613 make contact and depress into the user's skin. In some embodiments, the actuators adjust the extension height between 0.01 mm to 1.2 mm. This allows the user to customize the positioning of the sensors 613 to improve the overall comfort of the wearable band 610 when worn while still allowing the sensors 613 to contact the user's skin. In some embodiments, the sensors 613 are indistinguishable from the wearable structure 611 when worn by the user.

The wearable structure 611 can be formed of an elastic material, elastomers, etc., configured to be stretched and fitted to be worn by the user. In some embodiments, the wearable structure 611 is a textile or woven fabric. As described above, the sensors 613 can be formed as part of a wearable structure 611. For example, the sensors 613 can be molded into the wearable structure 611 or be integrated into a woven fabric (e.g., the sensors 613 can be sewn into the fabric and mimic the pliability of fabric (e.g., the sensors 613 can be constructed from a series of woven strands of fabric)).

The wearable structure 611 can include flexible electronic connectors that interconnect the sensors 613, the electronic circuitry, and/or other electronic components (described below in reference to FIG. 6B) that are enclosed in the wearable band 610. In some embodiments, the flexible electronic connectors are configured to interconnect the sensors 613, the electronic circuitry, and/or other electronic components of the wearable band 610 with respective sensors and/or other electronic components of another electronic device (e.g., watch body 620). The flexible electronic connectors are configured to move with the wearable structure 611 such that the user adjustment to the wearable structure 611 (e.g., resizing, pulling, folding, etc.) does not stress or strain the electrical coupling of components of the wearable band 610.

As described above, the wearable band 610 is configured to be worn by a user. In particular, the wearable band 610 can be shaped or otherwise manipulated to be worn by a user. For example, the wearable band 610 can be shaped to have a substantially circular shape such that it can be configured to be worn on the user's lower arm or wrist. Alternatively, the wearable band 610 can be shaped to be worn on another body part of the user, such as the user's upper arm (e.g., around a bicep), forearm, chest, legs, etc. The wearable band 610 can include a retaining mechanism 612 (e.g., a buckle, a hook and loop fastener, etc.) for securing the wearable band 610 to the user's wrist or other body part. While the wearable band 610 is worn by the user, the sensors 613 sense data (referred to as sensor data) from the user's skin. In particular, the sensors 613 of the wearable band 610 obtain (e.g., sense and record) neuromuscular signals.

The sensed data (e.g., sensed neuromuscular signals) can be used to detect and/or determine the user's intention to perform certain motor actions. In particular, the sensors 613 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 605 of the wrist-wearable device 600 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 613 can be used to provide a user with an enhanced interaction with a physical object (e.g., devices communicatively coupled with the wearable band 610) and/or a virtual object in an artificial-reality application generated by an artificial-reality system (e.g., user interface objects presented on the display 605 or another computing device (e.g., a smartphone)).

In some embodiments, the wearable band 610 includes one or more haptic devices 646 (FIG. 6B; e.g., a vibratory haptic actuator) that are configured to provide haptic feedback (e.g., a cutaneous and/or kinesthetic sensation, etc.) to the user's skin. The sensors 613, and/or the haptic devices 646 can be configured to operate in conjunction with multiple applications including, without limitation, health monitoring, social media, games, and artificial reality (e.g., the applications associated with artificial reality).

The wearable band 610 can also include coupling mechanism 616 (e.g., a cradle or a shape of the coupling mechanism can correspond to shape of the watch body 620 of the wrist-wearable device 600) for detachably coupling a capsule (e.g., a computing unit) or watch body 620 (via a coupling surface of the watch body 620) to the wearable band 610. In particular, the coupling mechanism 616 can be configured to receive a coupling surface proximate to the bottom side of the watch body 620 (e.g., a side opposite to a front side of the watch body 620 where the display 605 is located), such that a user can push the watch body 620 downward into the coupling mechanism 616 to attach the watch body 620 to the coupling mechanism 616. In some embodiments, the coupling mechanism 616 can be configured to receive a top side of the watch body 620 (e.g., a side proximate to the front side of the watch body 620 where the display 605 is located) that is pushed upward into the cradle, as opposed to being pushed downward into the coupling mechanism 616. In some embodiments, the coupling mechanism 616 is an integrated component of the wearable band 610 such that the wearable band 610 and the coupling mechanism 616 are a single unitary structure. In some embodiments, the coupling mechanism 616 is a type of frame or shell that allows the watch body 620 coupling surface to be retained within or on the wearable band 610 coupling mechanism 616 (e.g., a cradle, a tracker band, a support base, a clasp, etc.).

The coupling mechanism 616 can allow for the watch body 620 to be detachably coupled to the wearable band 610 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 620 to the wearable band 610 and to decouple the watch body 620 from the wearable band 610. For example, a user can twist, slide, turn, push, pull, or rotate the watch body 620 relative to the wearable band 610, or a combination thereof, to attach the watch body 620 to the wearable band 610 and to detach the watch body 620 from the wearable band 610. Alternatively, as discussed below, in some embodiments, the watch body 620 can be decoupled from the wearable band 610 by actuation of the release mechanism 629.

The wearable band 610 can be coupled with a watch body 620 to increase the functionality of the wearable band 610 (e.g., converting the wearable band 610 into a wrist-wearable device 600, adding an additional computing unit and/or battery to increase computational resources and/or a battery life of the wearable band 610, adding additional sensors to improve sensed data, etc.). As described above, the wearable band 610 (and the coupling mechanism 616) is configured to operate independently (e.g., execute functions independently) from watch body 620. For example, the coupling mechanism 616 can include one or more sensors 613 that contact a user's skin when the wearable band 610 is worn by the user and provide sensor data for determining control commands.

A user can detach the watch body 620 (or capsule) from the wearable band 610 in order to reduce the encumbrance of the wrist-wearable device 600 to the user. For embodiments in which the watch body 620 is removable, the watch body 620 can be referred to as a removable structure, such that in these embodiments the wrist-wearable device 600 includes a wearable portion (e.g., the wearable band 610) and a removable structure (the watch body 620).

Turning to the watch body 620, the watch body 620 can have a substantially rectangular or circular shape. The watch body 620 is configured to be worn by the user on their wrist or on another body part. More specifically, the watch body 620 is sized to be easily carried by the user, attached on a portion of the user's clothing, and/or coupled to the wearable band 610 (forming the wrist-wearable device 600). As described above, the watch body 620 can have a shape corresponding to the coupling mechanism 616 of the wearable band 610. In some embodiments, the watch body 620 includes a single release mechanism 629 or multiple release mechanisms (e.g., two release mechanisms 629 positioned on opposing sides of the watch body 620, such as spring-loaded buttons) for decoupling the watch body 620 and the wearable band 610. The release mechanism 629 can include, without limitation, a button, a knob, a plunger, a handle, a lever, a fastener, a clasp, a dial, a latch, or a combination thereof.

A user can actuate the release mechanism 629 by pushing, turning, lifting, depressing, shifting, or performing other actions on the release mechanism 629. Actuation of the release mechanism 629 can release (e.g., decouple) the watch body 620 from the coupling mechanism 616 of the wearable band 610, allowing the user to use the watch body 620 independently from wearable band 610, and vice versa. For example, decoupling the watch body 620 from the wearable band 610 can allow the user to capture images using rear-facing camera 625B. Although the coupling mechanism 616 is shown positioned at a corner of watch body 620, the release mechanism 629 can be positioned anywhere on watch body 620 that is convenient for the user to actuate. In addition, in some embodiments, the wearable band 610 can also include a respective release mechanism for decoupling the watch body 620 from the coupling mechanism 616. In some embodiments, the release mechanism 629 is optional and the watch body 620 can be decoupled from the coupling mechanism 616 as described above (e.g., via twisting, rotating, etc.).

The watch body 620 can include one or more peripheral buttons 623 and 627 for performing various operations at the watch body 620. For example, the peripheral buttons 623 and 627 can be used to turn on or wake (e.g., transition from a sleep state to an active state) the display 605, unlock the watch body 620, increase or decrease a volume, increase or decrease brightness, interact with one or more applications, interact with one or more user interfaces, etc. Additionally, or alternatively, in some embodiments, the display 605 operates as a touch screen and allows the user to provide one or more inputs for interacting with the watch body 620.

In some embodiments, the watch body 620 includes one or more sensors 621. The sensors 621 of the watch body 620 can be the same or distinct from the sensors 613 of the wearable band 610. The sensors 621 of the watch body 620 can be distributed on an inside and/or an outside surface of the watch body 620. In some embodiments, the sensors 621 are configured to contact a user's skin when the watch body 620 is worn by the user. For example, the sensors 621 can be placed on the bottom side of the watch body 620 and the coupling mechanism 616 can be a cradle with an opening that allows the bottom side of the watch body 620 to directly contact the user's skin. Alternatively, in some embodiments, the watch body 620 does not include sensors that are configured to contact the user's skin (e.g., including sensors internal and/or external to the watch body 620 that configured to sense data of the watch body 620 and the watch body 620's surrounding environment). In some embodiments, the sensors 613 are configured to track a position and/or motion of the watch body 620.

The watch body 620 and the wearable band 610 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 620 and the wearable band 610 can share data sensed by the sensors 613 and 621, as well as application- and device-specific information (e.g., active and/or available applications), output devices (e.g., display, speakers, etc.), input devices (e.g., touch screen, microphone, imaging sensors, etc.).

In some embodiments, the watch body 620 can include, without limitation, a front-facing camera 625A and/or a rear-facing camera 625B, sensors 621 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 663; FIG. 6B), a touch sensor, a sweat sensor, etc.). In some embodiments, the watch body 620 can include one or more haptic devices 676 (FIG. 6B; a vibratory haptic actuator) that is configured to provide haptic feedback (e.g., a cutaneous and/or kinesthetic sensation, etc.) to the user. The sensors 621 and/or the haptic device 676 can also be configured to operate in conjunction with multiple applications including, without limitation, health-monitoring applications, social media applications, game applications, and artificial-reality applications (e.g., the applications associated with artificial reality).

As described above, the watch body 620 and the wearable band 610, when coupled, can form the wrist-wearable device 600. When coupled, the watch body 620 and wearable band 610 operate as a single device to execute functions (operations, detections, communications, etc.) described herein. In some embodiments, each device is provided with particular instructions for performing the one or more operations of the wrist-wearable device 600. For example, in accordance with a determination that the watch body 620 does not include neuromuscular signal sensors, the wearable band 610 can include alternative instructions for performing associated instructions (e.g., providing sensed neuromuscular signal data to the watch body 620 via a different electronic device). Operations of the wrist-wearable device 600 can be performed by the watch body 620 alone or in conjunction with the wearable band 610 (e.g., via respective processors and/or hardware components) and vice versa. In some embodiments, operations of the wrist-wearable device 600, the watch body 620, and/or the wearable band 610 can be performed in conjunction with one or more processors and/or hardware components of another communicatively coupled device (e.g., the HIPD 800; FIGS. 8A-8B).

As described below with reference to the block diagram of FIG. 6B, the wearable band 610 and/or the watch body 620 can each include independent resources required to independently execute functions. For example, the wearable band 610 and/or the watch body 620 can each include a power source (e.g., a battery), a memory, data storage, a processor (e.g., a central processing unit (CPU)), communications, a light source, and/or input/output devices.

FIG. 6B shows block diagrams of a computing system 630 corresponding to the wearable band 610, and a computing system 660 corresponding to the watch body 620, according to some embodiments. A computing system of the wrist-wearable device 600 includes a combination of components of the wearable band computing system 630 and the watch body computing system 660, in accordance with some embodiments.

The watch body 620 and/or the wearable band 610 can include one or more components shown in watch body computing system 660. In some embodiments, a single integrated circuit includes all or a substantial portion of the components of the watch body computing system 660 are included in a single integrated circuit. Alternatively, in some embodiments, components of the watch body computing system 660 are included in a plurality of integrated circuits that are communicatively coupled. In some embodiments, the watch body computing system 660 is configured to couple (e.g., via a wired or wireless connection) with the wearable band computing system 630, which allows the computing systems to share components, distribute tasks, and/or perform other operations described herein (individually or as a single device).

The watch body computing system 660 can include one or more processors 679, a controller 677, a peripherals interface 661, a power system 695, and memory (e.g., a memory 680), each of which are defined above and described in more detail below.

The power system 695 can include a charger input 696, a power-management integrated circuit (PMIC) 697, and a battery 698, each are which are defined above. In some embodiments, a watch body 620 and a wearable band 610 can have respective charger inputs (e.g., charger input 696 and 657), respective batteries (e.g., battery 698 and 659), and can share power with each other (e.g., the watch body 620 can power and/or charge the wearable band 610, and vice versa). Although watch body 620 and/or the wearable band 610 can include respective charger inputs, a single charger input can charge both devices when coupled. The watch body 620 and the wearable band 610 can receive a charge using a variety of techniques. In some embodiments, the watch body 620 and the wearable band 610 can use a wired charging assembly (e.g., power cords) to receive the charge. Alternatively, or in addition, the watch body 620 and/or the wearable band 610 can be configured for wireless charging. For example, a portable charging device can be designed to mate with a portion of watch body 620 and/or wearable band 610 and wirelessly deliver usable power to a battery of watch body 620 and/or wearable band 610. The watch body 620 and the wearable band 610 can have independent power systems (e.g., power system 695 and 656) to enable each to operate independently. The watch body 620 and wearable band 610 can also share power (e.g., one can charge the other) via respective PMICs (e.g., PMICs 697 and 658) that can share power over power and ground conductors and/or over wireless charging antennas.

In some embodiments, the peripherals interface 661 can include one or more sensors 621, many of which listed below are defined above. The sensors 621 can include one or more coupling sensors 662 for detecting when the watch body 620 is coupled with another electronic device (e.g., a wearable band 610). The sensors 621 can include imaging sensors 663 (one or more of the cameras 625 and/or separate imaging sensors 663 (e.g., thermal-imaging sensors)). In some embodiments, the sensors 621 include one or more SpO2 sensors 664. In some embodiments, the sensors 621 include one or more biopotential-signal sensors (e.g., EMG sensors 665, which may be disposed on a user-facing portion of the watch body 620 and/or the wearable band 610). In some embodiments, the sensors 621 include one or more capacitive sensors 666. In some embodiments, the sensors 621 include one or more heart rate sensors 667. In some embodiments, the sensors 621 include one or more IMUs 668. In some embodiments, one or more IMUs 668 can be configured to detect movement of a user's hand or other location that the watch body 620 is placed or held.

In some embodiments, the peripherals interface 661 includes an NFC component 669, a global-position system (GPS) component 670, a long-term evolution (LTE) component 671, and/or a Wi-Fi and/or Bluetooth communication component 672. In some embodiments, the peripherals interface 661 includes one or more buttons 673 (e.g., the peripheral buttons 623 and 627 in FIG. 6A), which, when selected by a user, cause operations to be performed at the watch body 620. In some embodiments, the peripherals interface 661 includes one or more indicators, such as a light emitting diode (LED), to provide a user with visual indicators (e.g., message received, low battery, an active microphone, and/or a camera, etc.).

The watch body 620 can include at least one display 605 for displaying visual representations of information or data to the user, including user-interface elements and/or three-dimensional (3D) virtual objects. The display can also include a touch screen for inputting user inputs, such as touch gestures, swipe gestures, and the like. The watch body 620 can include at least one speaker 674 and at least one microphone 675 for providing audio signals to the user and receiving audio input from the user. The user can provide user inputs through the microphone 675 and can also receive audio output from the speaker 674 as part of a haptic event provided by the haptic controller 678. The watch body 620 can include at least one camera 625, including a front-facing camera 625A and a rear-facing camera 625B. The cameras 625 can include ultra-wide-angle cameras, wide-angle cameras, fish-eye cameras, spherical cameras, telephoto cameras, a depth-sensing cameras, or other types of cameras.

The watch body computing system 660 can include one or more haptic controllers 678 and associated componentry (e.g., haptic devices 676) for providing haptic events at the watch body 620 (e.g., a vibrating sensation or audio output in response to an event at the watch body 620). The haptic controllers 678 can communicate with one or more haptic devices 676, such as electroacoustic devices, including a speaker of the one or more speakers 674 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 678 can provide haptic events to respective haptic actuators that are capable of being sensed by a user of the watch body 620. In some embodiments, the one or more haptic controllers 678 can receive input signals from an application of the applications 682.

In some embodiments, the computer system 630 and/or the computer system 660 can include memory 680, which can be controlled by a memory controller of the one or more controllers 677 and/or one or more processors 679. In some embodiments, software components stored in the memory 680 include one or more applications 682 configured to perform operations at the watch body 620. In some embodiments, the one or more applications 682 include games, word processors, messaging applications, calling applications, web browsers, social media applications, media streaming applications, financial applications, calendars, clocks, etc. In some embodiments, software components stored in the memory 680 include one or more communication interface modules 683 as defined above. In some embodiments, software components stored in the memory 680 include one or more graphics modules 684 for rendering, encoding, and/or decoding audio and/or visual data; and one or more data management modules 685 for collecting, organizing, and/or providing access to the data 687 stored in memory 680. In some embodiments, one or more of applications 682 and/or one or more modules can work in conjunction with one another to perform various tasks at the watch body 620.

In some embodiments, software components stored in the memory 680 can include one or more operating systems 681 (e.g., a Linux-based operating system, an Android operating system, etc.). The memory 680 can also include data 687. The data 687 can include profile data 688A, sensor data 689A, media content data 690, and application data 691.

It should be appreciated that the watch body computing system 660 is an example of a computing system within the watch body 620, and that the watch body 620 can have more or fewer components than shown in the watch body computing system 660, combine two or more components, and/or have a different configuration and/or arrangement of the components. The various components shown in watch body computing system 660 are implemented in hardware, software, firmware, or a combination thereof, including one or more signal processing and/or application-specific integrated circuits.

Turning to the wearable band computing system 630, one or more components that can be included in the wearable band 610 are shown. The wearable band computing system 630 can include more or fewer components than shown in the watch body computing system 660, combine two or more components, and/or have a different configuration and/or arrangement of some or all of the components. In some embodiments, all, or a substantial portion of the components of the wearable band computing system 630 are included in a single integrated circuit. Alternatively, in some embodiments, components of the wearable band computing system 630 are included in a plurality of integrated circuits that are communicatively coupled. As described above, in some embodiments, the wearable band computing system 630 is configured to couple (e.g., via a wired or wireless connection) with the watch body computing system 660, which allows the computing systems to share components, distribute tasks, and/or perform other operations described herein (individually or as a single device).

The wearable band computing system 630, similar to the watch body computing system 660, can include one or more processors 649, one or more controllers 647 (including one or more haptics controller 648), a peripherals interface 631 that can include one or more sensors 613 and other peripheral devices, power source (e.g., a power system 656), and memory (e.g., a memory 650) that includes an operating system (e.g., an operating system 651), data (e.g., data 654 including profile data 688B, sensor data 689B, etc.), and one or more modules (e.g., a communications interface module 652, a data management module 653, etc.).

The one or more sensors 613 can be analogous to sensors 621 of the computer system 660 in light of the definitions above. For example, sensors 613 can include one or more coupling sensors 632, one or more SpO2 sensors 634, one or more EMG sensors 635, one or more capacitive sensors 636, one or more heart rate sensors 637, and one or more IMU sensors 638.

The peripherals interface 631 can also include other components analogous to those included in the peripheral interface 661 of the computer system 660, including an NFC component 639, a GPS component 640, an LTE component 641, a Wi-Fi and/or Bluetooth communication component 642, and/or one or more haptic devices 676 as described above in reference to peripherals interface 661. In some embodiments, the peripherals interface 631 includes one or more buttons 643, a display 633, a speaker 644, a microphone 645, and a camera 655. In some embodiments, the peripherals interface 631 includes one or more indicators, such as an LED.

It should be appreciated that the wearable band computing system 630 is an example of a computing system within the wearable band 610, and that the wearable band 610 can have more or fewer components than shown in the wearable band computing system 630, combine two or more components, and/or have a different configuration and/or arrangement of the components. The various components shown in wearable band computing system 630 can be implemented in one or a combination of hardware, software, and firmware, including one or more signal processing and/or application-specific integrated circuits.

The wrist-wearable device 600 with respect to FIG. 6A is an example of the wearable band 610 and the watch body 620 coupled, so the wrist-wearable device 600 will be understood to include the components shown and described for the wearable band computing system 630 and the watch body computing system 660. In some embodiments, wrist-wearable device 600 has a split architecture (e.g., a split mechanical architecture or a split electrical architecture) between the watch body 620 and the wearable band 610. In other words, all of the components shown in the wearable band computing system 630 and the watch body computing system 660 can be housed or otherwise disposed in a combined watch device 600, or within individual components of the watch body 620, wearable band 610, and/or portions thereof (e.g., a coupling mechanism 616 of the wearable band 610).

The techniques described above can be used with any device for sensing neuromuscular signals, including the arm-wearable devices of FIG. 6A-6B, but could also be used with other types of wearable devices for sensing neuromuscular signals (such as body-wearable or head-wearable devices that might have neuromuscular sensors closer to the brain or spinal column).

In some embodiments, a wrist-wearable device 600 can be used in conjunction with a head-wearable device described below (e.g., AR device 700 and VR device 710) and/or an HIPD 800, and the wrist-wearable device 600 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 700 and VR device 710.

### Example Head-Wearable Devices

FIGS. 7A, 7B-1, 7B-2, and 7C show example head-wearable devices, in accordance with some embodiments. Head-wearable devices can include, but are not limited to, AR devices 710 (e.g., AR or smart eyewear devices, such as smart glasses, smart monocles, smart contacts, etc.), VR devices 710 (e.g., VR headsets, head-mounted displays (HMD)s, etc.), or other ocularly coupled devices. The AR devices 700 and the VR devices 710 are instances of the AR headsets 102 and 402 described in reference to FIGS. 1A to 1H and 4A to 4D herein, such that the head-wearable device should be understood to have the features of the AR devices 700 and/or the VR devices 710, and vice versa. The AR devices 700 and the VR devices 710 can perform various functions and/or operations associated with navigating through user interfaces and selectively opening applications, as well as the functions and/or operations described above with reference to FIGS. 1A to 4D.

In some embodiments, an AR system (e.g., AR systems 500a-500d; FIGS. 5A-5D-2) includes an AR device 700 (as shown in FIG. 7A) and/or VR device 710 (as shown in FIGS. 7B-1-B-2). In some embodiments, the AR device 700 and the VR device 710 can include one or more analogous components (e.g., components for presenting interactive artificial-reality environments, such as processors, memory, and/or presentation devices, including one or more displays and/or one or more waveguides), some of which are described in more detail with respect to FIG. 7C. The head-wearable devices can use display projectors (e.g., display projector assemblies 707A and 707B) and/or waveguides for projecting representations of data to a user. Some embodiments of head-wearable devices do not include displays.

FIG. 7A shows an example visual depiction of the AR device 700 (e.g., which may also be described herein as augmented-reality glasses and/or smart glasses). The AR device 700 can work in conjunction with additional electronic components that are not shown in FIGS. 7A, such as a wearable accessory device and/or an intermediary processing device, in electronic communication or otherwise configured to be used in conjunction with the AR device 700. In some embodiments, the wearable accessory device and/or the intermediary processing device may be configured to couple with the AR device 700 via a coupling mechanism in electronic communication with a coupling sensor 724, where the coupling sensor 724 can detect when an electronic device becomes physically or electronically coupled with the AR device 700. In some embodiments, the AR device 700 can be configured to couple to a housing (e.g., a portion of frame 704 or temple arms 705), which may include one or more additional coupling mechanisms configured to couple with additional accessory devices. The components shown in FIG. 7A can be implemented in hardware, software, firmware, or a combination thereof, including one or more signal-processing components and/or application-specific integrated circuits (ASICs).

The AR device 700 includes mechanical glasses components, including a frame 704 configured to hold one or more lenses (e.g., one or both lenses 706-1 and 706-2). One of ordinary skill in the art will appreciate that the AR device 700 can include additional mechanical components, such as hinges configured to allow portions of the frame 704 of the AR device 700 to be folded and unfolded, a bridge configured to span the gap between the lenses 706-1 and 706-2 and rest on the user's nose, nose pads configured to rest on the bridge of the nose and provide support for the AR device 700, earpieces configured to rest on the user's ears and provide additional support for the AR device 700, temple arms 705 configured to extend from the hinges to the earpieces of the AR device 700, and the like. One of ordinary skill in the art will further appreciate that some examples of the AR device 700 can include none of the mechanical components described herein. For example, smart contact lenses configured to present artificial reality to users may not include any components of the AR device 700.

The lenses 706-1 and 706-2 can be individual displays or display devices (e.g., a waveguide for projected representations). The lenses 706-1 and 706-2 may act together or independently to present an image or series of images to a user. In some embodiments, the lenses 706-1 and 706-2 can operate in conjunction with one or more display projector assemblies 707A and 707B to present image data to a user. While the AR device 700 includes two displays, embodiments of this disclosure may be implemented in AR devices with a single near-eye display (NED) or more than two NEDs.

The AR device 700 includes electronic components, many of which will be described in more detail below with respect to FIG. 7C. Some example electronic components are illustrated in FIG. 7A, including sensors 723-1, 723-2, 723-3, 723-4, 723-5, and 723-6, which can be distributed along a substantial portion of the frame 704 of the AR device 700. The different types of sensors are described below in reference to FIG. 7C. The AR device 700 also includes a left camera 739A and a right camera 739B, which are located on different sides of the frame 704. And the eyewear device includes one or more processors 748A and 748B (e.g., an integral microprocessor, such as an ASIC) that is embedded into a portion of the frame 704.

FIGS. 7B-1 and 7B-2 show an example visual depiction of the VR device 710 (e.g., a head-mounted display (HMD) 712, also referred to herein as an artificial-reality headset, a head-wearable device, a VR headset, etc.). The HMD 712 includes a front body 714 and a frame 716 (e.g., a strap or band) shaped to fit around a user's head. In some embodiments, the front body 714 and/or the frame 716 includes one or more electronic elements for facilitating presentation of and/or interactions with an AR and/or VR system (e.g., displays, processors (e.g., processor 748A-1), IMUs, tracking emitter or detectors, sensors, etc.). In some embodiments, the HMD 712 includes output audio transducers (e.g., an audio transducer 718-1), as shown in FIG. 7B-2. In some embodiments, one or more components, such as the output audio transducer(s) 718 and the frame 716, can be configured to attach and detach (e.g., are detachably attachable) to the HMD 712 (e.g., a portion or all of the frame 716, and/or the output audio transducer 718), as shown in FIG. 7B-2. In some embodiments, coupling a detachable component to the HMD 712 causes the detachable component to come into electronic communication with the HMD 712. The VR device 710 includes electronic components, many of which will be described in more detail below with respect to FIG. 7C.

FIG. 7B-1 to 7B-2 also show that the VR device 710 one or more cameras, such as the left camera 739A and the right camera 739B, which can be analogous to the left and right cameras on the frame 704 of the AR device 700. In some embodiments, the VR device 710 includes one or more additional cameras (e.g., cameras 739C and 739D), which can be configured to augment image data obtained by the cameras 739A and 739B by providing more information. For example, the camera 739C can be used to supply color information that is not discerned by cameras 739A and 739B. In some embodiments, one or more of the cameras 739A to 739D can include an optional IR cut filter configured to remove IR light from being received at the respective camera sensors.

The VR device 710 can include a housing 790 storing one or more components of the VR device 710 and/or additional components of the VR device 710. The housing 790 can be a modular electronic device configured to couple with the VR device 710 (or an AR device 700) and supplement and/or extend the capabilities of the VR device 710 (or an AR device 700). For example, the housing 790 can include additional sensors, cameras, power sources, processors (e.g., processor 748A-2), etc. to improve and/or increase the functionality of the VR device 710. Examples of the different components included in the housing 790 are described below in reference to FIG. 7C.

Alternatively, or additionally, in some embodiments, the head-wearable device, such as the VR device 710 and/or the AR device 700), includes, or is communicatively coupled to, another external device (e.g., a paired device), such as an HIPD 8 (discussed below in reference to FIGS. 8A-8B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 800, an optional neckband, and/or wearable accessory device) with the head-wearable devices (e.g., an AR device 700 and/or VR device 710) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 800) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 800, can process information generated by one or more sensors of its sensors and/or information provided by other communicatively coupled devices. For example, a head-wearable device can include an IMU, and the intermediary processing device (neckband and/or an HIPD 800) can compute all inertial and spatial calculations from the IMUs located on the head-wearable device. Additional examples of processing performed by a communicatively coupled device, such as the HIPD 800, are provided below in reference to FIGS. 8A and 8B.

Artificial-reality systems may include a variety of types of visual feedback mechanisms. For example, display devices in the AR devices 700 and/or the VR devices 710 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 700 and/or the VR device 710 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 700 and the VR device 710, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 700 and/or the VR device 710 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 600, an HIPD 800, smart textile-based garment 900, etc.), and/or other devices described herein.

FIG. 7C illustrates a computing system 720 and an optional housing 790, each of which show components that can be included in a head-wearable device (e.g., the AR device 700 and/or the VR device 710). In some embodiments, more or less components can be included in the optional housing 790 depending on practical restraints of the respective head-wearable device being described. Additionally, or alternatively, the optional housing 790 can include additional components to expand and/or augment the functionality of a head-wearable device.

In some embodiments, the computing system 720 and/or the optional housing 790 can include one or more peripheral interfaces 722A and 722B, one or more power systems 742A and 742B (including charger input 743, PMIC 744, and battery 745), one or more controllers 746A 746B (including one or more haptic controllers 747), one or more processors 748A and 748B (as defined above, including any of the examples provided), and memory 750A and 750B, which can all be in electronic communication with each other. For example, the one or more processors 748A and/or 748B can be configured to execute instructions stored in the memory 750A and/or 750B, which can cause a controller of the one or more controllers 746A and/or 746B to cause operations to be performed at one or more peripheral devices of the peripherals interfaces 722A and/or 722B. In some embodiments, each operation described can occur based on electrical power provided by the power system 742A and/or 742B.

In some embodiments, the peripherals interface 722A can include one or more devices configured to be part of the computing system 720, many of which have been defined above and/or described with respect to wrist-wearable devices shown in FIGS. 6A and 6B. For example, the peripherals interface can include one or more sensors 723A. Some example sensors include: one or more coupling sensors 724, one or more acoustic sensors 725, one or more imaging sensors 726, one or more EMG sensors 727, one or more capacitive sensors 728, and/or one or more IMUs 729. In some embodiments, the sensors 723A further include depth sensors 767, light sensors 768 and/or any other types of sensors defined above or described with respect to any other embodiments discussed herein.

In some embodiments, the peripherals interface can include one or more additional peripheral devices, including one or more NFC devices 730, one or more GPS devices 731, one or more LTE devices 732, one or more WiFi and/or Bluetooth devices 733, one or more buttons 734 (e.g., including buttons that are slidable or otherwise adjustable), one or more displays 735A, one or more speakers 736A, one or more microphones 737A, one or more cameras 738A (e.g., including the a first camera 739-1 through nth camera 739-n, which are analogous to the left camera 739A and/or the right camera 739B), one or more haptic devices 740; and/or any other types of peripheral devices defined above or described with respect to any other embodiments discussed herein.

The head-wearable devices can include a variety of types of visual feedback mechanisms (e.g., presentation devices). For example, display devices in the AR device 700 and/or the VR device 710 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 735A can be coupled to each of the lenses 706-1 and 706-2 of the AR device 700. The displays 735A coupled to each of the lenses 706-1 and 706-2 can act together or independently to present an image or series of images to a user. In some embodiments, the AR device 700 and/or the VR device 710 includes a single display 735A (e.g., a near-eye display) or more than two displays 735A.

In some embodiments, a first set of one or more displays 735A can be used to present an augmented-reality environment, and a second set of one or more display devices 735A can be used to present a virtual-reality environment. In some embodiments, one or more waveguides are used in conjunction with presenting artificial-reality content to the user of the AR device 700 and/or the VR device 710 (e.g., as a means of delivering light from a display projector assembly and/or one or more displays 735A to the user's eyes). In some embodiments, one or more waveguides are fully or partially integrated into the AR device 700 and/or the VR device 710. Additionally, or alternatively to display screens, some artificial-reality systems include one or more projection systems. For example, display devices in the AR device 700 and/or the VR device 710 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 735A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 735A for presenting information to users. For example, an external display 735A can be used to show a current battery level, network activity (e.g., connected, disconnected, etc.), current activity (e.g., playing a game, in a call, in a meeting, watching a movie, etc.), and/or other relevant information. In some embodiments, the external displays 735A can be used to communicate with others. For example, a user of the head-wearable device can cause the external displays 735A to present a do not disturb notification. The external displays 735A can also be used by the user to share any information captured by the one or more components of the peripherals interface 722A and/or generated by head-wearable device (e.g., during operation and/or performance of one or more applications).

The memory 750A can include instructions and/or data executable by one or more processors 748A (and/or processors 748B of the housing 790) and/or a memory controller of the one or more controllers 746A (and/or controller 746B of the housing 790). The memory 750A can include one or more operating systems 751; one or more applications 752; one or more communication interface modules 753A; one or more graphics modules 754A; one or more AR processing modules 755A; head movement module 756A configured to detect head and lip movements of a user while they are causing an electronic message to be generated (e.g., a live-streamed social media post); and/or any other types of modules or components defined above or described with respect to any other embodiments discussed herein.

The data 760 stored in memory 750A can be used in conjunction with one or more of the applications and/or programs discussed above. The data 760 can include profile data 761; sensor data 762; media content data 763; AR application data 764; head movement data 765 including data for causing an avatar of a respective user to be animated based on the head movements of the user while they are composing an electronic communication; and/or any other types of data defined above or described with respect to any other embodiments discussed herein.

In some embodiments, the controller 746A of the head-wearable devices processes information generated by the sensors 723A on the head-wearable devices and/or another component of the head-wearable devices and/or communicatively coupled with the head-wearable devices (e.g., components of the housing 790, such as components of peripherals interface 722B). For example, the controller 746A can process information from the acoustic sensors 725 and/or image sensors 726. For each detected sound, the controller 746A can perform a direction of arrival (DOA) estimation to estimate a direction from which the detected sound arrived at a head-wearable device. As one or more of the acoustic sensors 725 detects sounds, the controller 746A can populate an audio data set with the information (e.g., represented by sensor data 762).

In some embodiments, a physical electronic connector can convey information between the head-wearable devices and another electronic device, and/or between one or more processors 748A of the head-wearable devices and the controller 746A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 800) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 700 and/or the VR device 710 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 7B-1 and 7B-2 show the VR device 710 having cameras 739A-739D, which can be used to provide depth information for creating a voxel field and a two-dimensional mesh to provide object information to the user to avoid collisions.

The optional housing 790 can include analogous components to those describe above with respect to the computing system 720. For example, the optional housing 790 can include a respective peripherals interface 722B including more or less components to those described above with respect to the peripherals interface 722A. As described above, the components of the optional housing 790 can be used augment and/or expand on the functionality of the head-wearable devices. For example, the optional housing 790 can include respective sensors 723B, speakers 736B, displays 735B, microphones 737B, cameras 738B, and/or other components to capture and/or present data. Similarly, the optional housing 790 can include one or more processors 748B, controllers 746B, and/or memory 750B (including respective communication interface modules 753B; one or more graphics modules 754B; one or more AR processing modules 755B, etc.) that can be used individually and/or in conjunction with the components of the computing system 720.

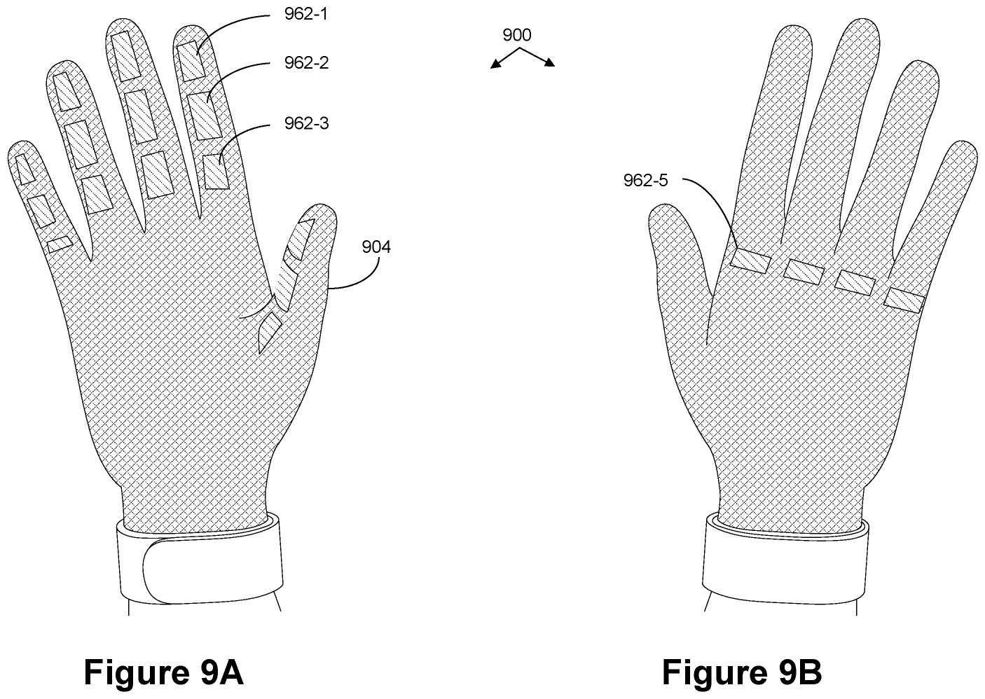

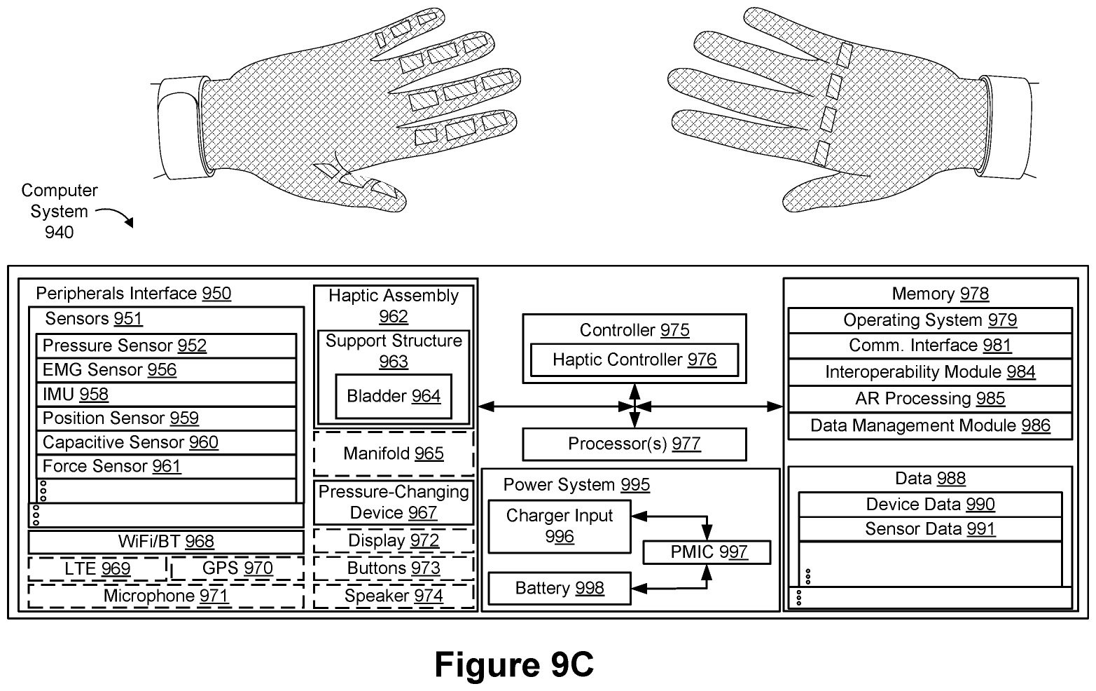

The techniques described above in FIGS. 7A-7C can be used with different head-wearable devices. In some embodiments, the head-wearable devices (e.g., the AR device 700 and/or the VR device 710) can be used in conjunction with one or more wearable device such as a wrist-wearable device 600 (or components thereof) and/or a smart textile-based garment 900 (FIGS. 9A-9C), as well as an HIPD 800.

Having thus described example the head-wearable devices, attention will now be turned to example handheld intermediary processing devices, such as HIPD 800.

### Example Handheld Intermediary Processing Devices

FIGS. 8A and 8B illustrate an example handheld intermediary processing device (HIPD) 800, in accordance with some embodiments. The HIPD 800 can perform various functions and/or operations associated with navigating through user interfaces and selectively opening applications.

FIG. 8A shows a top view 805 and a side view 825 of the HIPD 800. The HIPD 800 is configured to communicatively couple with one or more wearable devices (or other electronic devices) associated with a user. For example, the HIPD 800 is configured to communicatively couple with a user's wrist-wearable device 600 (or components thereof, such as the watch body 620 and the wearable band 610), AR device 700, and/or VR device 710. The HIPD 800 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 800 can successfully be communicatively coupled with an electronic device, such as a wearable device).

The HIPD 800 can perform various functions independently and/or in conjunction with one or more wearable devices (e.g., wrist-wearable device 600, AR device 700, VR device 710, etc.). The HIPD 800 is configured to increase and/or improve the functionality of communicatively coupled devices, such as the wearable devices. The HIPD 800 is configured to perform one or more functions or operations associated with interacting with user interfaces and applications of communicatively coupled devices, interacting with an AR environment, interacting with VR environment, and/or operating as a human-machine interface controller. Additionally, as will be described in more detail below, functionality and/or operations of the HIPD 800 can include, without limitation, task offloading and/or handoffs; thermals offloading and/or handoffs; 6 degrees of freedom (6DoF) raycasting and/or gaming (e.g., using imaging devices or cameras 814A and 814B, which can be used for simultaneous localization and mapping (SLAM) and/or with other image processing techniques); portable charging; messaging; image capturing via one or more imaging devices or cameras (e.g., cameras 822A and 822B); sensing user input (e.g., sensing a touch on a multi-touch input surface 802); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 800 and/or in communication between the HIPD 800 and another wearable device described herein. In some embodiments, functions can be executed on the HIPD 800 in conjunction with an AR environment. As the skilled artisan will appreciate upon reading the descriptions provided herein, the novel the HIPD 800 described herein can be used with any type of suitable AR environment.

While the HIPD 800 is communicatively coupled with a wearable device and/or other electronic device, the HIPD 800 is configured to perform one or more operations initiated at the wearable device and/or the other electronic device. In particular, one or more operations of the wearable device and/or the other electronic device can be offloaded to the HIPD 800 to be performed. The HIPD 800 performs the one or more operations of the wearable device and/or the other electronic device and provides to data corresponded to the completed operations to the wearable device and/or the other electronic device. For example, a user can initiate a video stream using AR device 700 and back-end tasks associated with performing the video stream (e.g., video rendering) can be offloaded to the HIPD 800, which the HIPD 800 performs and provides corresponding data to the AR device 700 to perform remaining front-end tasks associated with the video stream (e.g., presenting the rendered video data via a display of the AR device 700). In this way, the HIPD 800, which has more computational resources and greater thermal headroom than a wearable device, can perform computationally intensive tasks for the wearable device improving performance of an operation performed by the wearable device.

The HIPD 800 includes a multi-touch input surface 802 on a first side (e.g., a front surface) that is configured to detect one or more user inputs. In particular, the multi-touch input surface 802 can detect single tap inputs, multi-tap inputs, swipe gestures and/or inputs, force-based and/or pressure-based touch inputs, held taps, and the like. The multi-touch input surface 802 is configured to detect capacitive touch inputs and/or force (and/or pressure) touch inputs. The multi-touch input surface 802 includes a first touch-input surface 804 defined by a surface depression, and a second touch-input surface 806 defined by a substantially planar portion. The first touch-input surface 804 can be disposed adjacent to the second touch-input surface 806. In some embodiments, the first touch-input surface 804 and the second touch-input surface 806 can be different dimensions, shapes, and/or cover different portions of the multi-touch input surface 802. For example, the first touch-input surface 804 can be substantially circular and the second touch-input surface 806 is substantially rectangular. In some embodiments, the surface depression of the multi-touch input surface 802 is configured to guide user handling of the HIPD 800. In particular, the surface depression is configured such that the user holds the HIPD 800 upright when held in a single hand (e.g., such that the using imaging devices or cameras 814A and 814B are pointed toward a ceiling or the sky). Additionally, the surface depression is configured such that the user's thumb rests within the first touch-input surface 804.

In some embodiments, the different touch-input surfaces include a plurality of touch-input zones. For example, the second touch-input surface 806 includes at least a first touch-input zone 808 within a second touch-input zone 806 and a third touch-input zone 810 within the first touch-input zone 808. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 808 causes the HIPD 800 to perform a first command and a user input detected within the second touch-input zone 806 causes the HIPD 800 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 808 can be configured to detect force touch inputs (e.g., a magnitude at which the user presses down) and capacitive touch inputs, and the second touch-input zone 806 can be configured to detect capacitive touch inputs.

The HIPD 800 includes one or more sensors 851 for sensing data used in the performance of one or more operations and/or functions. For example, the HIPD 800 can include an IMU that is used in conjunction with cameras 814 for 3-dimensional object manipulation (e.g., enlarging, moving, destroying, etc. an object) in an AR or VR environment. Non-limiting examples of the sensors 851 included in the HIPD 800 include a light sensor, a magnetometer, a depth sensor, a pressure sensor, and a force sensor. Additional examples of the sensors 851 are provided below in reference to FIG. 8B.

The HIPD 800 can include one or more light indicators 812 to provide one or more notifications to the user. In some embodiments, the light indicators are LEDs or other types of illumination devices. The light indicators 812 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 804. The light indicators can be illuminated in different colors and/or patterns to provide the user with one or more notifications and/or information about the device. For example, a light indicator positioned around the first touch-input surface 804 can flash when the user receives a notification (e.g., a message), change red when the HIPD 800 is out of power, operate as a progress bar (e.g., a light ring that is closed when a task is completed (e.g., 0% to 100%)), operate as a volume indicator, etc.

In some embodiments, the HIPD 800 includes one or more additional sensors on another surface. For example, as shown FIG. 8A, HIPD 800 includes a set of one or more sensors (e.g., sensor set 820) on an edge of the HIPD 800. The sensor set 820, when positioned on an edge of the of the HIPD 800, can be pe positioned at a predetermined tilt angle (e.g., 26 degrees), which allows the sensor set 820 to be angled toward the user when placed on a desk or other flat surface. Alternatively, in some embodiments, the sensor set 820 is positioned on a surface opposite the multi-touch input surface 802 (e.g., a back surface). The one or more sensors of the sensor set 820 are discussed in detail below.

The side view 825 of the of the HIPD 800 shows the sensor set 820 and camera 814B. The sensor set 820 includes one or more cameras 822A and 822B, a depth projector 824, an ambient light sensor 828, and a depth receiver 830. In some embodiments, the sensor set 820 includes a light indicator 826. The light indicator 826 can operate as a privacy indicator to let the user and/or those around them know that a camera and/or microphone is active. The sensor set 820 is configured to capture a user's facial expression such that the user can puppet a custom avatar (e.g., showing emotions, such as smiles, laughter, etc., on the avatar or a digital representation of the user). The sensor set 820 can be configured as a side stereo RGB system, a rear indirect Time-of-Flight (iToF) system, or a rear stereo RGB system. As the skilled artisan will appreciate upon reading the descriptions provided herein, the novel HIPD 800 described herein can use different sensor set 820 configurations and/or sensor set 820 placement.

In some embodiments, the HIPD 800 includes one or more haptic devices 871 (FIG. 8B; e.g., a vibratory haptic actuator) that are configured to provide haptic feedback (e.g., kinesthetic sensation). The sensors 851, and/or the haptic devices 871 can be configured to operate in conjunction with multiple applications and/or communicatively coupled devices including, without limitation, wearable devices, health monitoring applications, social media applications, game applications, and artificial reality applications (e.g., the applications associated with artificial reality).

The HIPD 800 is configured to operate without a display. However, in optional embodiments, the HIPD 800 can include a display 868 (FIG. 8B). The HIPD 800 can also income one or more optional peripheral buttons 867 (FIG. 8B). For example, the peripheral buttons 867 can be used to turn on or turn off the HIPD 800. Further, the HIPD 800 housing can be formed of polymers and/or elastomer elastomers. The HIPD 800 can be configured to have a non-slip surface to allow the HIPD 800 to be placed on a surface without requiring a user to watch over the HIPD 800. In other words, the HIPD 800 is designed such that it would not easily slide off a surface. In some embodiments, the HIPD 800 include one or magnets to couple the HIPD 800 to another surface. This allows the user to mount the HIPD 800 to different surfaces and provide the user with greater flexibility in use of the HIPD 800.

As described above, the HIPD 800 can distribute and/or provide instructions for performing the one or more tasks at the HIPD 800 and/or a communicatively coupled device. For example, the HIPD 800 can identify one or more back-end tasks to be performed by the HIPD 800 and one or more front-end tasks to be performed by a communicatively coupled device. While the HIPD 800 is configured to offload and/or handoff tasks of a communicatively coupled device, the HIPD 800 can perform both back-end and front-end tasks (e.g., via one or more processors, such as CPU 877; FIG. 8B). The HIPD 800 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 800 can perform the above operations alone or in conjunction with a wearable device (or other communicatively coupled electronic device).

FIG. 8B shows block diagrams of a computing system 840 of the HIPD 800, in accordance with some embodiments. The HIPD 800, described in detail above, can include one or more components shown in HIPD computing system 840. The HIPD 800 will be understood to include the components shown and described below for the HIPD computing system 840. In some embodiments, all, or a substantial portion of the components of the HIPD computing system 840 are included in a single integrated circuit. Alternatively, in some embodiments, components of the HIPD computing system 840 are included in a plurality of integrated circuits that are communicatively coupled.

The HIPD computing system 840 can include a processor (e.g., a CPU 877, a GPU, and/or a CPU with integrated graphics), a controller 875, a peripherals interface 850 that includes one or more sensors 851 and other peripheral devices, a power source (e.g., a power system 895), and memory (e.g., a memory 878) that includes an operating system (e.g., an operating system 879), data (e.g., data 888), one or more applications (e.g., applications 880), and one or more modules (e.g., a communications interface module 881, a graphics module 882, a task and processing management module 883, an interoperability module 884, an AR processing module 885, a data management module 886, etc.). The HIPD computing system 840 further includes a power system 895 that includes a charger input and output 896, a PMIC 897, and a battery 898, all of which are defined above.

In some embodiments, the peripherals interface 850 can include one or more sensors 851. The sensors 851 can include analogous sensors to those described above in reference to FIG. 6B. For example, the sensors 851 can include imaging sensors 854, (optional) EMG sensors 856, IMUs 858, and capacitive sensors 860. In some embodiments, the sensors 851 can include one or more pressure sensor 852 for sensing pressure data, an altimeter 853 for sensing an altitude of the HIPD 800, a magnetometer 855 for sensing a magnetic field, a depth sensor 857 (or a time-of flight sensor) for determining a difference between the camera and the subject of an image, a position sensor 859 (e.g., a flexible position sensor) for sensing a relative displacement or position change of a portion of the HIPD 800, a force sensor 861 for sensing a force applied to a portion of the HIPD 800, and a light sensor 862 (e.g., an ambient light sensor) for detecting an amount of lighting. The sensors 851 can include one or more sensors not shown in FIG. 8B.

Analogous to the peripherals described above in reference to FIGS. 6B, the peripherals interface 850 can also include an NFC component 863, a GPS component 864, an LTE component 865, a Wi-Fi and/or Bluetooth communication component 866, a speaker 869, a haptic device 871, and a microphone 873. As described above in reference to FIG. 8A, the HIPD 800 can optionally include a display 868 and/or one or more buttons 867. The peripherals interface 850 can further include one or more cameras 870, touch surfaces 872, and/or one or more light emitters 874. The multi-touch input surface 802 described above in reference to FIG. 8A is an example of touch surface 872. The light emitters 874 can be one or more LEDs, lasers, etc. and can be used to project or present information to a user. For example, the light emitters 874 can include light indicators 812 and 826 described above in reference to FIG. 8A. The cameras 870 (e.g., cameras 814A, 814B, and 822 described above in FIG. 8A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 870 can be used for SLAM; 6 DoF ray casting, gaming, object manipulation, and/or other rendering; facial recognition and facial expression recognition, etc.

Similar to the watch body computing system 660 and the watch band computing system 630 described above in reference to FIG. 6B, the HIPD computing system 840 can include one or more haptic controllers 876 and associated componentry (e.g., haptic devices 871) for providing haptic events at the HIPD 800.

Memory 878 can include high-speed random-access memory and/or non-volatile memory, such as one or more magnetic disk storage devices, flash memory devices, or other non-volatile solid-state memory devices. Access to the memory 878 by other components of the HIPD 800, such as the one or more processors and the peripherals interface 850, can be controlled by a memory controller of the controllers 875.

In some embodiments, software components stored in the memory 878 include one or more operating systems 879, one or more applications 880, one or more communication interface modules 881, one or more graphics modules 882, one or more data management modules 885, which are analogous to the software components described above in reference to FIG. 6B.

In some embodiments, software components stored in the memory 878 include a task and processing management module 883 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 883 uses data 888 (e.g., device data 890) to distribute the one or more front-end and/or back-end tasks based on communicatively coupled devices' computing resources, available power, thermal headroom, ongoing operations, and/or other factors. For example, the task and processing management module 883 can cause the performance of one or more back-end tasks (of an operation performed at communicatively coupled AR device 700) at the HIPD 800 in accordance with a determination that the operation is utilizing a predetermined amount (e.g., at least 70%) of computing resources available at the AR device 700.

In some embodiments, software components stored in the memory 878 include an interoperability module 884 for exchanging and utilizing information received and/or provided to distinct communicatively coupled devices. The interoperability module 884 allows for different systems, devices, and/or applications to connect and communicate in a coordinated way without user input. In some embodiments, software components stored in the memory 878 include an AR module 885 that is configured to process signals based at least on sensor data for use in an AR and/or VR environment. For example, the AR processing module 885 can be used for 3D object manipulation, gesture recognition, facial and facial expression, recognition, etc.

The memory 878 can also include data 887, including structured data. In some embodiments, the data 887 can include profile data 889, device data 889 (including device data of one or more devices communicatively coupled with the HIPD 800, such as device type, hardware, software, configurations, etc.), sensor data 891, media content data 892, application data 893.

It should be appreciated that the HIPD computing system 840 is an example of a computing system within the HIPD 800, and that the HIPD 800 can have more or fewer components than shown in the HIPD computing system 840, combine two or more components, and/or have a different configuration and/or arrangement of the components. The various components shown in HIPD computing system 840 are implemented in hardware, software, firmware, or a combination thereof, including one or more signal processing and/or application-specific integrated circuits.

The techniques described above in FIG. 8A-8B can be used with any device used as a human-machine interface controller. In some embodiments, an HIPD 800 can be used in conjunction with one or more wearable device such as a head-wearable device (e.g., AR device 700 and VR device 710) and/or a wrist-wearable device 600 (or components thereof). In some embodiments, an HIPD 800 can also be used in conjunction with a wearable garment, such as smart textile-based garment 900 (FIGS. 9A-9C). Having thus described example HIPD 800, attention will now be turned to example feedback devices, such as smart textile-based garment 900.

### Example Smart Textile-Based Garments

FIGS. 9A and 9B illustrate an example smart textile-based garment, in accordance with some embodiments. The smart textile-based garment 900 (e.g., wearable gloves, a shirt, a headband, a wristband, socks, etc.) is configured to communicatively couple with one or more electronic devices, such as a wrist-wearable device 600, a head-wearable device, an HIPD 800, a laptop, tablet, and/or other computing devices. The smart textile-based garment 900 can perform various functions and/or operations associated with navigating through user interfaces and selectively opening applications, as well as the functions and/or operations described above with reference to FIGS. 1A to 4D.

The smart textile-based garment 900 can be part of an AR system, such as AR system 500d described above in reference to FIGS. 5D-1 and 5D-2. The smart textile-based garment 900 is also configured to provide feedback (e.g., tactile or other haptic feedback) to a user based on the user's interactions with a computing system (e.g., navigation of a user interface, operation of an application (e.g., game vibrations, media responsive haptics), device notifications, etc.), and/or the user's interactions within an AR environment. In some embodiments, the smart textile-based garment 900 receives instructions from a communicatively coupled device (e.g., the wrist-wearable device 600, a head-wearable device, and HIPD 800, etc.) for causing the performance of a feedback response. Alternatively, or in addition, in some embodiments, the smart textile-based garment 900 determines one or more feedback responses to provide a user. The smart textile-based garment 900 can determine the one or more feedback responses based on sensor data captured by one or more of its sensors (e.g., sensors 951; FIG. 9C) or communicatively coupled sensors (e.g., sensors of a wrist-wearable device 600, a head-wearable device, an HIPD 800, and/or other computing device).

Non-limiting examples of the feedback determined by the smart textile-based garment 900 and/or a communicatively coupled device include visual feedback, audio feedback, haptic (e.g., tactile, kinesthetic, etc.) feedback, thermal or temperature feedback, and/or other sensory perceptible feedback. The smart textile-based garment 900 can include respective feedback devices (e.g., a haptic device or assembly 962 or other feedback devices or assemblies) to provide the feedback responses to the user. Similarly, the smart textile-based garment 900 can communicatively couple with another device (and/or the other device's feedback devices) to coordinate the feedback provided to the user. For example, a VR device 710 can present an AR environment to a user and as the user interacts with objects within the AR environment, such as a virtual cup, the smart textile-based garment 900 provides respective response to the user. In particular, the smart textile-based garment 900 can provide haptic feedback to prevent (or, at a minimum, hinder/resist movement of) one or more of the user's fingers from bending past a certain point to simulate the sensation of touching a solid cup and/or thermal feedback to simulate the sensation of a cold or warm beverage.

Additionally, or alternatively, in some embodiments, the smart textile-based garment 900 is configured to operate as a controller configured to perform one or more functions or operations associated with interacting with user interfaces and applications of communicatively coupled devices, interacting with an AR environment, interacting with VR environment, and/or operating as a human-machine interface controller.

FIG. 9A shows one or more haptic assemblies 962 (e.g., first through fourth haptic assemblies 962-1 through 962-4) on a portion of the smart textile-based garment 900 adjacent to a palmar side of the user's hand and FIG. 9B shows additional haptic assemblies (e.g., a fifth haptic assembly 962-5) on a portion of the smart textile-based garment 900 adjacent to a dorsal side of the user's hand. In some embodiments, the haptic assemblies 962 include a mechanism that, at a minimum, provide resistance when a respective haptic assembly 962 is transitioned from a first state (e.g., a first pressurized state (e.g., at atmospheric pressure or deflated)) to a second state (e.g., a second pressurized state (e.g., inflated to a threshold pressure)). In other words, the haptic assemblies 962 described can transition between a first pressurized state and a second pressurized state to provide haptic feedback to the user. Structures of haptic assemblies 962 can be integrated into various devices configured to be in contact or proximity to a user's skin, including, but not limited to devices such as glove worn devices, body worn clothing device, headset devices. Each of the haptic assemblies 962 can be included in or physically coupled to a garment component 904 of the smart textile-based garment 900. For example, each of the haptic assemblies 962-1, 962-2, 962-3, . . . 962-N are physically coupled to the garment 904 are configured to contact respective phalanges of a user's thumb and fingers.

Due to the ever-changing nature of artificial reality, the haptic assemblies 962 may be required to transition between the multiple states hundreds, or perhaps thousands of times, during a single use. Thus, the haptic assemblies 962 described herein are durable and designed to quickly transition from state to state. To provide some context, in a first pressurized state, the haptic assemblies 962 do not impede free movement of a portion of the wearer's body. For example, one or more haptic assemblies 962 incorporated into a glove are made from flexible materials that do not impede free movement of the wearer's hand and fingers (e.g., an electrostatic-zipping actuator). The haptic assemblies 962 are configured to conform to a shape of the portion of the wearer's body when in the first pressurized state. However, once in a second pressurized state, the haptic assemblies 962 can be configured to restrict and/or impede free movement of the portion of the wearer's body (e.g., appendages of the user's hand). For example, the respective haptic assembly 962 (or multiple respective haptic assemblies) can restrict movement of a wearer's finger (e.g., prevent the finger from curling or extending) when the haptic assembly 962 is in the second pressurized state. Moreover, once in the second pressurized state, the haptic assemblies 962 may take different shapes, with some haptic assemblies 962 configured to take a planar, rigid shape (e.g., flat and rigid), while some other haptic assemblies 962 are configured to curve or bend, at least partially.

The smart textile-based garment 900 can be one of a plurality of devices in an AR system (e.g., AR systems of FIGS. 5A-5D-2). For example, a user can wear a pair of gloves (e.g., a first type of smart textile-based garment 900), wear a haptics component of a wrist-wearable device 600 (FIGS. 6A-6B), wear a headband (e.g., a second type of smart textile-based garment 900), hold an HIPD 800, etc. As explained above, the haptic assemblies 962 are configured to provide haptic simulations to a wearer of the smart textile-based garments 900. The garment 904 of each smart textile-based garment 900 can be one of various articles of clothing (e.g., gloves, socks, shirts, pants, etc.). Thus, a user may wear multiple smart textile-based garments 900 that are each configured to provide haptic stimulations to respective parts of the body where the smart textile-based garments 900 are being worn. Although the smart textile-based garment 900 are described as an individual device, in some embodiments, the smart textile-based garment 900 can be combined with other wearable devices described herein. For example, the smart textile-based garment 900 can form part of a VR device 710 (e.g., a headband portion).

FIG. 9C shows block diagrams of a computing system 940 of the haptic assemblies 962, in accordance with some embodiments. The computing system 940 can include one or more peripheral interfaces 950, one or more power systems 995 (including charger input 996, PMIC 997, and battery 998), one or more controllers 975 (including one or more haptic controllers 976), one or more processors 977 (as defined above, including any of the examples provided), and memory 978, which can all be in electronic communication with each other. For example, the one or more processors 977 can be configured to execute instructions stored in the memory 978, which can cause a controller of the one or more controllers 975 to cause operations to be performed at one or more peripheral devices of the peripherals interface 950. In some embodiments, each operation described can occur based on electrical power provided by the power system 995.

In some embodiments, the peripherals interface 950 can include one or more devices configured to be part of the computing system 940, many of which have been defined above and/or described with respect to wrist-wearable devices shown in FIGS. 6A-8B. For example, the peripherals interface 950 can include one or more sensors 951, such as one or more pressure sensors 952, one or more EMG sensors 956, one or more IMUs 958, one or more position sensors 959, one or more capacitive sensors 960, one or more force sensors 961; and/or any other types of sensors defined above or described with respect to any other embodiments discussed herein. In some embodiments, the peripherals interface can include one or more additional peripheral devices including one or more WiFi and/or Bluetooth devices 968; an LTE component 969; a GPS component 970; a microphone 971; one or more haptic assemblies 962; one or more support structures 963 (which can include one or more bladders 964; one or more manifolds 965; one or more pressure-changing devices 967; one or more displays 972; one or more buttons 973; one or more speakers 974; and/or any other types of peripheral devices defined above or described with respect to any other embodiments discussed herein). In some embodiments, computing system 940 includes more or less components that those shown in FIG. 9C.

In some embodiments, each haptic assembly 962 includes a support structure 963, and at least one bladder 964. The bladder 964 (e.g., a membrane) is a sealed, inflatable pocket made from a durable and puncture resistance material, such as thermoplastic polyurethane (TPU), a flexible polymer, or the like. The bladder 964 contains a medium (e.g., a fluid such as air, inert gas, or even a liquid) that can be added to or removed from the bladder 964 to change a pressure (e.g., fluid pressure) inside the bladder 964. The support structure 963 is made from a material that is stronger and stiffer than the material of the bladder 964. A respective support structure 963 coupled to a respective bladder 964 is configured to reinforce the respective bladder 964 as the respective bladder changes shape and size due to changes in pressure (e.g., fluid pressure) inside the bladder. The above example haptic assembly 962 is non-limiting. The haptic assembly 962 can include eccentric rotating mass (ERM), linear resonant actuators (LRA), voice coil motor (VCM), piezo haptic actuator, thermoelectric devices, solenoid actuators, ultrasonic transducers, thermo-resistive heaters, Peltier devices, and/or other devices configured to generate a perceptible response.

The smart textile-based garment 900 also includes a haptic controller 976 and a pressure-changing device 967. Alternatively, in some embodiments, the computing system 940 is communicatively coupled with a haptic controller 976 and/or pressure-changing device 967 (e.g., in electronic communication with one or more processors 977 of the computing system 940). The haptic controller 976 is configured to control operation of the pressure-changing device 967, and in turn operation of the smart textile-based garments 900. For example, the haptic controller 976 sends one or more signals to the pressure-changing device 967 to activate the pressure-changing device 967 (e.g., turn it on and off). The one or more signals can specify a desired pressure (e.g., pounds-per-square inch) to be output by the pressure-changing device 967. Generation of the one or more signals, and in turn the pressure output by the pressure-changing device 967, can be based on information collected by sensors 951 of the smart textile-based garment 900 and/or other communicatively coupled device. For example, the haptic controller 976 can provide one or more signals, based on collected sensor data, to cause the pressure-changing device 967 to increase the pressure (e.g., fluid pressure) inside a first haptic assembly 962 at a first time, and provide one or more additional signals, based on additional sensor data, to the pressure-changing device 967 to cause the pressure-changing device 967 to further increase the pressure inside a second haptic assembly 962 at a second time after the first time. Further, the haptic controller 976 can provide one or more signals to cause the pressure-changing device 967 to inflate one or more bladders 964 in a first portion of a smart textile-based garment 900 (e.g., a first finger), while one or more bladders 964 in a second portion of the smart textile-based garment 900 (e.g., a second finger) remain unchanged. Additionally, the haptic controller 976 can provide one or more signals to cause the pressure-changing device 967 to inflate one or more bladders 964 in a first smart textile-based garment 900 to a first pressure and inflate one or more other bladders 964 in the first smart textile-based garment 900 to a second pressure different from the first pressure. Depending on the number of smart textile-based garments 900 serviced by the pressure-changing device 967, and the number of bladders therein, many different inflation configurations can be achieved through the one or more signals and the examples above are not meant to be limiting.

The smart textile-based garment 900 may include an optional manifold 965 between the pressure-changing device 967, the haptic assemblies 962, and/or other portions of the smart textile-based garment 900. The manifold 965 may include one or more valves (not shown) that pneumatically couple each of the haptic assemblies 962 with the pressure-changing device 967 via tubing. In some embodiments, the manifold 965 is in communication with the controller 975, and the controller 975 controls the one or more valves of the manifold 965 (e.g., the controller generates one or more control signals). The manifold 965 is configured to switchably couple the pressure-changing device 967 with one or more haptic assemblies 962 of the smart textile-based garment 900. In some embodiments, one or more smart textile-based garment 900 or other haptic devices can be coupled in a network of haptic device and the manifold 965 can distribute the fluid between the coupled smart textile-based garments 900.

In some embodiments, instead of using the manifold 965 to pneumatically couple the pressure-changing device 967 with the haptic assemblies 962, the smart textile-based garment 900 may include multiple pressure-changing devices 967, where each pressure-changing device 967 is pneumatically coupled directly with a single (or multiple) haptic assembly 962. In some embodiments, the pressure-changing device 967 and the optional manifold 965 can be configured as part of one or more of the smart textile-based garments 900 (not illustrated) while, in other embodiments, the pressure-changing device 967 and the optional manifold 965 can be configured as external to the smart textile-based garments 900. In some embodiments, a single pressure-changing device 967 can be shared by multiple smart textile-based garment 900 or other haptic devices. In some embodiments, the pressure-changing device 967 is a pneumatic device, hydraulic device, a pneudraulic device, or some other device capable of adding and removing a medium (e.g., fluid, liquid, gas) from the one or more haptic assemblies 962.

The memory 978 includes instructions and data, some or all of which may be stored as non-transitory computer-readable storage media within the memory 978. For example, the memory 978 can include one or more operating systems 979; one or more communication interface applications 981; one or more interoperability modules 984; one or more AR processing applications 985; one or more data management modules 986; and/or any other types of data defined above or described with respect to FIGS. 6A-8B.

The memory 978 also includes data 988 which can be used in conjunction with one or more of the applications discussed above. The data 988 can include: device data 990; sensor data 991; and/or any other types of data defined above or described with respect to FIGS. 6A-8B.

The different components of the computing system 940 (and the smart textile-based garment 900) shown in FIGS. 9A-9C can be coupled via a wired connection (e.g., via busing). Alternatively, one or more of the devices shown in FIGS. 9A-9C may be wirelessly connected (e.g., via short-range communication signals).

Example embodiments of the computing systems described herein will now be discussed.

### Example Embodiments

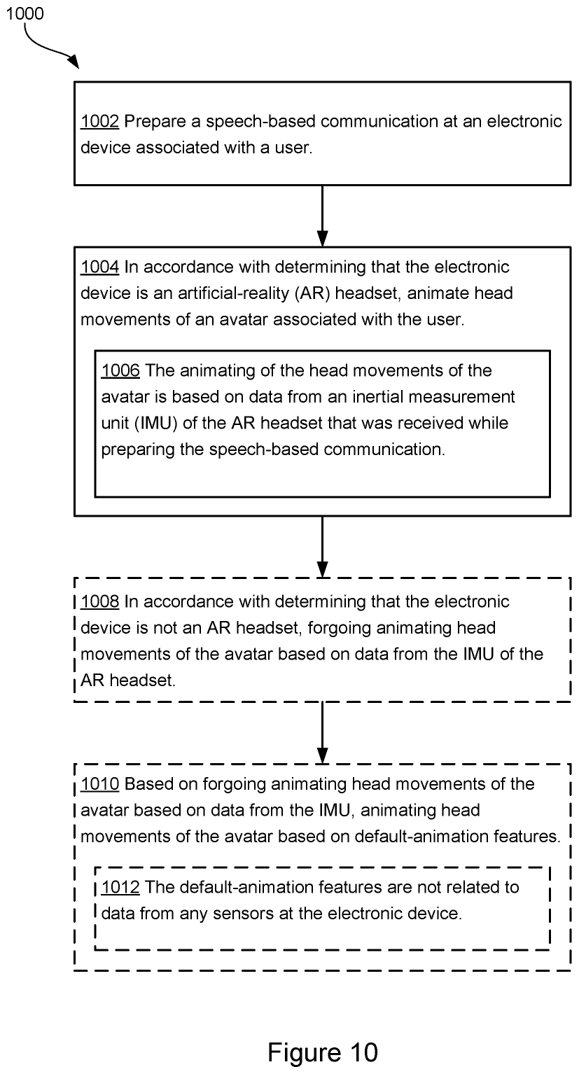

FIG. 10 shows a flow diagram of method 1000 for animating aspects of an animated avatar that is associated with an electronic communication. The method 1000 is performed at a computing system (e.g., a wearable device or intermediary device) having one or more processors and memory. The method 1000 can be caused to be performed based on instructions included on a non-transitory computer-readable storage medium, at least part of which can be stored in memory of processors of an AR headset within the computing system (e.g., the computing system 500a), in accordance with some embodiments.

(A1) The method 1000 includes preparing (1002) a speech-based communication at an electronic device associated with a user. For example, FIG. 1B shows the user 101 preparing a speech-based communication after performing the gesture 110 to compose an audio message in accordance with the prompt in the user interface element 106.

The method 1000 further includes, in accordance with determining (1004) that the electronic device is an artificial-reality (AR) headset, animating head movements of an animated avatar associated with the user. For example, in FIG. 1B, after the user 101 initiated the electronic communication by performing the pinch gesture 110 in FIG. 1A, the AR headset 102 presents the user interface element 112 that indicates that the animated avatar will be presented based on data from the IMU sensors 192 and the audio sensors 194 of the AR headset 102.

The animating (1006) of the head movements of the animated avatar is based on data from an inertial measurement unit (IMU) of the AR headset that was received while preparing the speech-based communication. As shown in FIG. 1C, the animated avatar 111 includes animated head movements based on the head movements the user 101 is performing that are detected by the IMU sensors of the AR headset 102.

(A2) In some embodiments of A1, the method 1000 includes, in accordance with determining (1008) that the electronic device is not an AR headset, forgoing animating the head movements of the animated avatar associated with the user based on movement-related data from the IMU of the AR headset. For example, in FIGS. 2A-2C, the user 201 is composing an electronic communication while the user 201 is not wearing an AR headset that includes an IMU and an audio sensor (since the user 201 is not wearing an AR headset in the sequence shown by FIGS. 2A-2C).

(A3) In some embodiments of A2, the method 1000 includes, based on forgoing (1010) animating the head movements of the animated avatar associated with the user based on data from the IMU, animating head movements of the avatar based on default-animation features. In some embodiments, the default animation features are not related (1012) to data from any sensors of the electronic device. For example, the default animation features can be based on one or more settings of one or more messaging applications that the user 201 is connected to via the wrist-wearable device 202. As shown in FIG. 2B, there can be a plurality of different options for animating an animated avatar when a user is or is not wearing an AR headset. For example, a user can select to use default animations, or they can use previously saved head movements from electronic communications in which the user was wearing an AR headset.

(A4) In some embodiments of A3, the default animation features are based on analyzing content of the speech-based communication. For example, an AI model can be used to analyze aspects of the user's spoken words (e.g., content of speech, tone, volume) and can provide animated mouth movements based on one or more aspects of the user's spoken words.

(A5) In some embodiments of A1-A4, the method 800 includes, while preparing the speech-based communication and in accordance with determining that the electronic device is the AR headset, presenting a preview of the animated avatar, in its animated state with the head movements, to the user at the AR headset. For example, in FIGS. 4A-4E, the animated avatar 410 that is being presented within a portion of the augmented-reality glasses 402 of the user 401 is a preview of the animated avatar to be presented with content shared by the user 401 about the physical activity that they are currently performing.

(A6) In some embodiments of A1-A5, the operations for animating the head movements of the animated avatar include operations for animating the head movements of the animated avatar without using data from a camera. For example, the symbolic view of data from the sensors 190 in FIGS. 1B and 1C indicates that the camera 196 of the AR headset is powered off while data is being collected by the IMU sensors 192 and the audio sensors 194 of the AR headset, where the data that is being collected is used to animate head movements and mouth movements of the animated avatar 111.

(A7) In some embodiments of A1-A6, the method 800 includes, in accordance with determining that the AR headset includes a microphone, animating mouth movements of the animated avatar associated with the user, wherein the mouth movements of the animated avatar are based on data from the microphone of the AR headset that was received while preparing the speech-based communication. For example, the animated avatar 111 shown in FIGS. 1B and 1C includes different animated mouth movements based on the user 101 saying different spoken words at different points in time corresponding to the animated avatar 111.

(A8) In some embodiments of A1-A7, the operations for animating the head movements of the animated avatar include operations for animating the head movements of the animated avatar based only on detecting that the user is preparing a speech-based communication at the AR headset. For example, the animated avatar 111 being presented in FIG. 1B based on the user 101 performing the in-air hand gesture 110 in FIG. 1A may also be displayed based on the user's spoken words in FIG. 1B. In some embodiments, the animated avatar is displayed automatically, without further user intervention, based on the user performing a gesture directed to an electronic message from another user.

(A9) In some embodiments of A1-A8, the AR headset is configured to display user interface elements to the user that are presented while also allowing the user to continue to view an unobstructed physical environment. In some embodiments, the AR headset is configured to present user interface elements outside of an area where an object of interest (e.g., the golf ball 405, shown in FIGS. 4A-4E) is being presented, where the object of interest is associated with a physical activity that the user is performing.

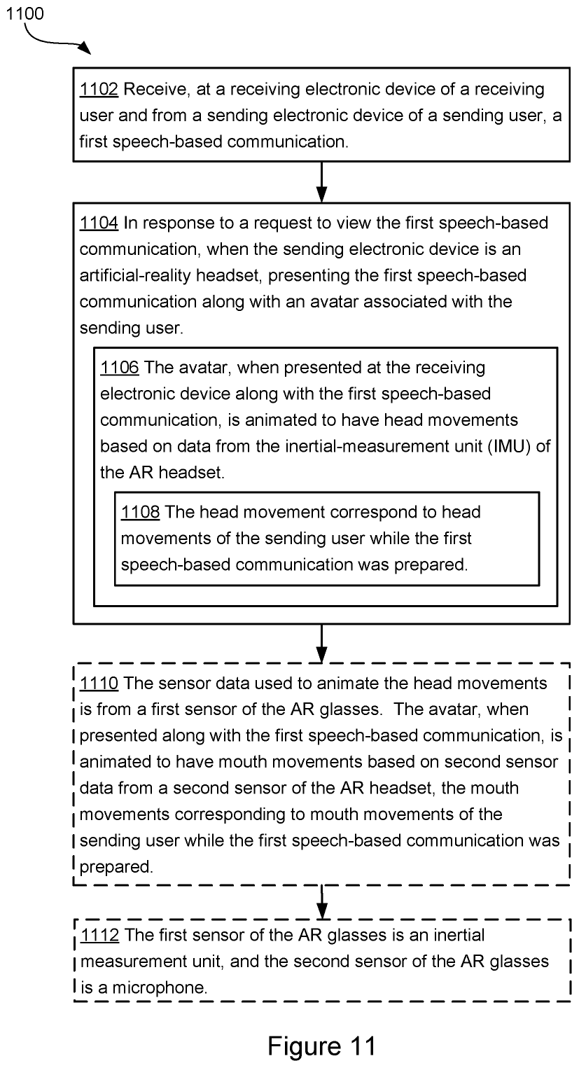

FIG. 11 shows a flow diagram of method 1100 for presenting an animated avatar that is obtained via an electronic communication. The method 1100 is performed at a computing system (e.g., a wearable device or intermediary device) having one or more processors and memory. The method 1100 is caused to be performed by a non-transitory computer-readable storage medium, at least part of which is stored in memory of an AR headset within the computing system, in accordance with some embodiments.

(B1) The method 1100 includes receiving (1102), at a receiving electronic device of a receiving user and from a sending electronic device of a sending user, a first speech-based communication. For example, the second user 151 in FIG. 1G is shown receiving a speech-based communication as indicated by the user interface element 160.

The method 1100 includes, in response to (1104) a request to view the first speech-based communication, when the sending electronic device is an AR headset, presenting the first speech-based communication along with an avatar associated with the sending user.

The avatar, when presented (1106) at the receiving electronic device along with the first speech-based communication, is animated to have head movements based on sensor data from the AR headset.

The head movements correspond (1108) to head movements of the sending user while the first speech-based communication was prepared. For example, the animated avatar 111 is shown at the display of the wrist-wearable device 150 of the second user 151 based on the wrist-wearable device 150 determining that the electronic communication from the user 101 includes first data corresponding to head movements of the user 101, and second data corresponding to spoken words of the user 101.

In some embodiments, the method includes detecting other sensors besides IMUs for facilitating animated head movements of a user. For example, the method may include detecting whether the user is using a device that includes a camera that is capable of capturing head movements of the user. In some embodiments, a camera can be a fallback technique once the method fails to detect an IMU or other sensor that is more efficient for detecting such gestures. In some embodiments, other sensors can be used in addition to the IMU to detect aspects of head movements. For example, audio data can be used to enhance the quality of detection of head movements that is already occurring via the IMU.

In some embodiments, the request to view the speech-based communication is a user answering a request to engage in a video call (e.g., a real-time audio-video communication between two users). In some embodiments, the request to view the speech-based communication can be made while another user is preparing a speech-based communication, and after requesting to view the communication, the user can request for the other user preparing the communication to engage in a video call.

(B2) In some embodiments of B1, the sensor data (1110) used to animate the head movements is from a first sensor of the AR glasses. The avatar, when presented along with the first speech-based communication, is animated to have mouth movements based on second sensor data from a second sensor of the AR headset, the mouth movements corresponding to mouth movements of the sending user while the first speech-based communication was prepared.

(B3) In some embodiments of B2, the first sensor of the AR glasses is an inertial measurement unit, and the second sensor of the AR glasses is a microphone.

(B4) In some embodiments of B3, the method 900 includes receiving, at the receiving electronic device of the receiving user and from a different sending electronic device of the sending user, a second speech-based communication. And the method includes, in response to a request to view the second speech-based communication, when the different sending electronic device is not an AR headset, presenting the second speech-based communication without presenting the avatar as having animated movements based on sensor data from the AR glasses.

(B5) In some embodiments of B4, presenting the second speech-based communication includes presenting a textual message corresponding to message content of the second speech-based communication. For example, an AR model can be used to determine the spoken words that a user is saying while preparing a particular speech-based communication, and a non-transitory computer-readable storage medium stored at an electronic device that the user is using to prepare the electronic communication can generate textual content corresponding to the spoken words.

(B6) In some embodiments of any one of B4-B5, presenting the second speech-based communication includes presenting only text derived from the second speech-based communication. That is, the electronic communication can be presented to a particular user without audio even if the electronic communication includes a spoken-word message.

(B7) In some embodiments of any one of B4-B6, presenting the second speech-based communication includes presenting the second speech-based communication along with the avatar associated with the sending user. And the avatar, when presented along with the second speech-based communication, is not animated to have head movements based on data from any IMU. For example, the animated avatar 211 shown in FIG. 2C is not animated based on actual head movements of the user 201 and is instead animated based on default animations. In some embodiments, the default animations include aspects of a user's profile within a particular sharing application (e.g., a messaging application and/or a social media application).

(B8) In some embodiments of any one of B1-B7, presenting the first speech-based communication includes audibly presenting the first speech-based communication.

(B9) In some embodiments of any one of B1-B8, the avatar is animated without using data from a camera (e.g., the camera 196 is powered off while the user 101 is preparing the electronic communication in FIGS. 1B-1C).

(B10) In some embodiments of any one of B1-B9, presenting the first speech-based communication includes textually presenting the first speech-based communication such that words are presented in synchronous fashion along with corresponding animated mouth movements of the avatar. For example, in some embodiments, subtitles are provided in conjunction with presentation of the animated avatar in a first presentation mode (e.g., a silent presentation mode) and audio is provided in a second presentation mode (e.g., an audio-enabled presentation mode). In some embodiments, the animated avatar is presented within a scrollable feed of previews of content within a particular sharing application. And based on a user selecting the sharable content that includes the animated avatar, the animated avatar is caused to adjust from being presented in the first presentation mode to the second presentation mode.

(B11) In some embodiments of any one of B1-B10, the method 1100 further includes, in conjunction with presenting the avatar associated with the sending user, determining that the receiving user has access to view the avatar. For example, the animated avatar may only be accessible by contacts that are connected to the user via a particular sharing application, and a non-transitory computer-readable storage medium of the receiving device may determine whether a particular receiving contact is a connection with the user via the sharing application. In some embodiments, data corresponding to the animated head movements and/or the animated mouth movements is encrypted such that it cannot be otherwise accessed except via the animated avatar.

In some embodiments, the method 1100 further includes, based on data from a microphone in electronic communication with the AR headset, animating mouth movements of the avatar. For example, the animated avatar 316 shown in FIG. 3C includes animated mouth movements, which can correspond to spoken words of the user. In some embodiments, the animated mouth movements may be based on text-based content provided in conjunction with the electronic communication.

(B12) In some embodiments of any one of B1-B11, the first speech-based communication includes video content, and the avatar is presented as overlaying a portion of the video content. For example, the animated avatar 316 shown in FIG. 3C is presented as an overlay to video content.

(B13) In some embodiments of B12, the first speech-based communication is a video call, and the video content is associated with the video call, and the avatar is presented based on a determination that the sending user is not being captured by the video content associated with the video call. For example, in FIG. 3A, the user 301 is recording themselves playing piano via the cameras of the AR headset and is not using any cameras to record themselves while they are recording their playing the piano. In some embodiments, the animated avatar that is displayed in conjunction with the video content is based on a sharing application that a user is sharing the respective video content on.

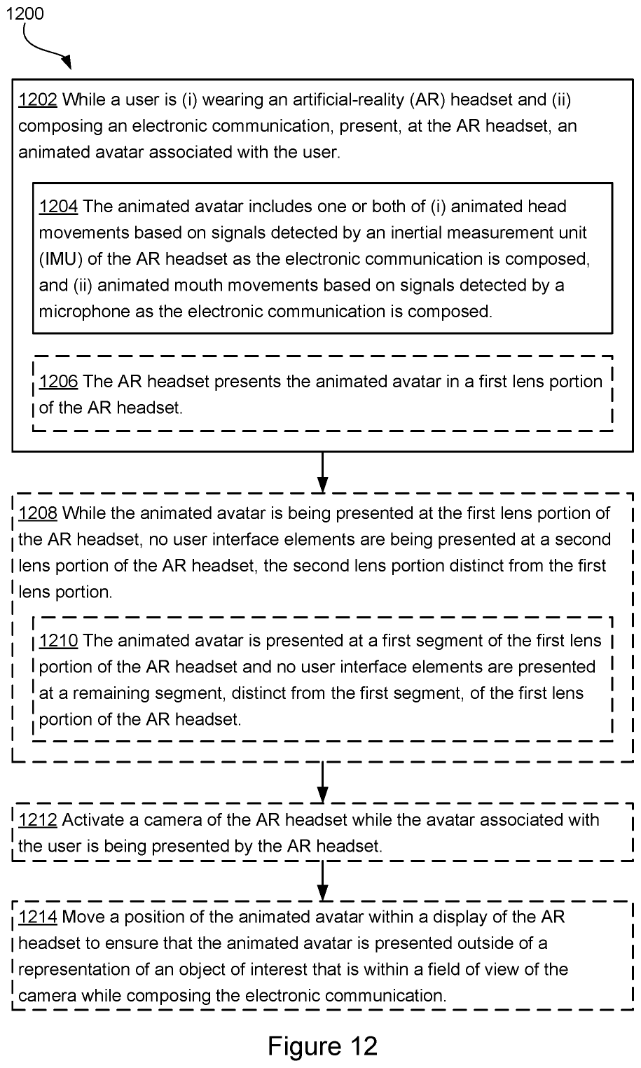

FIG. 12 shows a flow diagram of method 1200 for presenting an animated avatar at a portion of a display of AR glasses. The method 1200 is performed at a computing system (e.g., a wearable device or intermediary device) having one or more processors and memory. The method 1200 is caused to be performed by a non-transitory computer-readable storage medium, at least part of which is stored in memory of processors an AR headset within the computing system, in accordance with some embodiments.

(C1) The method 1200 includes, while (1202) a user is (i) wearing an artificial-reality (AR) headset and (ii) composing an electronic communication, presenting, at the AR headset, an animated avatar associated with the user. The animated avatar includes (1204) one or both of (i) animated head movements based on signals detected by an inertial measurement unit (IMU) of the AR headset as the electronic communication is composed, and (ii) animated mouth movements based on signals detected by a microphone as the electronic communication is composed.

(C2) In some embodiments of C1, the AR headset presents (1206) the animated avatar in a first lens portion of the AR headset. In some embodiments, the method 1200 further includes, while (1208) the animated avatar is being presented at the first lens portion of the AR headset, no user interface elements are being presented at a second lens portion of the AR headset, the second lens portion distinct from the first lens portion.

(C3) In some embodiments of C2, the animated avatar is (1210) presented at a first segment of the first lens portion of the AR headset, and no user interface elements are presented at a remaining segment, distinct from the first segment of the first lens portion of the AR headset. For example, in FIG. 4C, the animated avatar 410 is minimized so that no user interface elements are presented so as to obstruct the user 401 from viewing the object of interest of their particular physical activity (e.g., the golf ball 405).

(C4) In some embodiments of any one of C1-C3, the method 1200 further includes activating (1212) a camera of the AR headset while the animated avatar associated with the user is being presented by the AR headset.

In accordance with some embodiments, the method 1200 further includes moving (1214) a position of the animated avatar within a display of the AR headset to ensure that the animated avatar is presented outside of a representation of an object of interest (e.g., a piano keyboard) that is within a field of view of the camera while composing the electronic communication. For example, in FIG. 4B, the user 401 moves their head in a downward direction, and the animated avatar 410 is caused to move out of the view corresponding to the new location of the object of interest (the golf ball 405) based on its new location within the lens of the augmented-reality glasses 402.

(C5) In some embodiments of C4, the animated avatar is moved to avoid multiple different objects of interest within the field of view of the camera while composing the electronic communication. For example, if the golf club of the user 401 were also in the view of the lens of the augmented-reality glasses 402, then the animated avatar 410 could be caused to move such that no user interface elements are presented at the location of the golf ball 405 or the golf club of the user 401 while they are performing the physical activity of swinging the golf club.

(C6) In some embodiments of C1-C5, the animated avatar associated with the user is presented in response to the user beginning to compose the electronic communication. For example, instead of beginning to present the animated avatar 111 based on the user 101 performing the in-air hand gesture 110, the animated avatar 111 could be presented based on the user beginning to enunciate spoken words as shown in FIG. 1B.

(C7) In some embodiments of C1-C6, the method 1200 further includes, before composing the electronic communication: (i) presenting, via the AR headset, a first representation of a different electronic communication received from a different user and a second representation of the different user, and (ii) in response to detecting a user input directed to the second representation of the different electronic communication, presenting, via the AR headset, a selectable user interface object to initiate the composing of the electronic communication. For example, in FIG. 1H, the AR headset 154 of the second user 151 is presenting the animated avatar 111 while providing user interface options for the second user 151 to provide prepare an electronic communication in response to the electronic communication that includes the animated avatar 111 of the user 101.

(C8) In some embodiments of C7, the selectable user interface object is presented, via the AR headset, along with a representation of an avatar associated with the user. For example, the second user 151 could select a selectable option of the user interface element 170 presented at the lens portion of the AR headset 154.

(C9) In some embodiments of any one of C1-C8, the animated avatar is configured to be sent to a different user for display along with a representation of video data that was captured by a camera of the AR headset during the composing of the electronic communication. For example, in FIGS. 4A-4E, the user 401 is sharing video content related to the physical activity (golf) that they are performing while causing the animated avatar to be presented to another user.

(C10) In some embodiments of C9, the animated avatar is configured to be presented to the different user within a user interface element that is separable from the representation of video data that was captured by the camera of the AR headset during the composing of the electronic communication. For example, as shown in FIGS. 3A-3D, a receiving user of the electronic message can modify presentation of the electronic communication that includes the animated avatar, including minimizing, re-sizing, expanding, and applying customized effects to the animated avatar corresponding to the sending user. And the representation of the animated avatar is separable and separately modifiable from the representation of the visual content. In some embodiments, the user can modify and/or drag the representation of the animated avatar independently of the video content.

(C11) In some embodiments of C1-C10, the method 1200 further includes, in response to detecting that the user has removed the AR headset, pausing the composing of the electronic communication to be resumed upon a determination that the user is again wearing the AR headset. For example, the preparing of the electronic communication shown in FIGS. 1B-1C may be temporarily halted based on a determination that the user 101 removed the AR headset 102 during composition of the electronic communication. In some embodiments, the electronic communication automatically resumes, without further interaction by the user, based on the user wearing the AR headset again.

(C12) In some embodiments of C1-C11, the method 1200 further includes based on detecting, via sensors of another electronic device worn by the user, hand movements of a user gesture, animating one or more hand movements of the animated avatar. For example, the user 301 in FIGS. 3A-3D may be wearing a wrist-wearable device in addition to the AR headset 302, and, based on data from one or more sensors of the wrist-wearable device, the animated avatar may include one or more animated hand movements corresponding to the actual hand movements of the user 301 while they are performing the physical activity (playing piano).

(C13) In some embodiments of C1-C12, the AR headset includes a plurality of lenses, and the animated avatar is presented in only one lens of the AR headset. For example, the animated avatar 410 is only shown being presented in one lens of the augmented-reality glasses 402. In some embodiments, no user interface elements are presented in the other lens of the augmented-reality glasses 402.

(C14) In some embodiments of C1-C13, the animated avatar is displayed in real time while the user is composing the electronic communication. For example, the animated avatar 111 can be presented to the second user 151 while the user 101 is preparing the electronic communication that includes the animated avatar 111.

(C15) In some embodiments of C1-C14, the electronic communication is a speech-based electronic communication. For example, the user 101 is shown enunciating spoken words in FIGS. 1B-1C in the course of preparing an electronic communication to the second user 151.

(C16) In some embodiments of C1-C15, the AR headset is not a virtual-reality headset and is configured to overlay user interface elements on top of an unobstructed view of physical surroundings of the user.

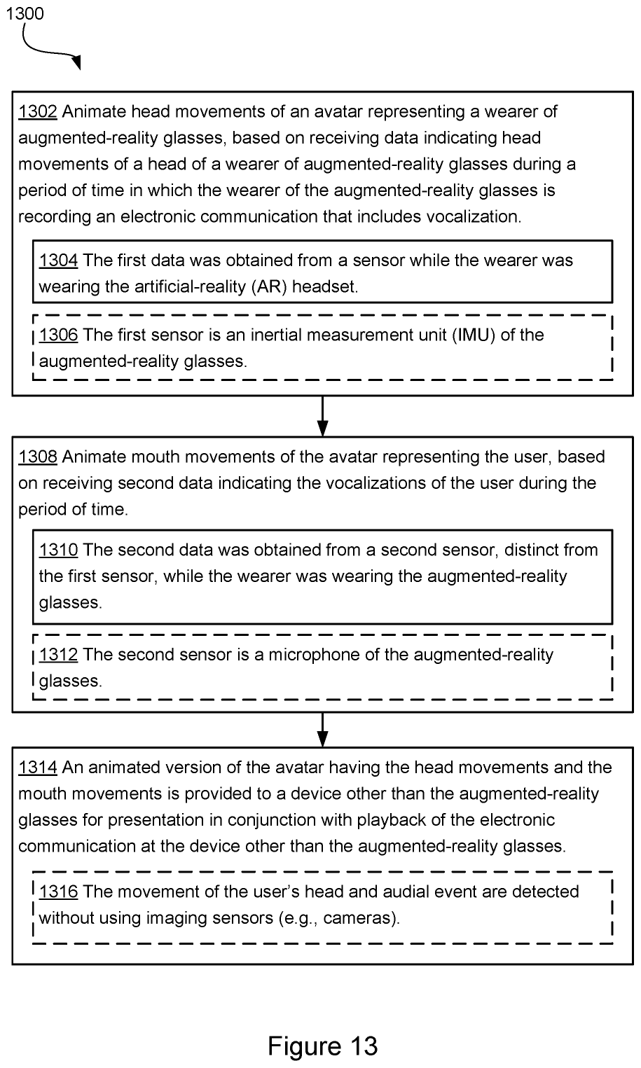

FIG. 13 shows a flow diagram of method 1300 for presenting an avatar in an electronic communication based on data from sensors of augmented-reality glasses. The method 1300 is performed at a computing system (e.g., a wearable device or intermediary device) having one or more processors and memory. The method 1300 is caused to be performed by a non-transitory computer-readable storage medium, at least part of which is stored in memory of processors of an AR headset within the computing system, in accordance with some embodiments.

(D1) The method 1300 includes animating (1302) of an avatar representing a wearer of augmented-reality glasses, based on receiving first data indicating movements of a head of the wearer of the augmented-reality glasses during a period of time in which the wearer of the augmented-reality glasses is recording an electronic communication that includes vocalization.

The first data was obtained (1304) from a first sensor while the wearer was wearing the augmented-reality glasses. In some embodiments, the vocalizations that are recognized in the first data are spoken words, such as spoken words recognized to be performed by the user.

The method 1300 further includes animating (1308) mouth movements of the avatar representing the wearer, based on receiving second data indicating the vocalizations of the wearer during the period of time. The second data was obtained (1310) from a second sensor, distinct from the first sensor, while the wearer was wearing the augmented-reality glasses.

An animated version of the avatar having the head movements and the mouth movements is (1314) provided to a device other than the augmented-reality glasses for presentation in conjunction with playback of an electronic communication at the device other than the augmented-reality glasses.

(D2) In some embodiments of D1, the first sensor is (1306) an inertial measurement unit (IMU). In some embodiments, the second sensor is (1312) a microphone of the augmented-reality glasses.

(D3) In some embodiments of any one of D1-D2, the data indicating the movement (1316) of the head of the wearer and the second data indicating the vocalizations are obtained without using any imaging sensors of the augmented-reality glasses. For example, in FIGS. 1B-1C, the symbolic view of the sensors 190 of the AR headset indicates that the camera 196 of the AR headset is powered off. In some embodiments, power is reduced to one or more cameras of an AR headset or another device in electronic communication with the AR headset based on a determination that other sensors (e.g., IMU sensors) will be used to detect head movements of a user for animating an animated avatar.

(D4) In some embodiments of D3, the augmented-reality glasses include one or more imaging sensors that are configured to detect movements of the wearer, and before the first data and the second data have been obtained, the one or more imaging sensors of the augmented-reality glasses are caused to be deactivated based on one or more of (i) an indication of a limited amount of storage at the augmented-reality glasses, and (ii) an indication of a limited amount of battery at the augmented-reality glasses. For example, the augmented-reality glasses may be configured to maintain a particular level of available storage that includes enough storage to store data from an IMU sensor, but not enough storage to store video content from a camera of the AR headset. The determination that storage at the AR headset is insufficient for camera data can be further based on the AR headset lacking an internet connection for sending such camera data to a remote server to be processed and/or stored.

(D5) In some embodiments of any one of D1-D4, the animating of the head movements and the animating of the mouth movements are performed at another electronic device, distinct from the augmented-reality glasses. For example, the first data and the second data can be processed by another electronic device (e.g., a remote server) based on a determination that the first data and the second data are being collected by an AR headset.

In some embodiments, the animating of the head movements is performed at an intermediary device configured to convey data between the augmented-reality glasses and the other electronic device.

(D6) In some embodiments of any one of D1-D5, the method 1300 further includes animating body movements of the avatar based on detecting that the wearer is performing a physical activity. For example, body movements of an animated avatar may be further based on the user performing a particular physical activity (e.g., golfing, as shown in FIGS. 4A-4E).

(D7) In some embodiments of any one of D1-D6, a visual aspect of the avatar is based on a particular application from which the electronic communication is initiated at the augmented-reality glasses. For example, a user may have certain animation settings configured at a first sharing application and may not have the same settings configured at a second sharing application. In some embodiments, a user may have particular animation settings configured for particular contacts of the user, such that an animated avatar can be presented to a first contact differently than the animated avatar is presented to a second contact, based on the configuration settings for the user associated with the first contact or the second contact. For example, a user may be “connected” (e.g., having a recognized connection with a particular contact) via a particular sharing application. The respective animated avatar may include certain elements based on a contact having a connection with a user in a first sharing application (e.g., a particular accessory element) and additional elements based on another contact having a connection with the user at a different sharing application.

(D8) In some embodiments of D1-D7, animating one or more of (i) the head movements of the avatar, and (ii) the mouth movements of the avatar causes animation of one or more accessory elements presented in conjunction with the avatar. For example, the animated avatar 111 is shown wearing an accessory item (e.g., a virtual hat), and an amount of tilt of the accessory item can be based on an amount of tilt detected from the IMU sensors 192 of the AR headset 102. In some embodiments, the accessory item displayed in conjunction with the animated avatar can be based on a physical activity that the user is performing during the electronic communication.

In some embodiments, based on one or more animation criteria, the AR system causes data from one or more sensors separate from the augmented-reality glasses to be provided along with the first data and the second data in conjunction with providing the avatar to the device other than the augmented-reality glasses.

(D9) In some embodiments of D1-D8, animating the head movements of the avatar representing the wearer includes applying a model to the first data, the model selected from a group consisting of (i) an axis-angle model, (ii) a Euler model, and (iii) a quaternion model. For example, if a user is performing more complex head movements, then a higher-order quaternion model can be used to animate aspects of the animated avatar's head movements. In some embodiments, the determination of which model to use is based on a sharing application that the user is using to prepare a particular electronic communication.

(D10) In some embodiments of D1-D9, animating the head movements is further based on fusing the first data from the first sensor with the second data from the second sensor. In some embodiments, data from less than all of the microphones of an AR headset can be combined with the first data from the IMU to animate head movements of a respective animated avatar.

(D11) In some embodiments of D1-D10, animating the head movements is further based on the second data. For example, the data from the audio sensors 194 in FIG. 1C can be combined with the data from the IMU sensors 192 to increase an amount of precision associated with the animated head movements of the animated avatar.

(D12) In some embodiments of D11, the second data is applied to a quaternion model for animating head movements. For example, a user may be wearing an AR headset with a particular IMU sensor that is capable of processing IMU data in conjunction with a quaternion model for performing tilt correction on the first data from the IMU sensor. Based on detecting that the IMU sensor of the AR has such capabilities, a non-transitory computer-readable storage medium that is stored at the AR headset can be configured to cause the second data from one or more microphones of the AR headset to be applied to the quaternion model.

(D13) In some embodiments of D12, the second data is used to determine an amount of tilt correction to be applied to at least part of the first data. For example, the IMU sensor of an AR headset may have a tendency to include error based on tilt of a user's head after a head movement in two separate axes of a coordinate plane established by the IMU sensors.

(D14) In some embodiments of D1-D13, the augmented-reality glasses include (i) a first temple that includes a first audio sensor, and (ii) a second temple with a second audio sensor and based on the first data indicating the movements of the head of the wearer by the first sensor, applying a higher weighting to data from the first audio sensor than data from the second audio sensor. For example, if an IMU of an AR headset determines that a user is moving their head in a particular direction, then audio sensors located on a particular temple of the user's AR headset can be given a higher weighting with respect to animating head movements of an animated avatar corresponding to the user. In some embodiments, a higher weighting can be applied to a particular audio sensor based on a determination that the audio sensor has more sensing capabilities for the particular situation (e.g., a physical activity that a user is performing).

(D15) In some embodiments of D1-D14, the method 1300 further includes adjusting the avatar based on data from additional sensors of the augmented-reality glasses or another electronic device that is in electronic communication with the augmented-reality glasses, the additional sensors including one or more of (i) a neuromuscular-signal sensor (e.g., an electromyography (EMG) electrode), (ii) a time-of-flight (TOF) sensor, (iii) a mechanomyography (MMG) sensor, (iv) a photoplethysmography (PPG) sensor, and (v) a camera. For example, a user can perform an in-air hand gesture that is detectable by a neuromuscular-signal sensor of a wrist-wearable device (e.g., a controlled squeeze gesture), and an aspect of an animated avatar being prepared by the user (e.g., at an AR headset) can be based on an amount of force applied by the controlled squeeze gesture (e.g., an amount that the animated avatar is smiling).

(D16) In some embodiments of any one of D1-D15, the method 1300 further includes encrypting the first data indicating the head movements or encrypting the second data indicating the spoken words of the spoken-word communication.

(D17) In some embodiments of D16, the first data or the second data is encrypted such that the encrypted first data or the encrypted second data can only be used to present an animated avatar.

(D18) In some embodiments of any one of D16-D17, the first data or the second data is encrypted such that it can only be used in conjunction with a first sharing application.

(D19) In some embodiments of any one of D16-D18, the first data or the second data is encrypted such that it can only be accessed by a user that is connected to another user via a particular sharing application. That is, an animated avatar corresponding to a respective user may only be available by a contact of the respective user at a particular sharing application. In some embodiments, one or more users can access the animated avatar without being direct contacts with the user based on the one or more users being contacts with at least one contact of the user corresponding to the animated avatar.

(D20) In some embodiments of any one of D16-D19, the first data or the second data is encrypted such that it is resistant to quantum decryption.

(E1) In some embodiments, a head-wearable device (e.g., an AR headset, such as a VR headset or AR glasses) is provided. The head-wearable device includes (i) a display, (ii) one or more sensors, (iii) one or more processors, and (iv) memory comprising instructions that, when executed by the head-wearable device, cause performance of a method that includes operations of any one of A1-D20.

(F1) In some embodiments, a head-wearable device is provided. The head-wearable device includes a means for performing the method of any one of A1-D20.

(G1) In some embodiments, a non-transitory computer-readable storage medium is provided. The non-transitory computer-readable storage medium, when executed at a computing device that includes memory, and one or more processors, causes performance of the method of any one of A1-D20.

(H1) In some embodiments, a system including a head-wearable device and a wrist-wearable device to be used as a controller for input to the head-wearable device is provided. The system is configured to perform or cause performance of the method of any one of A1-D20.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
animating head movements of an avatar representing a wearer of augmented-reality glasses, based on receiving first data indicating movements of a head of the wearer of the augmented-reality glasses during a period of time in which the wearer of the augmented-reality glasses is recording an electronic communication that includes vocalizations, wherein the first data was obtained from a first sensor while the wearer was wearing the augmented-reality glasses; and
animating mouth movements of the avatar representing the wearer, based on receiving second data indicating the vocalizations of the wearer during the period of time, wherein the second data was obtained from a second sensor, distinct from the first sensor, while the wearer was wearing the augmented-reality glasses,
wherein an animated version of the avatar having the head movements and the mouth movements is provided to a device other than the augmented-reality glasses for presentation in conjunction with playback of the electronic communication at the device other than the augmented-reality glasses.

2. The method of claim 1, wherein:
the first sensor is an inertial measurement unit (IMU) of the augmented-reality glasses, and
the second sensor is a microphone of the augmented-reality glasses.

3. The method of claim 2, wherein the first data indicating the movements of the head of the wearer and the second data indicating the vocalizations are obtained without using any imaging sensors of the augmented-reality glasses.

4. The method of claim 3, wherein:
the augmented-reality glasses include one or more imaging sensors that are configured to detect movements of the wearer; and
before the first data and the second data have been obtained, the one or more imaging sensors of the augmented-reality glasses are caused to be deactivated based on one or more of (i) an indication of a limited amount of storage at the augmented-reality glasses, and (ii) an indication of a limited amount of battery at the augmented-reality glasses.

5. The method of claim 1, wherein the animating of the head movements and the animating of the mouth movements are performed at another electronic device, distinct from the augmented-reality glasses.

6. The method of claim 1, further comprising animating body movements of the avatar based on detecting that the wearer is performing a physical activity.

7. The method of claim 1, wherein a visual aspect of the avatar is based on a particular application from which the electronic communication is initiated at the augmented-reality glasses.

8. The method of claim 1, wherein animating one or more of the (i) head movements of the avatar, and (ii) the mouth movements of the avatar cause animation of one or more accessory elements presented in conjunction with the avatar.

9. The method of claim 1, wherein animating the head movements of the avatar representing the wearer includes applying a model to the first data, the model selected from a group consisting of (i) an axis-angle model, (ii) a Euler model, and (iii) a quaternion model.

10. The method of claim 1, wherein animating the head movements is based on fusing the first data from the first sensor with the second data from the second sensor.

11. The method of claim 1, wherein animating the head movements is further based on the second data.

12. The method of claim 11, wherein the second data is applied to a quaternion model for animating head movements.

13. The method of claim 12, wherein the second data is used to determine an amount of tilt correction to be applied to at least part of the first data.

14. The method of claim 1, wherein:
the augmented-reality glasses include (i) a first temple that includes a first audio sensor, and (ii) a second temple with a second audio sensor; and
based on the first data indicating the movements of the head of the wearer by the first sensor, applying a higher weighting to data from the first audio sensor than data from the second audio sensors.

15. The method of claim 1, further comprising:
adjusting the avatar based on data from additional sensors of the augmented-reality glasses or another electronic device that is in electronic communication with the augmented-reality glasses, the additional sensors including one or more of:
a neuromuscular-signal sensor (e.g., an electromyography (EMG) electrode);
a time-of-flight (TOF) sensor;
a mechanomyography (MMG) sensor;
a photoplethysmography (PPG) sensor; and
a camera.

16. A non-transitory computer-readable storage medium, comprising instructions configured to be executed by one or more processors of an augmented-reality headset, the instructions configured to cause operations, comprising:
animating head movements of an avatar representing a wearer of augmented-reality glasses, based on receiving first data indicating movements of a head of the wearer of the augmented-reality glasses during a period of time in which the wearer of the augmented-reality glasses is recording an electronic communication that includes vocalizations, wherein the first data was obtained from a first sensor while the wearer was wearing the augmented-reality glasses; and
animating mouth movements of the avatar representing the wearer, based on receiving second data indicating the vocalizations of the wearer during the period of time, wherein the second data was obtained from a second sensor, distinct from the first sensor, while the wearer was wearing the augmented-reality glasses,
wherein an animated version of the avatar having the head movements and the mouth movements is provided to a device other than the augmented-reality glasses for presentation in conjunction with playback of the electronic communication at the device other than the augmented-reality glasses.

17. The non-transitory computer-readable storage medium of claim 16, wherein:
the first sensor is an inertial measurement unit (IMU) of the augmented-reality glasses, and
the second sensor is a microphone of the augmented-reality glasses.

18. The non-transitory computer-readable storage medium of claim 16, wherein the first data indicating the movements of the head of the wearer and the second data indicating the vocalizations are obtained without using any imaging sensors of the augmented-reality glasses.

19. The non-transitory computer-readable storage medium of claim 18, wherein:
the augmented-reality glasses include one or more imaging sensors that are configured to detect movements of the wearer; and
before the first data and the second data have been obtained, the one or more imaging sensors of the augmented-reality glasses are caused to be deactivated based on one or more of (i) an indication of a limited amount of storage at the augmented-reality glasses, and (ii) an indication of a limited amount of battery at the augmented-reality glasses.

20. Augmented-reality glasses, comprising:
one or more processors;
memory comprising instructions, which, when executed by the one or more processors, cause operations, including:
animating head movements of an avatar representing a wearer of augmented-reality glasses, based on receiving first data indicating movements of a head of the wearer of the augmented-reality glasses during a period of time in which the wearer of the augmented-reality glasses is recording an electronic communication that includes vocalizations, wherein the first data was obtained from a first sensor while the wearer was wearing the augmented-reality glasses; and
animating mouth movements of the avatar representing the wearer, based on receiving second data indicating the vocalizations of the wearer during the period of time, wherein the second data was obtained from a second sensor, distinct from the first sensor, while the wearer was wearing the augmented-reality glasses,
wherein an animated version of the avatar having the head movements and the mouth movements is provided to a device other than the augmented-reality glasses for presentation in conjunction with playback of the electronic communication at the device other than the augmented-reality glasses.
